(19) United States
(12) Patent Application Publication
(10) Pub. No.: US 2010/0153138 A1
(43) Pub. Date: Jun. 17, 2010

(54) Offer in compromise method and system

(76) Inventor: Thomas M. Evans, Scotts Valley, CA (US)

Correspondence Address: William C. Milks, III, 401 Florence Street, Palo Alto, CA, 94301, US

(21) Appl. No.: 12/454,945

(22) Filed: May 26, 2009

Related U.S. Application Data
(63) Continuation-in-part of application No. 11/516,371, filed on Sep. 5, 2006.
(60) Provisional application No. 61/128,643, filed on May 23, 2008.

(51) Int. Cl. G06Q 40/00; G06Q 20/00

(52) U.S. Cl. 705/4; 705/35; 705/36 T; 705/31

(57) ABSTRACT

A tax resolution system and method are disclosed for identifying and implementing solutions to tax delinquency problems. A taxpayer who is delinquent is guided to provide pertinent data and make adjustments to be analyzed to formulate an offer in compromise to resolve tax delinquency problems or plan a future tax strategy.

### CROSS-REFERENCES TO RELATED PATENT APPLICATIONS

This application is a continuation-in-part of co-pending non-provisional U.S. patent application Ser. No. 11/516,371 filed on Sep. 5, 2006 entitled TAX RESOLUTION PROCESS AND SYSTEM, which is hereby incorporated herein in its entirety by this reference. This application also relates to U.S. Provisional Patent Application No. 61/128,643 filed on May 23, 2008 entitled OFFER IN COMPROMISE METHOD AND SYSTEM, which is hereby incorporated herein in its entirety by this reference.

### BACKGROUND OF THE INVENTION

1. Field of the Invention

The present invention relates generally to taxes and, more particularly, to a method and system for the purpose of assisting one or more taxpayers in resolving their tax delinquency problems. One preferred embodiment of the present invention provides a method and system for evaluating tax-related and other data regarding taxpayers, collecting and analyzing the taxpayer data, and formulating an offer in compromise strategy or scenario to resolve tax delinquency problems regarding qualification for an offer in compromise on paying back taxes.

2. References

[1] U.S. Published Application No. 20030061131 for “Automated income tax system.”

[2] U.S. Published Application No. 20050283418 for “System and methodology for processing debt management plans.”

[3] U.S. Published Application No. 20050097033 for “Debt management system.”

[4] U.S. Published Application No. 20050038722 for “Methods, systems, and computer program for processing and/or preparing a tax return and initiating certain financial transactions.”

[5] U.S. Published Application No. 20040199456 for “Method and apparatus for explaining credit scores.”

[6] U.S. Published Application No. 20040172347 for “Determining the occurrence of events using decision trees.”

[7] U.S. Published Application No. 20030217032 for “System and method for providing business strategy and compliance information.”

[8] U.S. Published Application No. 20010044734 for “Method, system, and software for providing tax audit insurance.”

[9] U.S. Published Application No. 20020156710 for “Personal or family accounting and management system.”

[10] U.S. Published Application No. 20050102283 for “System with an interactive, graphical interface for delivery of planning information and consulting materials, research, and compliance information relating to tax or other forms.”

[11] U.S. Pat. No. 6,912,508 for “Method and apparatus for promoting taxpayer compliance.”

[12] U.S. Pat. No. 6,446,048 for “Web-based entry of financial transaction information and subsequent download of such information.”

[13] Daily, Frederick W. Stand Up to the IRS, 7th ed. Berkeley, Calif.: Nolo Press, 2003.

[14] Goldstein, Arnold S. Solving IRS Problems. Chicago: Socrates Media, LLC, 2004.

[15] Goldstein, Arnold S. How to Settle with the IRS . . . For Pennies on the Dollar. Deerfield

Beach, Fla.: Garrett Publishing, 1997.

3. Description of the Prior Art

Today, one of the most challenging recurring problems facing any person or business is the filing of tax returns and the payment of taxes. The tax returns are complicated. In order to efficiently complete tax returns, effective bookkeeping practices are required to collect and analyze data that is entered into the tax returns. The payment of taxes must be timely in order to avoid interest and penalties, but taxes place a budgetary strain on the finances of individuals and businesses alike.

Often, data for completing tax returns is not available or is simply not collected sufficiently early to complete tax returns for filing on a timely basis. Just as often, individuals and business may not have the funds to pay taxes. Other factors such as an illness prevent an individual from filing tax returns or paying taxes, or an event such as a fire or hurricane causes destruction of taxpayer data or intervenes to prevent the timely preparation and filing of tax returns and payment of taxes.

Taxpayers can include an individual(s) and/or small business(es) who are a) delinquent in their U.S. Federal personal income taxes, business income taxes, and/or payroll taxes; and/or b) planning the consequences of their estimated future liability for any of these types of taxes. Typically, delinquent taxpayers are either confronted with having to resolve their own tax problems or seeking and paying for the advice and assistance of a tax professional that includes both individuals who are tax advisers and/or preparers and an enterprise(s) employing more than one such individual such as H & R Block, Inc. The time and effort required to address a tax delinquency problem are often considerable, and there is an additional out-of-pocket cost associated with consulting with a tax adviser or preparer to assist with preparation of tax returns and payment of taxes and/or planning for future tax liabilities.

Experts estimate that ten million taxpayers owe back taxes to the IRS. Up to another ten million taxpayers are not filing with the IRS as required. This problem has grown so widespread that in 1996 Congress passed the Taxpayer's Bill of Rights 2, which liberalized a program whereby people could settle all their IRS debt in one negotiation, often for pennies on the dollar. Since then the offer in compromise (OIC) program has been further expanded to encourage non-filers and those hopelessly behind to come into full compliance. See Internal Revenue Code §7122 and Regulations §301.7122-IT. In July, 2006 and February, 2007 further changes were made.

In 2001, 39,000 (31%) of the 125,000 OIC were accepted. Applications were down slightly in 2002 to 124,000 and acceptances fell to 29,000 (23%). From 2002 the number of acceptances has continued to decline while the approval rate increased somewhat due to fewer applications: 2003 was 22,000 (17%) and 2004 fell to 20,000 (19%). This trend has continued in 2005 where 19,000 (26%) were approved and in 2006 where 15,000 (25%) were accepted. While individual settlements vary greatly, the average amount the IRS recovers has remained fairly constant at about 15% of the aggregate owed.

There are three arguments under which the IRS considers granting an OIC:

1. A person owes the tax but does not have the money to pay it (also referred to as “doubt as to collectibility”).

2. A person owes the tax but it would cause undue hardship to pay it.

3. A person does not owe the tax for some very good reason (“doubt as to liability”).

It would be desirable to enable a taxpayer to adjust his or her finances to better fit the OIC guidelines for reasons 1 and 2, above, and, thereby, qualify for settlement at a reduced monetary amount. If the taxpayer is applying under option 3, above, he or she need not submit financial statements, and can proceed directly to complete IRS Form 656, Offer in Compromise.

Thus, it would be desirable to provide a tax resolution method and system which overcome problems in approaching tax delinquency and provide an objective approach that can formulate a potential tax resolution based on an offer in compromise. It is to this end that the present invention is directed. The various embodiments of the present invention have many advantages by providing a tax resolution method and system to formulate an offer in compromise strategy or scenario for delinquent taxpayers.

### SUMMARY OF THE INVENTION

One embodiment of the offer in compromise method and system in accordance with the present invention provides many advantages in resolving tax delinquency problems, which make the offer in compromise method and system in accordance with the present invention useful to taxpayers as well as tax professionals advising and assisting delinquent taxpayers. One embodiment of the present invention provides an offer in compromise formulation method and a system that provide solutions to tax problems relating to delinquent taxes, as well as future tax planning. One embodiment of the offer in compromise method is performed and the system is implemented by executing a software program on a computer to provide information useful in formulating an offer in compromise that is compliant with IRS guidelines and calculating the amount of the offer. In accordance with one preferred embodiment of the present invention, the software program is a spreadsheet program.

A preferred embodiment of the offer in compromise method and system in accordance with the present invention guides a delinquent taxpayer or a tax professional to provide pertinent data to be analyzed to derive a strategy to resolve tax delinquency problems or plan a future tax strategy. The taxpayer or a tax professional is provided an offer in compromise scenario to solve tax delinquency problems and prepare documentation to implement a potential solution based on an offer in compromise.

The offer in compromise method and system in accordance with the various embodiments of the present invention provide the taxpayer or a tax professional with detailed insight into the numbers and calculations the IRS employs to reach their conclusions. The offer in compromise method and system utilize the IRS's own quantitative test to strategize how to best qualify for an OIC settlement. Also, the taxpayer or a tax professional can test the feasibility and potential benefits of an OIC before doing the heavy lifting of gathering taxpayer records required to document an OIC.

The taxpayer or a tax professional can determine which numbers are important to passing the test so the taxpayer can anticipate and document them in the application. Knowing how the IRS will likely view the taxpayer's OIC and being able to quickly run varying scenarios is crucial in planning the taxpayer's strategy.

The offer in compromise method and system in accordance with the various embodiments of the preset invention enable the taxpayer to avoid the pitfalls with an easy to follow, step-by-step process. About one out of four OIC applications is accepted. This statistic is misleading, however. Very few if any applicants analyze their situation from the IRS's perspective prior to filing. Just calculating their Reasonable Collection Potential (RCP) allows taxpayers to quickly determine what, if any, benefit could result from an OIC. RCP is the IRS's measure of the capacity of a taxpayer to pay current and past due taxes. The RCP is the sum of three separate calculations: a) the net equity in one's assets, b) income available to pay taxes after allowing for certain expenditures, and c) income that will become available as existing loans, such as a car loan, are paid off. If the RCP is equal to or greater than the total taxes owed (including interest and penalties), the IRS will demand full payment. If the RCP is less than the taxes due, then the IRS will be more open to negotiating an OIC settlement. Using the offer in compromise method and system in accordance with the various embodiments of the preset invention, the taxpayer or a tax professional can make appropriate adjustments to the taxpayer's finances to adjust the RCP to plan ahead and further increase the likelihood of achieving a quick, fair compromise with the IRS.

The foregoing and other objects, features, and advantages of the present invention will become more readily apparent from the following detailed description of various embodiments, which proceeds with reference to the accompanying drawing.

### BRIEF DESCRIPTION OF THE DRAWING

The various embodiments of the present invention will be described in conjunction with the accompanying figures of the drawing to facilitate an understanding of the present invention. In the figures, like reference numerals refer to like elements. In the drawing:

FIG. 1 is a block diagram of one embodiment of a tax resolution system that preferably incorporates a software program to formulate an offer in compromise in accordance with the present invention;

FIG. 2 is an overview flowchart of one embodiment of the tax resolution method performed by the tax resolution system shown in FIG. 1;

FIG. 3 is a detailed flowchart of taxpayer data input and checking steps shown in FIG. 2;

FIG. 4 is a detailed flowchart of data analysis and generation of solutions steps shown in FIG. 2;

FIG. 5 is a detailed flowchart of solution implementation steps shown in FIG. 2; and

FIGS. 6-70 illustrate screens displayed by the system shown in FIG. 1 during formulation of an offer in compromise.

### DETAILED DESCRIPTION OF THE PREFERRED EMBODIMENTS

The present invention is particularly applicable to computer software executed by a computer for resolving tax problems and formulating offer in compromise tax resolution strategies and other strategies, and it is in this context that the preferred embodiments of the present invention will be described. The embodiments of the offer in compromise tax resolution method and system in accordance with the present invention are examples only, and is not intended to limit the scope of the present invention to resolution of tax liability, as the principles of the present invention may apply more generally, for example, to tax planning.

There minimum system requirements. To install and run the offer in compromise software program, one preferably has Microsoft Word and Excel software programs installed on his or her computer.

For installing and operating the offer in compromise software program, download and save this application to one's computer. Open Microsoft Word and Excel and use these programs to run the application files. Save and print one's work as one would any other Word or Excel file.

Various embodiments of the offer in compromise (OIC) method and system in accordance with the present invention will now be described. The various embodiments of the OIC method and system in accordance with the present invention enable a user to:
1. Apply the new OIC regulations that went into effect July, 2006 and February, 2007 to the taxpayer's advantage.
2. Determine what “Monthly Multiplier” to use in an analysis—and why this is so important.
3. Calculate the benefit of and how to qualify for a more favorable Monthly Multiplier—a small change saves thousands of dollars.
4. Plan using an Asset Equity Table spreadsheet to minimize the “net equity” in the taxpayer's assets and what the taxpayer is obligated to pay in taxes.
5. Test scenarios with a Retired Debt Calculations spreadsheet to avoid huge tax payments when a loan is paid off.
6. Adjust the taxpayer's monthly figures in an Income Expense Table spreadsheet to limit the impact these have on settlement.
7. The offer in compromise software program links these spreadsheets together to derive the IRS's “Reasonable Collection Potential.” While this figure determines the IRS's final recommendation, the taxpayer will see how to change it to his or her advantage.
8. Finally, the offer in compromise software program assists a taxpayer or a tax professional in preparing the forms and documentation necessary to submit the taxpayer's OIC application.

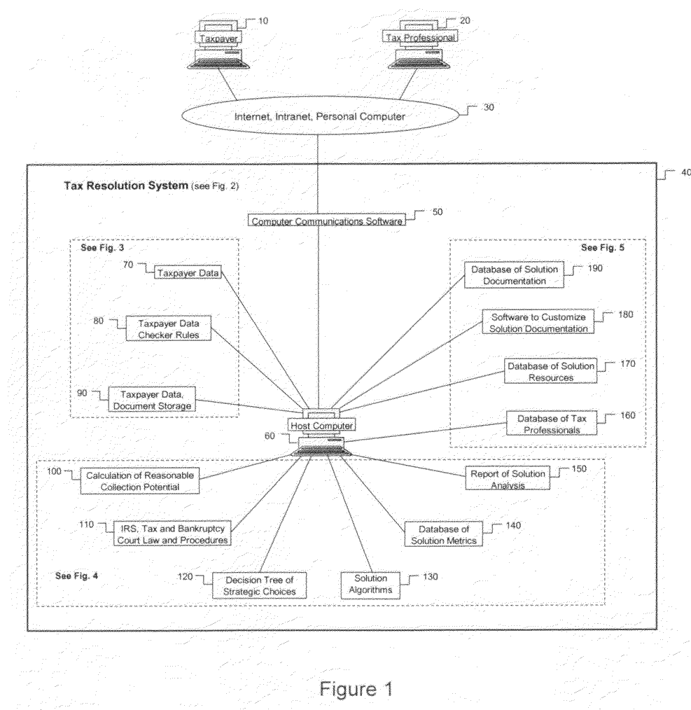

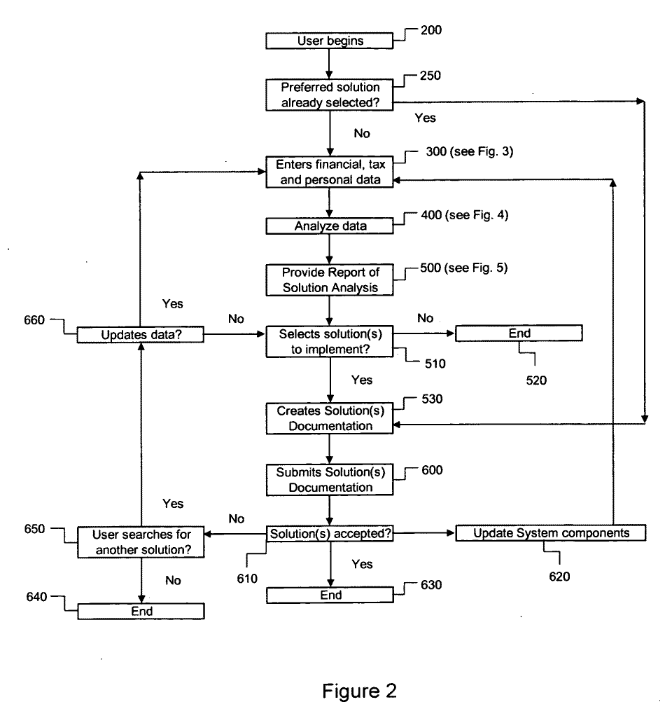

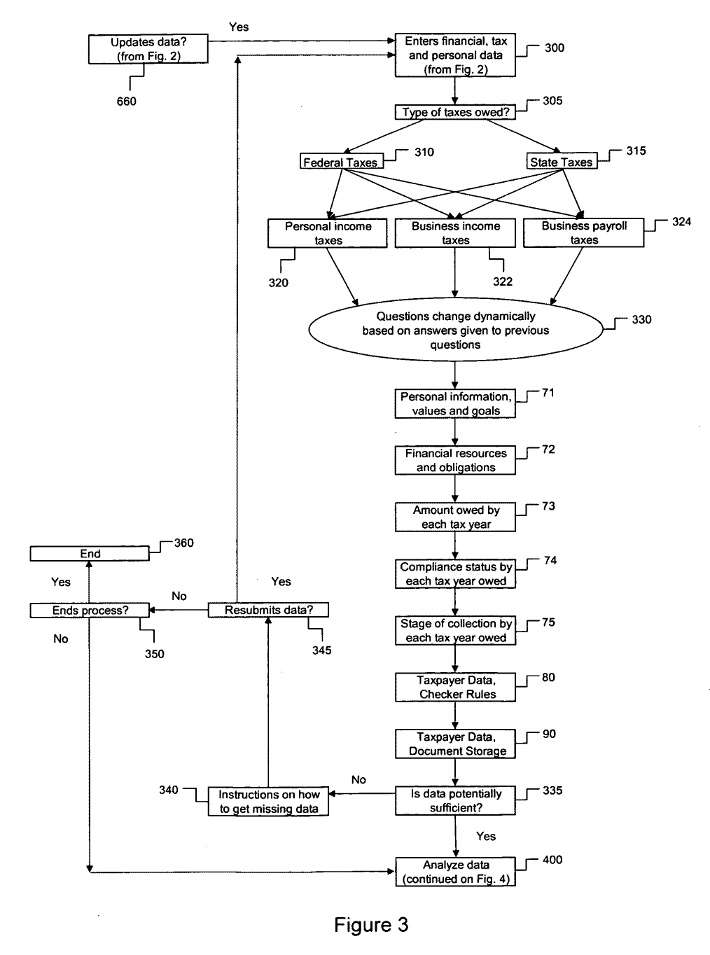

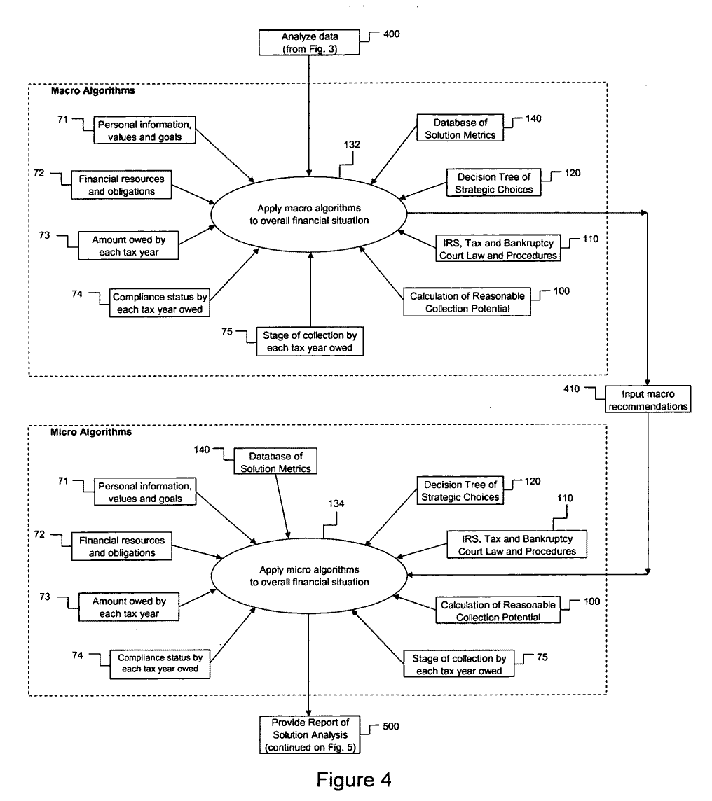

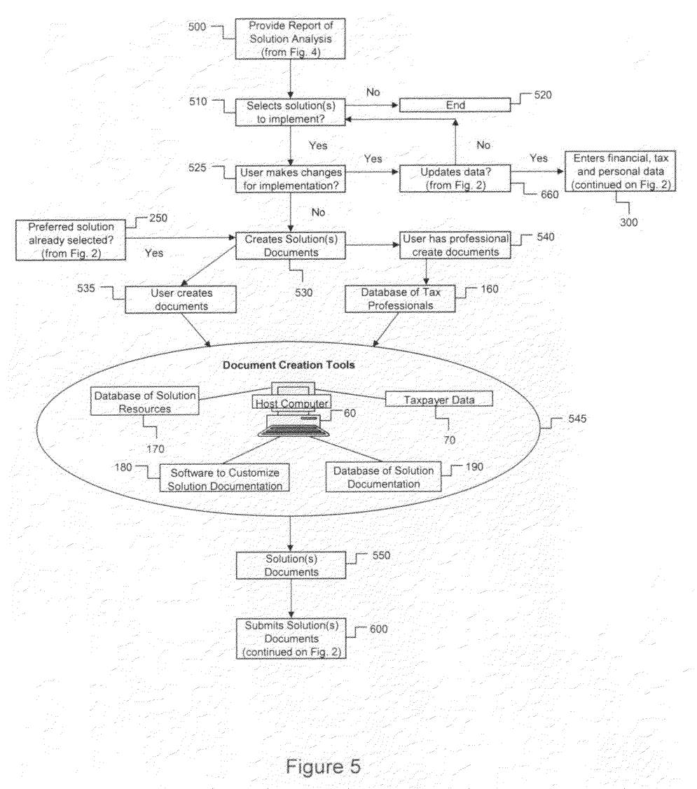

Referring now to the drawing, FIG. 1 shows various components of a tax resolution system 40 described in aforementioned co-pending non-provisional U.S. patent application Ser. No. 11/516,371 filed on Sep. 5, 2006 entitled TAX RESOLUTION PROCESS AND SYSTEM. FIG. 2 is an overview flowchart of the tax resolution method performed by the tax resolution system 40. FIGS. 3, 4, and 5 provide more detailed flowcharts of an implementation of various steps of the method shown in FIG. 2.

Generally, the purpose of the tax resolution system 40 is to assist one or more taxpayers 10 in identifying and implementing solutions to their tax delinquency problems. Such taxpayers 10 may include an individual(s) and/or a small business(es) who are a) delinquent in their U.S. Federal personal income taxes, business income taxes, and/or payroll taxes; b) delinquent in their state personal income taxes, business income taxes, and/or payroll taxes; and/or c) planning the consequences of their estimated future liability for any of these types of taxes.

Alternatively or additionally, as shown in FIG. 2, a tax professional 20 may utilize the tax resolution system 40 to identify and implement solutions for taxpayers 10 who are individuals or small businesses a) delinquent in their U.S. Federal personal income taxes, business income taxes, and/or payroll taxes; b) delinquent in their state personal income taxes, business income taxes, and/or payroll taxes; and/or c) planning the consequences of their estimated future liability of any of these types of taxes. A tax professional 20 includes both an individual who is a tax adviser and/or preparer and an enterprise(s) employing more than one such individual.

Hereafter, for convenience, when an action or result applies to either a taxpayer 10 or tax professional 20, they will be collectively referred to as a “user.” In view of the potential interaction between a taxpayer 10 and a tax professional 20, the tax resolution system 40 preferably has built-in safeguards to protect the taxpayer 10, while at the same time providing a platform which enables efficient interaction between a taxpayer 10 and a tax professional 20, as follows.

In one preferred embodiment, a tax professional 20 restricts their involvement to advising on any steps a taxpayer 10 may initiate using the tax resolution system 40. In such an embodiment, the taxpayer 10 may or may not authorize the tax professional 20 to access the taxpayer's 10 secure workspace in a taxpayer data, document storage 90 comprising the tax resolution system 40, as shown in FIG. 1.

In an alternative embodiment, a taxpayer 10 supplies taxpayer data to a tax professional 20. The tax professional 20 then enters the taxpayer data into a secure workspace taxpayer data 70 that the tax professional 20 creates on the tax resolution system 40 on behalf of the taxpayer 10. The tax professional 20 may or may not authorize the taxpayer 10 to access this workspace.

As shown in FIG. 1, a user accesses and interacts with the tax resolution system 40 by a communication medium such as the Internet (including the World Wide Web) or intranet and personal computer 30, or any other electronic techniques and devices that have communication capability with Internet, intranet, or television, for example, such as personal computers, personal data assistants (PDA's), cellular telephones, and other personal communication equipment and computer communications software 50 that interfaces the user and a host computer 60.

The tax resolution system 40 preferably comprises a software application operating on the host computer 60, as shown in FIG. 1. For example, the host computer 60 may be any personal computer having at least 256 megabytes of random access memory (RAM) and preferably includes one gigabyte of RAM. The tax resolution system 40 in accordance with one exemplary implementation is a 32-bit software application compatible with a Microsoft Windows 2000 or Windows NT or later operating system available from Microsoft Corporation located in Redmond, Wash. The host computer 60 also preferably comprises a hard disk drive having at least 40 gigabytes of free storage space available. The host computer 60 is provided with the Internet or World Wide Web connection 30 for connection to one or more users. The connection 30 comprises a high-speed connection, for example, a DSL or greater connection, and is preferably a T1 or faster connection. In the preferred embodiment of the tax resolution system 40, users can be ported to the Internet or World Wide Web and analyses and formulation of solutions are performed by the host computer 60. In another embodiment of the tax resolution system 40, analyses and formulations of solutions may be preformed by user personal computers 30 associated with users.

As mentioned earlier, the tax resolution system 40 also comprises computer software or code. In the preferred embodiment, the tax resolution system 40 computer software or code can be a hosted application that runs on the host computer 60. In the alternative embodiment, the software or code can comprise a client installed on or downloaded to the personal computers 30 of users and executed locally. Thus, the computer software or code may be initially supplied to users on a CD-ROM or other electronic medium or downloadable over the Internet or World Wide Web.

In accordance with one embodiment of the tax resolution system 40, the software or code preferably comprises other software applications such as word processing and spreadsheet application software. One example of a word processor that can be utilized with the various embodiments of the tax resolution system is Word, and one example of a spreadsheet is Excel, both commercially available from Microsoft Corporation.

The initial action of accessing the tax resolution system 40 is shown as a step 200 (“user begins”) in FIG. 2. The user may have a preferred solution they want to implement using the tax resolution system's 40 resources, as determined by a step 250. In this case, they bypass entering their taxpayer data 70 and go directly to create their solution(s) documentation 550, as indicated by a step 530.

If no solution is initially specified as being preferred, the taxpayer 10 enters their financial, tax, and personal data (taxpayer data 70) into the tax resolution system 40 during a step 300 shown in FIG. 2. This step may comprise a tax professional 20 entering taxpayer data 70 for a taxpayer 10 client. Examples of taxpayer data 70 will be described in more detail shortly. An embodiment of how the step 300 may be implemented is shown in more detail in FIG. 3.

Referring to FIG. 3, the question in a step 305 asks to what agency are the taxes owed: Federal taxes 310 or state taxes 315. Under each of these taxing authorities, the type of taxes owed can be personal income taxes 320, business income taxes 322, or business payroll taxes 324. All six situations are covered by the tax resolution system 40, as well as cases where more than one of these types of taxes is owed. In addition, the tax resolution system 40 preferably provides forecasts of future tax liabilities in deriving tax solutions.

Depending on the answers given by the user to the data input questions, the subsequent questions dynamically adapt, as indicated by a step 330, so that only relevant inquiries are made. For example, if a user states that Federal personal income taxes are the only taxes owed, then subsequent questions asked by the tax resolution system 40 focus on this type of tax.

FIG. 3 depicts the entering of taxpayer data 70 into the tax resolution system 40 in more detail. An additional mode has the user (i.e., a taxpayer 10 or tax professional 20) import the taxpayer data 70 into the tax resolution system 40 from other software programs and databases such as QuickBooks. Specific examples of taxpayer data 70 will be described in more detail below, but, in general, such data may include any or all of the following: personal information, values, and goals 71; financial resources and obligations 72; amount owed by each tax year 73; compliance status by each tax year owed 74; stage of collection by each tax year owed 75, as well as any other data pertinent to resolving their tax problem. The taxpayer data 70 references current and past results or events, as well as future expected results or events. For example, the taxpayer data 70 takes into account if the taxpayer 10 plans to retire soon or incur a significant change in income. This data may be of a personal and/or business nature as well as covering past, current, and future time periods.

Considered in more detail, examples of personal information, values, and goals 71 are the taxpayer's 10 state of health, age, and level of expertise or interest in financial matters, as well as their stated objectives. Examples of financial resources and obligations 72 are the taxpayer's 10 itemization of their monthly income and expenses plus details of their assets and liabilities. Examples of amount owed by each tax year 73 are the taxpayer's 10 liabilities for taxes, interest, and penalties for any tax years for which they are delinquent or expect to owe in the future. Examples of compliance status by each tax year owed 74 are the date tax returns were filed (or if they are still outstanding) and the amount of taxes paid to date (if any) on the unresolved tax years. Examples of stage of collection by each tax year owed 75 are the date and type of notices the taxpayer 10 has received from the tax authority, as well as any levies or liens placed on the taxpayer's 10 income and assets.

An illustrative, limited dataset for a taxpayer 10 may reveal, for example, that they are married with three dependents, 50 years of age, in chronic poor health, with a continual deficit spending of $300.00 per month, $100,000.00 of equity in their home, and having filed no tax returns for the last three years. Their primary goal is to file their past due tax returns and resolve any tax liability that may be owed.

Referring again to FIG. 3, taxpayer data checker rules 80 analyze the taxpayer data 70 for potential completeness and consistency, as indicated by a step 335. A case where a notice of potentially inconsistent data would be given the user is when the taxes being withheld exceed the taxpayer's 10 income.

The minimum dataset required changes dynamically as responses are entered by the user. For example, placing a high value on not paying any more to resolve past tax liabilities changes the amount of information needed by the tax resolution system 40, because some solutions (e.g., negotiate an installment plan) are presented in less detail for consideration. If the user later amends their goals to allow additional tax payments, then the taxpayer data checker rules 80 will require more data to be input by the user.

If the taxpayer data is not sufficient to process, the tax resolution system 40 informs the user what data is needed and gives instructions on how to obtain the missing data 340. Such advice could include, for example, sample Internal Revenue Service (hereafter, the “IRS”) or other forms showing where the data is provided and/or a list of professionals who can help assemble the taxpayer data 70.

In one embodiment, the taxpayer data checker rules 80 are used in the step 335 to alert the user as to which possible solutions cannot be analyzed in detail due to insufficient data. The user would then have the option of having the tax resolution system continue to analyze data, as indicated by a step 400, and be given a more limited analysis, or to exercise the option of acquiring more data for resubmission as indicated by a step 345.

At any time the user is connected to the tax resolution system 40, they can save their taxpayer data 70 (FIG. 1) in their individual secure workspace in the taxpayer data, document storage 90. In the implementation illustrated in FIG. 3, for example, the user saves their data after the taxpayer data checker rules 80 have been applied in a step 90. This allows the user to later re-enter the tax resolution system 40 and access the taxpayer data 70. Alternatively, the user can exit the tax resolution system 40 without saving their data or changes to the data.

Preferably, each time the user logs onto the tax resolution system 40, they will be asked if their data needs to be updated and, if so, given the opportunity to do so. In one embodiment, automatic alerts may be scheduled and provided by the tax resolution system 40 to the user respecting when to enter data, file documents, respond to statutory or other deadlines, or take certain other actions. Such notices are preferably communicated utilizing any of the methods and devices described earlier including Internet, intranet, or television via personal computers, personal data assistants (PDA's), cellular telephones, and other personal communication equipment such as by email or text message, for example.

In the step 345, the user is asked if they want to resubmit updated taxpayer data for the taxpayer data 70 or to end the process. Thus, a step 350 provides the choice of ending (indicated by a step 360) or continuing with the limited set of data they have provided (indicated by a step 400). If they resubmit, the cycle of updating the data and having it checked for completeness and consistency repeats until sufficient data is available to analyze, they choose to stop altogether, or they elect to proceed with what data they have already provided, as indicated by the step 400.

Assuming the taxpayer data checker rules 80 find the data to be potentially sufficient in the step 335 or the user decides to continue with a limited dataset, the tax resolution system 40 then analyzes the data starting with the step 400, which is continued from the bottom of FIG. 3 to the top of FIG. 4.

One embodiment of the analysis process is shown in more detail in FIG. 4. As shown in FIG. 4, macro algorithms 132 and micro algorithms 134 comprise the solution algorithms 130 in FIG. 1.

For example, algorithms weigh the taxpayer data 70 so that some data is given greater importance by the tax resolution system 40 in analyzing the taxpayer's 10 situation and formulating potential solutions. One example is where past tax returns have not been filed. Normally such a situation precludes the IRS from entering into negotiations with delinquent taxpayers, which limits the potential solutions available to the taxpayer 10. The weighting is preferably dependent on the relative desirability of their various goals specified when the user enters personal information, values, and goals 71. This information is incorporated into the weights given alternative solutions. For example, placing a high value on not paying any more to resolve past tax liabilities weights the alternative solutions, because some solutions (e.g., negotiate an installment plan) are weighted less for consideration.

As shown in FIG. 4, the macro algorithms 132 are applied to the taxpayer data 70 to gain a perspective on the taxpayer's overall situation. The macro algorithms 132 preferably utilize all aspects of the taxpayer data 70: personal information, values, and goals 71, financial resources and obligations 72, amount owed by each tax year 73, compliance status by each tax year owed 74, stage of collection by each tax year owed 75, as well as any other data pertinent to resolving their tax problem. Again, examples of personal information, values, and goals 71 are the taxpayer's 10 state of health, age, and level of expertise or interest in financial matters, as well as their stated objectives. Examples of financial resources and obligations 72 are the taxpayer's 10 itemization of their monthly income and expenses plus details of their assets and liabilities. Examples of amount owed by each tax year 73 are the taxpayer's 10 liabilities for taxes, interest, and penalties for any tax years for which they are delinquent or expect to owe in the future. Examples of compliance status by each tax year owed 74 are the date tax returns were filed (or if they are still outstanding) and the amount of taxes paid to date (if any) on the unresolved tax years. Examples of stage of collection by each tax year owed 75 are the date and type of notices the taxpayer 10 has received from the tax authority, as well as any levies or liens placed on the taxpayer's 10 income and assets.

Additionally, as shown in FIG. 4, the macro algorithms 132 preferably take into consideration the “calculation of reasonable collection potential” 100, the IRS, Tax, and bankruptcy court law and procedures 110, the decision tree of strategic choices 120, and the database of solution metrics 140.

The “calculation of reasonable collection potential” 100 is a quantitative methodology used by the IRS to estimate a taxpayer's 10 ability to pay current and back taxes. For example, cash in the bank and income above allowable limits are assumed to be available for the payment of taxes. This calculation changes as the taxpayer data 70 is amended and the taxpayer 10 makes changes to their financial situation, as indicated by a step 525 shown in FIG. 5. For instance, selling stocks worth $1,000.00 and using the money to reduce bank loans reduces the calculation of reasonable collection potential 100 by $1,000.00.

The calculation of reasonable collection potential 100 is an instance where complete and consistent taxpayer data 70 is required to produce meaningful results. The tax resolution system 40 will prompt the user when the taxpayer data 71 appears to be incomplete and/or inconsistent. As described earlier, the user can make choices about data deficiencies in accordance with the step 345 shown in FIG. 3.

Referring again to FIG. 4, examples of IRS, Tax, and bankruptcy court law and procedures 110 include data related to the probability that different types of cases would be decided in the taxpayer's 10 favor under the jurisdiction of each of these institutions.

The decision tree of strategic choices 120 starts at very fundamental criteria (e.g., “Does the taxpayer's 10 total liabilities exceed their assets?”) and progresses to lesser priorities (e.g., “How can the taxpayer 10 influence the calculation of reasonable collection potential 100?”). Another embodiment of the decision tree of strategic choices 120 is a mapping of the actions and reactions that are possible between the taxpayer 10 and the IRS, courts, and other institutions.

Examples of the database of solution metrics 140 are estimates of the time, expertise, cost, and other parameters associated with implementing various solutions.

The recommendations from applying the macro algorithms 132 are input to the micro algorithms 134 for analysis, as indicated by a step 410. Factors considered at this stage include all aspects of the taxpayer data 70 (items 71 through 75), as well as the calculation of reasonable collection potential 100, the IRS, Tax, and bankruptcy court law and procedures 110, the decision tree of strategic choices 120, and the database of solution metrics 140. The micro algorithms 134 analyze each delinquent tax year separately to derive recommendations and solutions at that level.

The macro and micro analyses utilize algorithms to weigh segments of the taxpayer data 70, as well as the other criteria depending on the taxpayer's 10 individual situation and various other factors. For example, the taxpayer's 10 health, age, and/or other special circumstances may have an overriding impact on the range and potential success of alternative solutions. An example of such a case would be where extensive health care costs and inability to be fully employed markedly reduce a taxpayer's 10 ability to repay back taxes.

Preferably, the macro and micro algorithms 132 and 134, respectively, taxpayer data 70, other analysis databases 100, 110, 120, and 140, and any other relevant information are amended based on the experience and results from pursuing solutions under differing conditions and as changes occur in IRS, court, and other institutional practices and procedures.

At the conclusion of the data analysis, the user is provided with the report of solution analysis 150, as indicated by a step 500 at the bottom of FIG. 4. This report prioritizes the potential solutions and recommendations for the user to consider for implementation. For instance, the report indicates the suitability of each potential solution based on the earlier described algorithms that take into consideration the taxpayer's 10 values, goals, and expertise; the advantages and disadvantages of each solution; the approximate time required to implement; the level of expertise needed; stress; risks of failure; and other factors that could bear on their decision respecting which potential solution to pursue.

For example, a possible solution for a taxpayer 10 in a specific case may be to submit an “offer in compromise” to the IRS. An “offer in compromise” is an IRS process for settling the amount of taxes owed.

Applying for an offer in compromise (OIC) is, in many ways, an irrevocable decision. The pros and cons, as well as other factors, are presented here to consider so that the taxpayer 10 makes an informed choice. If a taxpayer 10 decides to pursue the benefits of an OIC, then a strategy is important. The most frequent reason for the failure of OICs is applicants do not plan ahead and execute their strategy properly. The description that follows combines text and quantitative tools to help secure IRS approval and maximize tax savings.

There are advantages and disadvantages to an OIC. The advantages include:
1. A taxpayer 10 gains peace of mind and certainty by settling all outstanding issues with the IRS in one negotiation.
2. The monetary settlement could be for far less than what is owed. The IRS accepts on average about 15% of the total due.
3. The settlement can be paid in installments over a number of years.
4. Interest accrues, not on the original assessment, but on the settlement amount until the OIC is paid in full.
5. The IRS generally delays seizure or levy of assets if they feel the taxpayer 10 is negotiating in good faith. Also, if an OIC is granted and the taxpayer 10 fulfills his or her obligations, the taxpayer may avoid seizure or levy altogether.
6. If the taxpayer 10 is subject to federal tax liens, he or she can have them lifted within 30 days of paying off the OIC settlement. In addition, entering into a collateral agreement for future payments usually entices the IRS to release their liens. This allows the taxpayer 10 to begin repairing his or her credit rating.
7. If the taxpayer 10 has paid his or her OIC settlement in full and his or her income and financial circumstances improve in the future, the IRS is prohibited from revoking the OIC and demanding the past taxes. This is a significant advantage over an installment agreement.
8. If an OIC application is rejected, the taxpayer 10 can appeal the ruling so long as he or she is current with his or her tax filings and payments and an appeal is filed within 30 days.

The disadvantages include:
1. The IRS approves about one in four OIC applications.
2. The taxpayer 10 is required to file all past tax returns and be current on his or her quarterly payments or withholding prior to applying.
3. The taxpayer 10 must collect, analyze, and provide extensive reports and supporting materials along with his or her OIC filing. In addition, the IRS will undoubtedly request additional information.
4. The OIC process takes at least six to eighteen months (or longer) to complete.
5. If the taxpayer 10 lies or does not disclose all his or her assets and the IRS finds out, the OIC will likely be revoked and the taxpayer will probably not be approved for another OIC in the future.
6. Submitting the disclosure forms supplies the IRS with all the personal and financial information they need to seize or levy a taxpayer's 10 assets and/or garnish his or her income.
7. The IRS may audit the taxpayer 10 based on information contained in his or her application, but this is rare.
8. If the Revenue Officer decides the taxpayer 10 has not provided sufficient information to document his or her application, they can “close” the taxpayer's 10 OIC case and there's no appeal to their decision (as there would be if it were “rejected”).

If a taxpayer's 10 OIC application is rejected:
1. Amounts he or she pays in an OIC application fee are forfeited and his or her deposit is applied to his or her outstanding tax liability.
2. Interest and penalties accrued during the application period are added to the tax debt.
3. OIC submissions based on the argument “I owe the tax but . . . ” bar a taxpayer 10 from contesting in Tax Court since the taxpayer acknowledges the debt, even if his or her OIC is turned down. This applies to all the tax years the taxpayer 10 lists in his or her application.
4. Applying for an OIC extends the time the IRS has to collect by the months the OIC is under consideration, plus one year, to whatever remains on the 10-year collection statute.

After the IRS approves the taxpayer's OIC request:
1. The taxpayer 10 must remain current on all tax filings, payments, and other requirements for five years. The taxpayer 10 must also fulfill the terms of his or her OIC agreement, or the IRS will likely revoke it.
2. If the taxpayer's 10 OIC is revoked, the original amount is reinstated in full (including interest and penalties less cash received), and the IRS will commence collection.
3. The taxpayer 10 gives up any tax refunds he or she is due for prior tax years, the current year, and usually for the next three to five years.

Many factors determine how easy or difficult it will be for the taxpayer 10 to adjust his or her finances to fit the IRS profile for granting an OIC. The best and worst case scenarios are outlined below.

Best Case: A taxpayer's 10 chances of successfully negotiating an OIC based on the premise “I owe the tax but don't have the money to pay it” are good if his or her assets and income match one of these three situations:
1. The taxpayer 10 has limited assets, borrowing power, or income. This is best because the IRS does not have much to take, pressure the taxpayer to borrow against, or garnish.
2. The taxpayer 10 does not have much relative to what is owed. Here, the taxpayer 10 forfeits some money in order to avoid a much higher tax. Or, even better, the taxpayer 10 may be able to shield these funds from the IRS.
3. The taxpayer 10 has sizable resources but can protect them. The best solution in this situation is to arrange his or her assets and income so that they are not accessible to the IRS. Possible strategies are discussed in the next sections.

Worst Case The most adverse circumstance is where the taxpayer 10 owes the tax and has sizeable resources that he or she cannot protect. This usually occurs if:
1. The taxpayer 10 has more equity than owed in taxes. The equity in his or her home, business, and other assets is sufficient to cover the tax and the IRS has liens on them.
2. The taxpayer 10 has good future earnings potential. He or she is young (say, under 50 years old) and is likely to earn enough over the next ten years to pay back taxes.
3. In these instances, the tax collectors will wait patiently while the interest compounds on the taxpayer's 10 debt at 8% or more per year. And, since this type of interest is not tax deductible (unless the taxpayer 10 is a corporation), the taxpayer needs to earn at least 13.4% before tax on his or her money just to break-even, assuming he or she is in the 35% federal and 8% state tax bracket.

Therefore, in these worst-case scenarios, the taxpayer's 10 best hope is to plead “economic hardship” to qualify for an OIC and, if rejected, seek help from the Taxpayer Advocate Service. If the taxpayer 10 cannot justify adequate hardship, he or she is better off borrowing and paying the tax. He or she will end up saving a great deal of money, because the interest will likely be tax-deductible and at a lower rate than the IRS charges. Plus, he or she will reduce stress and free up energy to make more money.

Immediate or quick denial of an OIC application happens for several reasons:
1. The taxpayer 10 did not use the latest OIC forms. Note that IRS Form 656, the OIC application form, was updated February, 2007.
2. The application Form 656 and documentation were incomplete with some questions unanswered or blank.
   A. The taxpayer's 10 social security or EIN numbers were missing, incomplete or incorrect.
   B. The offer was not signed and dated.
   C. Financial statement forms (433-A and 433-B) were not furnished or were incomplete.
   D. The taxpayer 10 did not include his or her deposit and application fee.
3. No monetary offer was made to settle.
4. Tax liabilities were not identified.
   A. If the taxpayer 10 owes both personal and business taxes, submit two separate OIC applications.
5. Not all past tax returns have been filed.
6. The taxpayer 10 is not up to date with tax compliance (e.g., quarterly tax remittances).

Rejections that occur later are usually for the following reasons:
1. By far the most frequent reason for denial at this point is the amount offered is not enough compared to what the IRS believes it could collect using “normal collection efforts.”
   A. For instance, their analysis may conclude that you have higher disposable income or the taxpayer's 10 assets are undervalued so he or she can afford to pay more. If this is the reason, the IRS usually counters or indicates what they would settle for in his or her case.
   B. Younger taxpayers 10 have a harder time convincing the IRS not to wait and collect more over time. Even if this is the case and the taxpayer's 10 offer is rejected, the taxpayer can ask if there is an amount they would accept to settle.
   C. The criterion used by the IRS to estimate what can be collected is the Reasonable Collection Potential test as demonstrated below.
2. The taxpayer 10 failed to supply sufficient documentation to support his or her application.
3. The taxpayer 10 did not respond within the time limits specified. If the taxpayer 10 needs more time, he or she should explain why and ask for it.
4. The IRS believes the taxpayer 10 lied or misled them in his or her application. Even suspicion that the taxpayer 10 is not being forthcoming can be grounds for rejection.
   A. For example, if the taxpayer's 10 claimed expenses greatly exceed his or her income, it raises questions as to whether the taxpayer disclosed all of his or her income.
   B. Also, the IRS may know more about the taxpayer 10 than he or she is aware, so be sure to obtain a copy of their rejection report.
5. The IRS determines there's a high probability that the taxpayer 10 cannot or will not comply with an OIC agreement, due to his or her poor financial condition and/or history of dishonoring past pledges. For example, falling behind in paying estimated taxes during the negotiations would likely disqualify the taxpayer 10, as would having defaulted on a prior OIC.
6. The IRS concludes that the taxpayer's 10 offer was not made in good faith, but rather to delay or impede collection. For instance, if the taxpayer 10 promises to pay, but later files an OIC, this could easily be interpreted as a delaying tactic.
7. The taxpayer 10 re-filed an OIC application that was turned down without offering any new facts.
8. The taxpayer 10 has a criminal record, especially if it is tax-related.
9. Occasionally the IRS declines OICs because acceptance might jeopardize overall taxpayer compliance. In other words, if others found out what the taxpayer 10 settled for, they would be less willing to pay their taxes as required. This reason is referred to as “Effective Tax Administration.”

The offer in compromise software method and system in accordance with the present invention should prevent many of the above mistakes. This section describes the use of the IRS's Reasonable Collection Potential (“RCP”) test to plan and implement a sample OIC. The purpose is to familiarize the taxpayer 10 with the offer in compromise software and demonstrate how to settle an IRS debt for substantially less than the amount owed. Other, more complex examples described below show the step-by-step process of strategizing an OIC.

### Example #1

### Jeff I. O. Alot's OIC Strategy

The offer in compromise software application is preferably included in the solution algorithms 130 shown in FIG. 1. First, open the offer in compromise software application and save a file titled “Jeff Alot before.” This allows the taxpayer 10 to enter data without making changes to the OIC calculator template. Create a separate file each time the taxpayer 10 starts a new case or runs a scenario he or she wants to save.

Assume Jeff I. O. Alot wants to test the feasibility of applying for an OIC. Enter the following in the Monthly Multiplier spreadsheet:
1. “1/15/2007” in cell E3 (Date of Analysis)
2. “Jeff I. O. Alot” in cell M3 (Taxpayer's Name)

His name and the date are automatically copied to the other spreadsheets, so do not enter data in the light blue cells as these contain copied data or formulas. Read the text in the spreadsheet to learn about the IRS's Monthly Multiplier which will help to understand what follows.

Jeff elects to pay the full settlement amount upon approval of his OIC, so enter:
3. “C” in cell L26

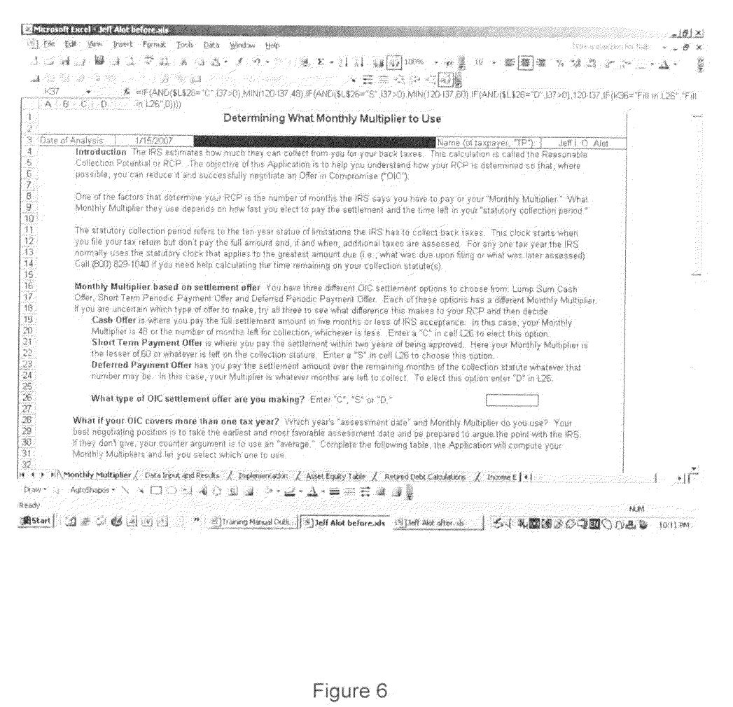

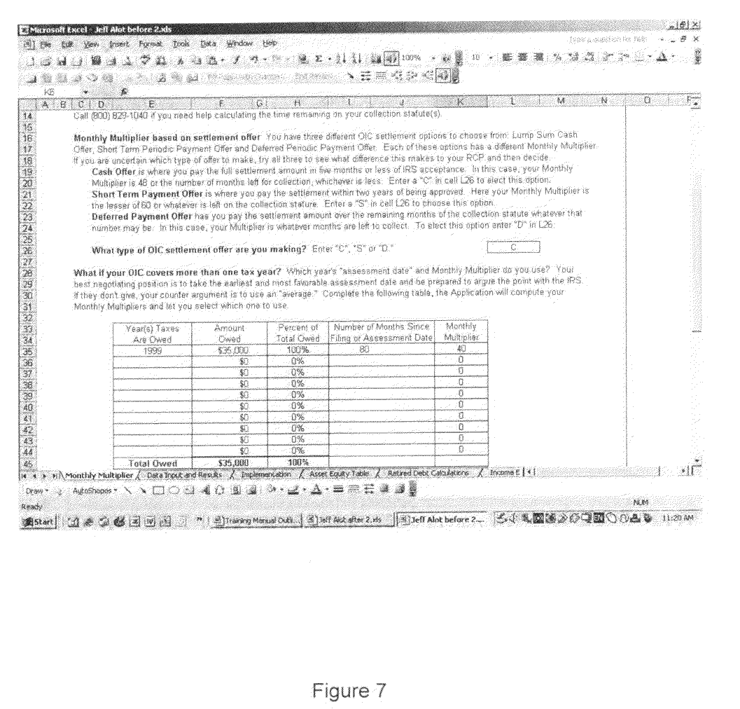

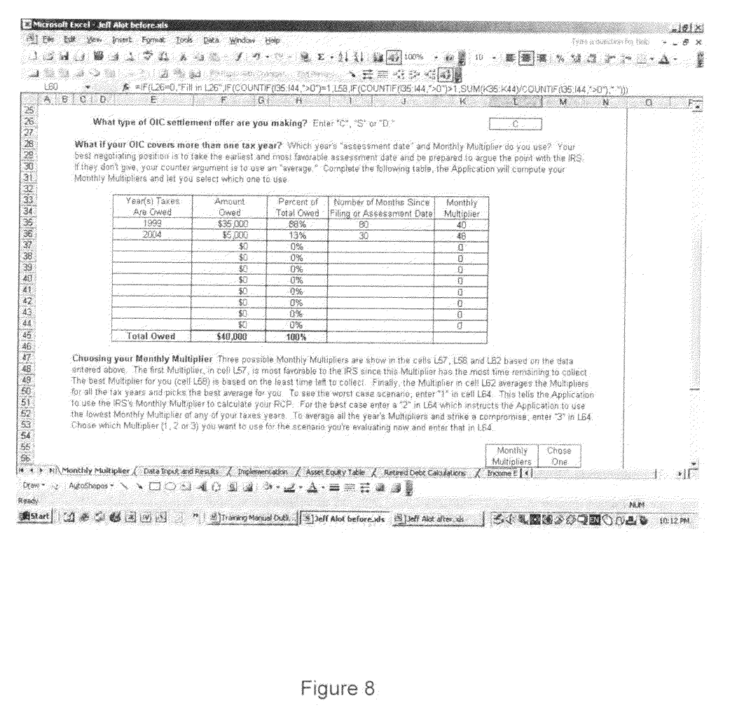

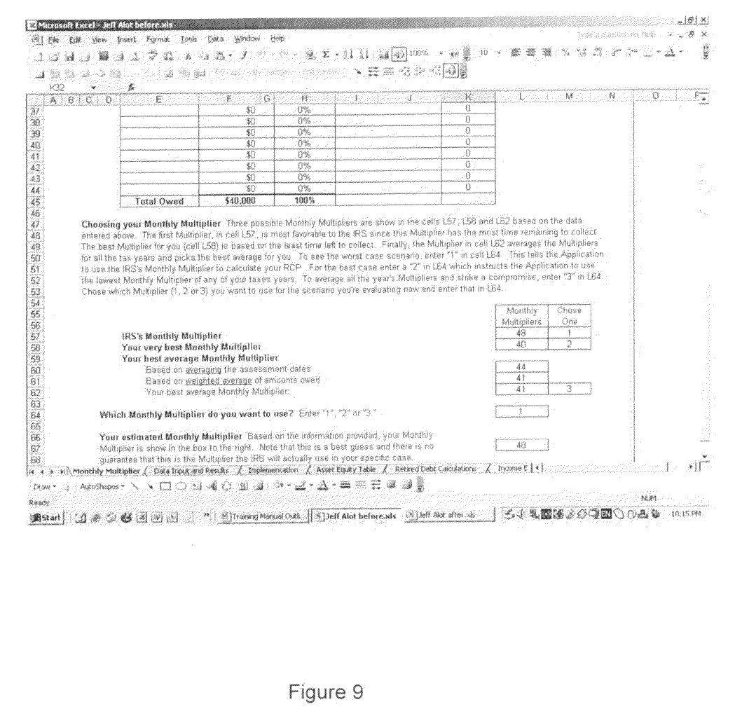

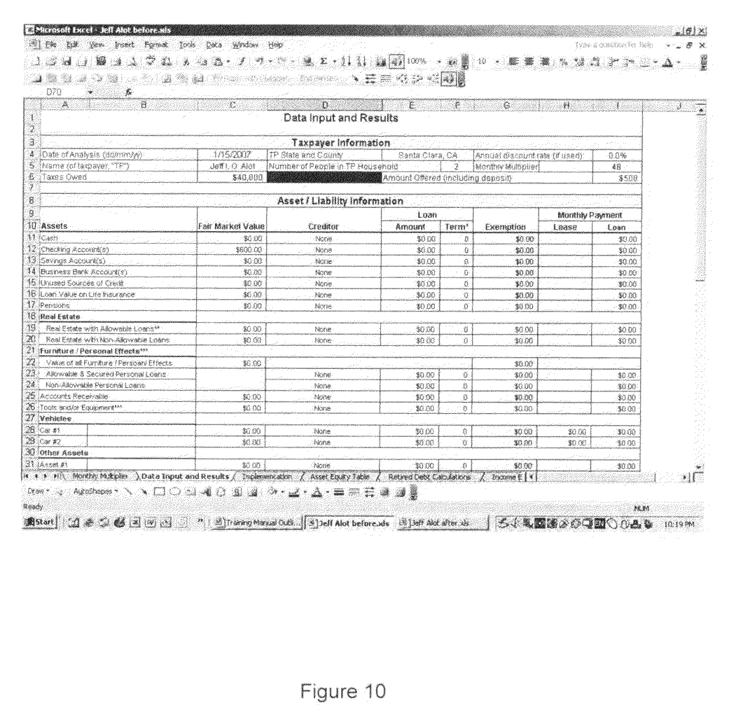

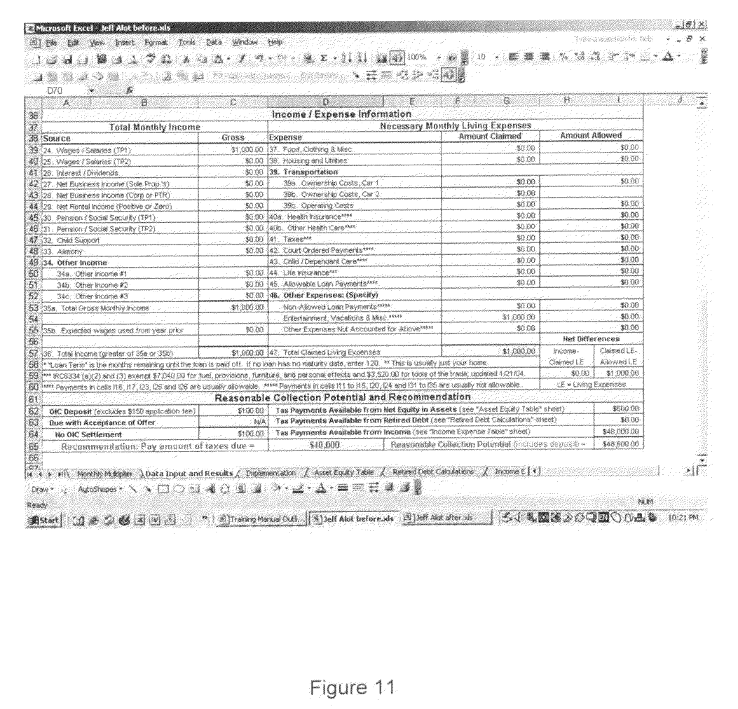

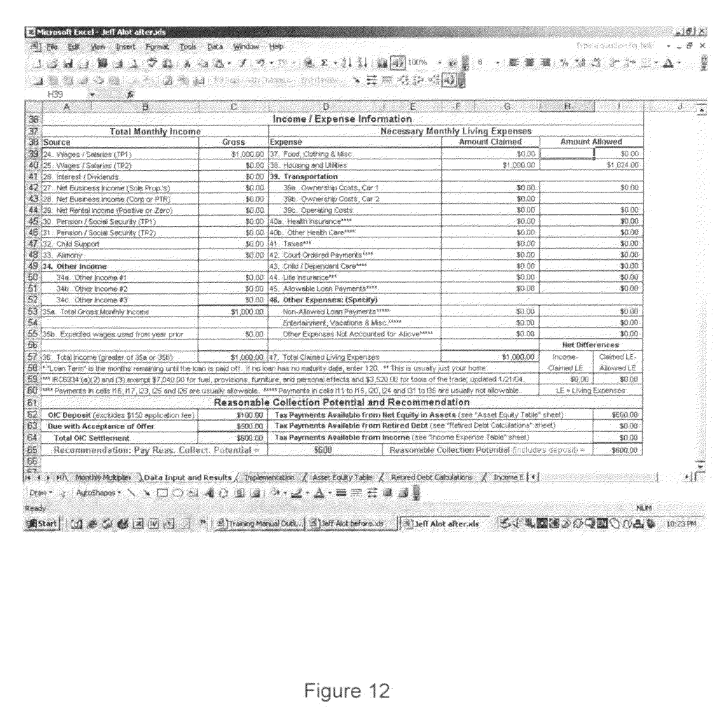

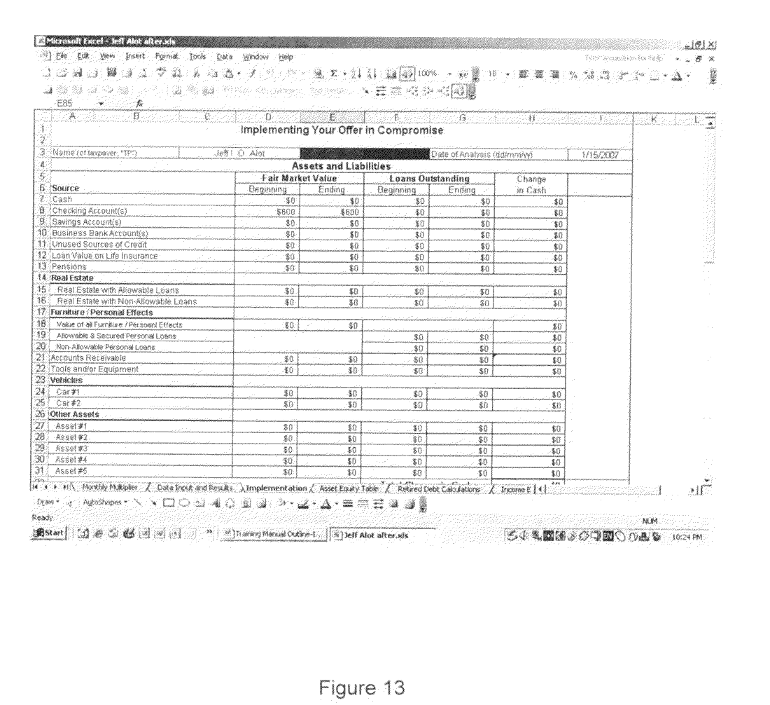

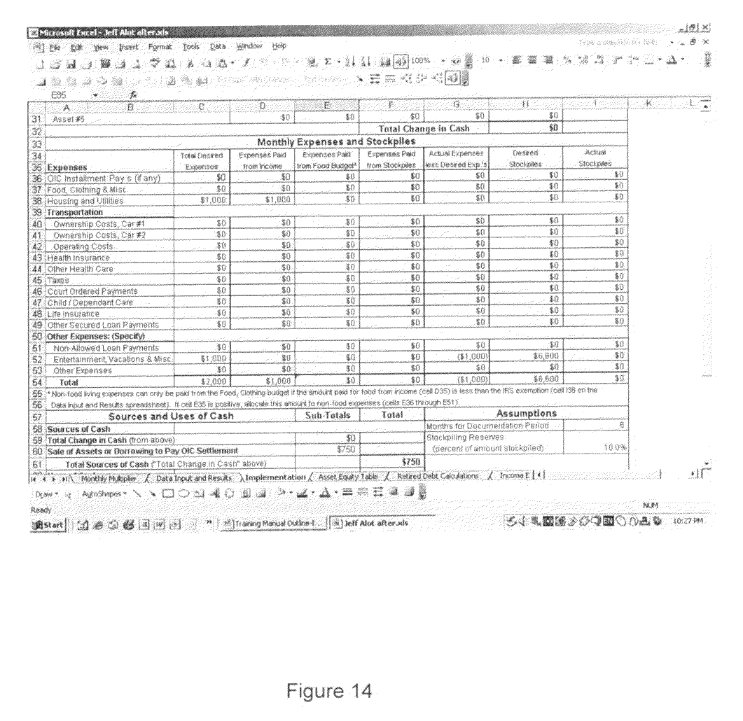

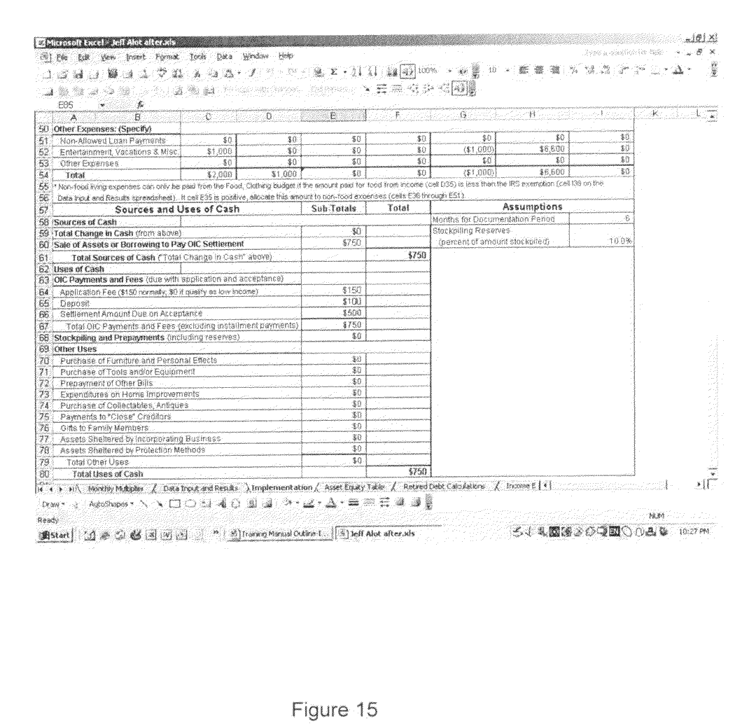

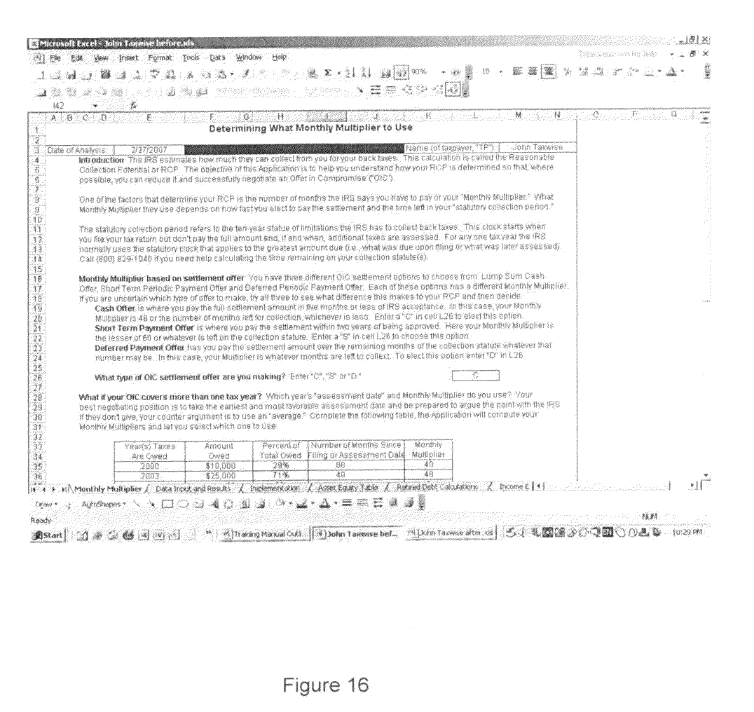

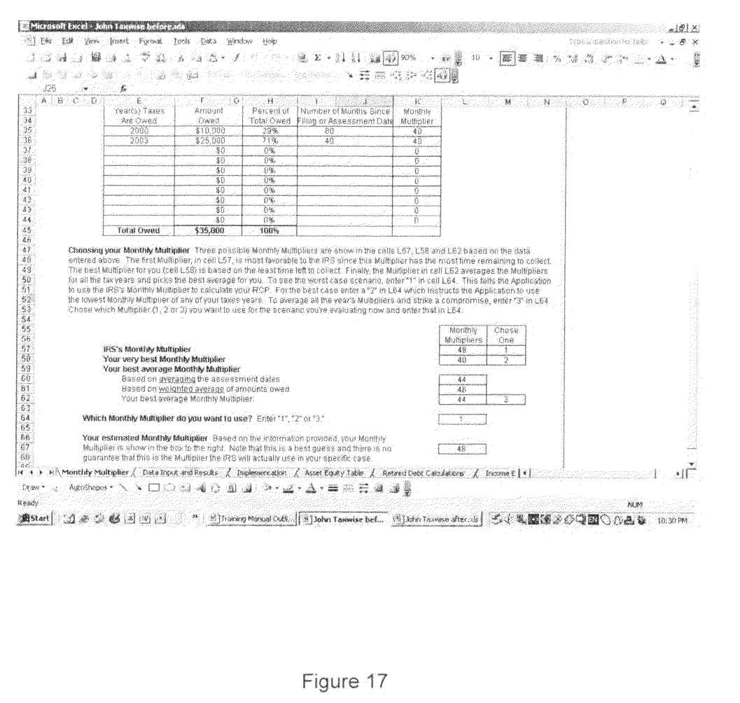

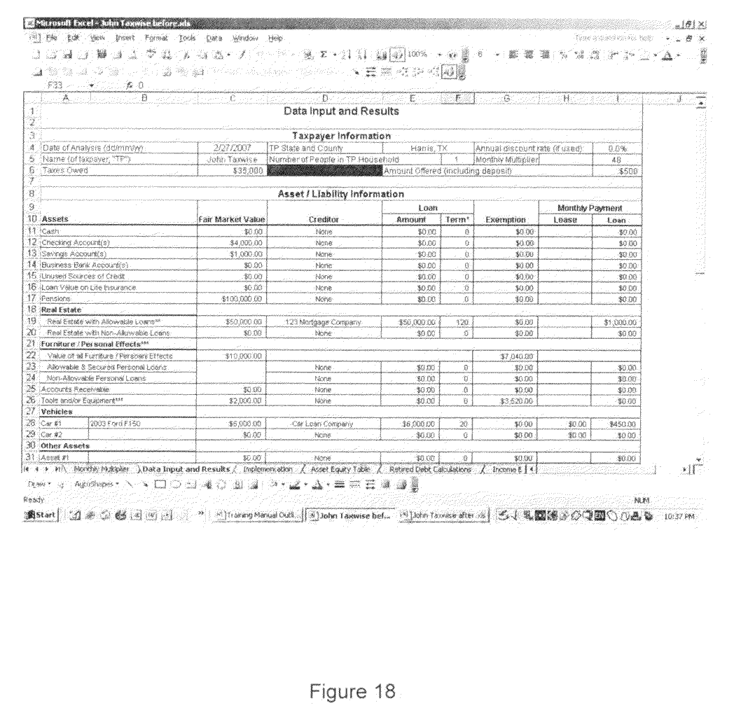

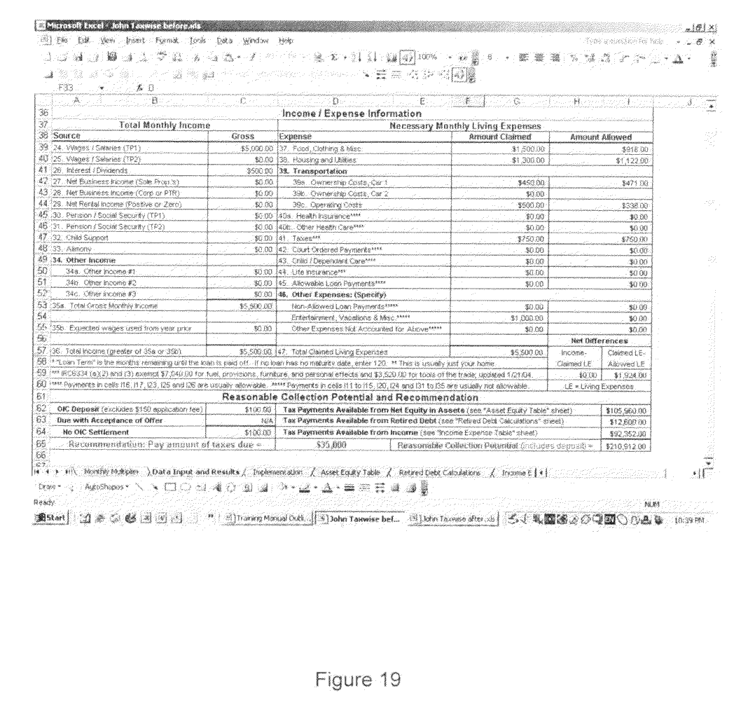

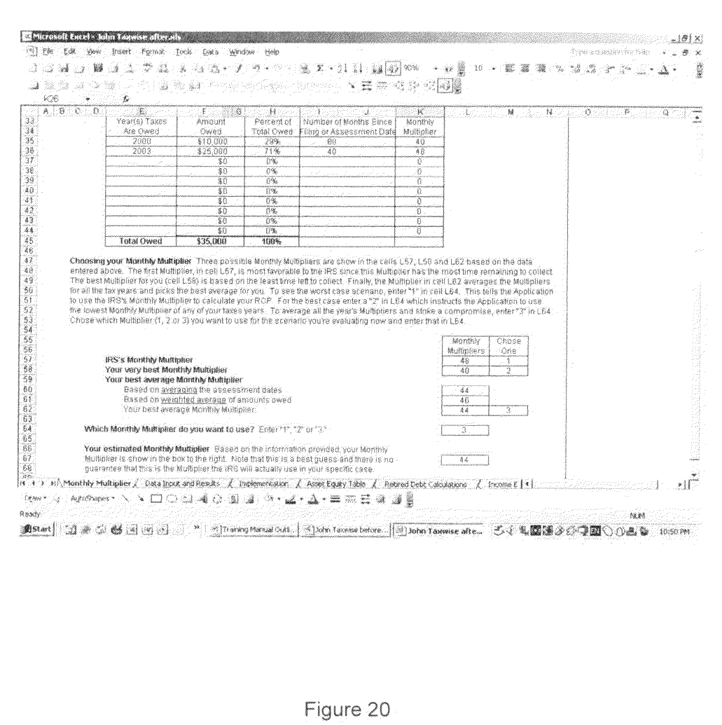

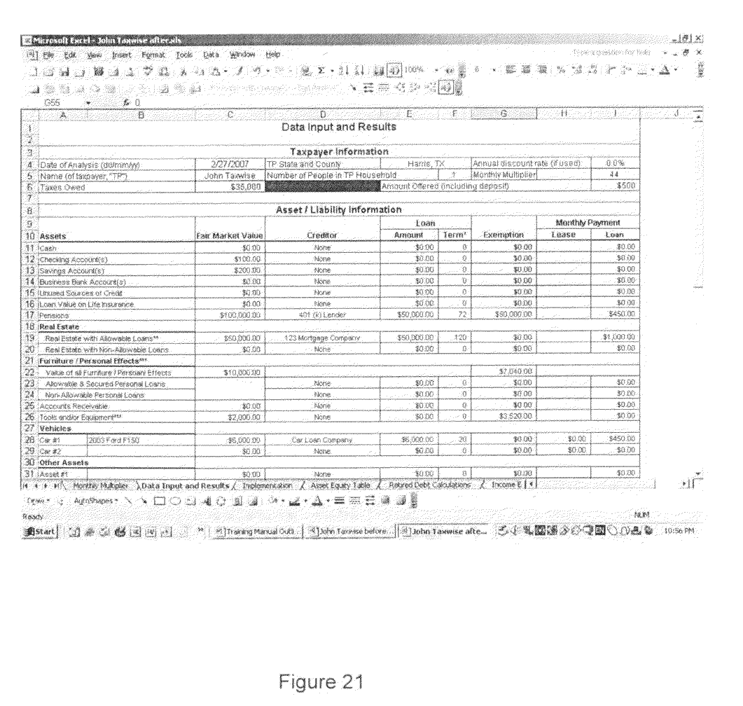

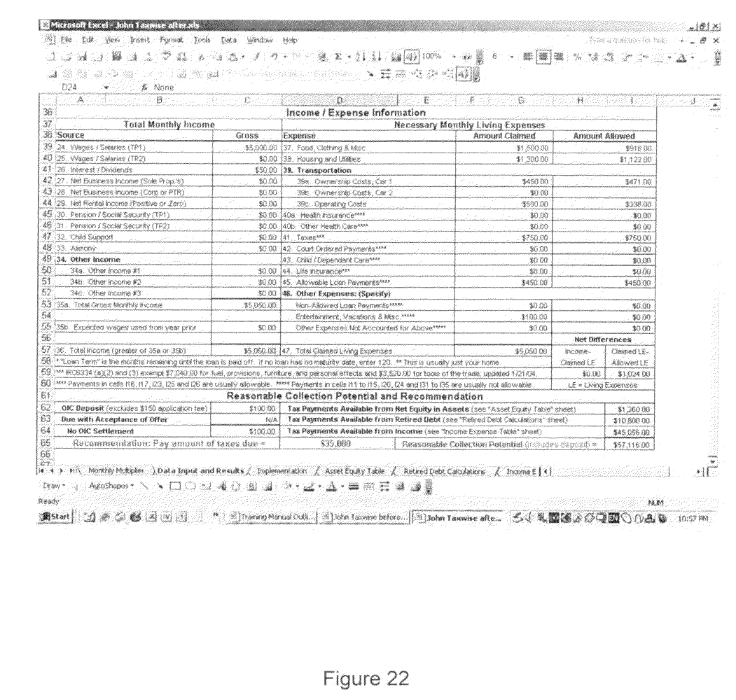

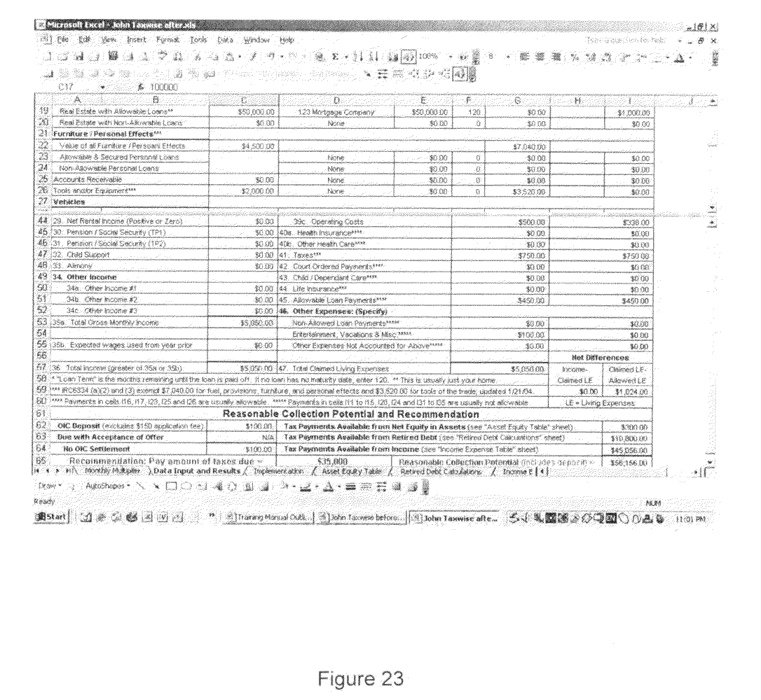

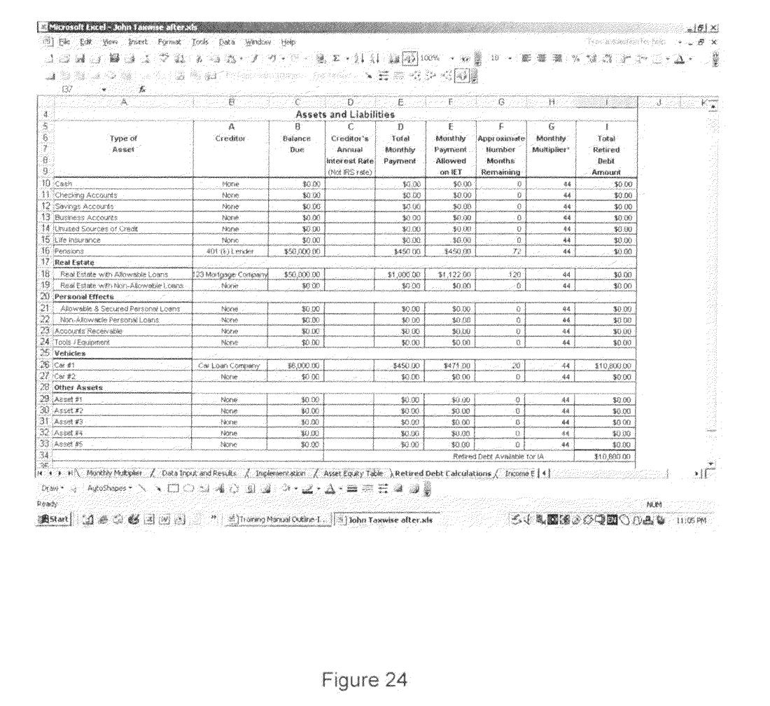

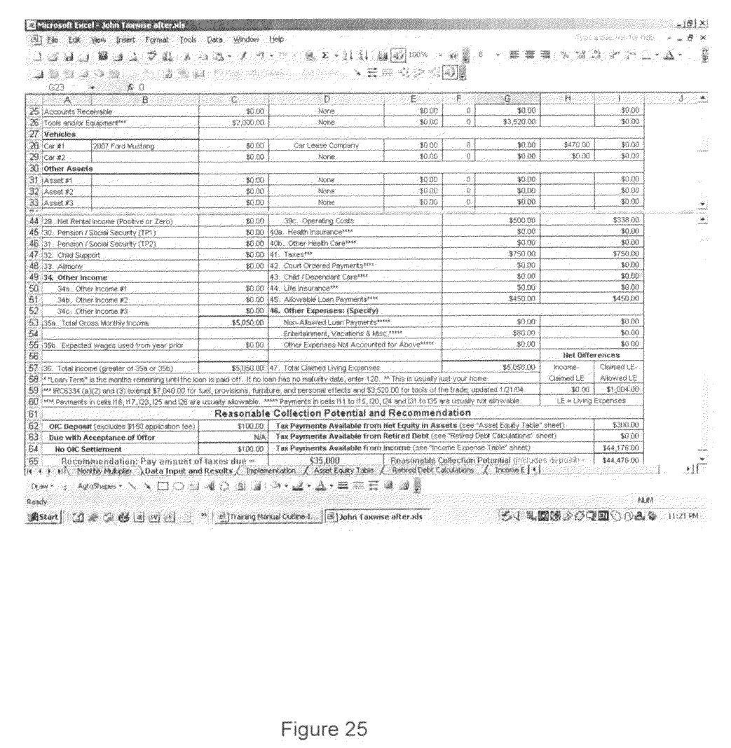

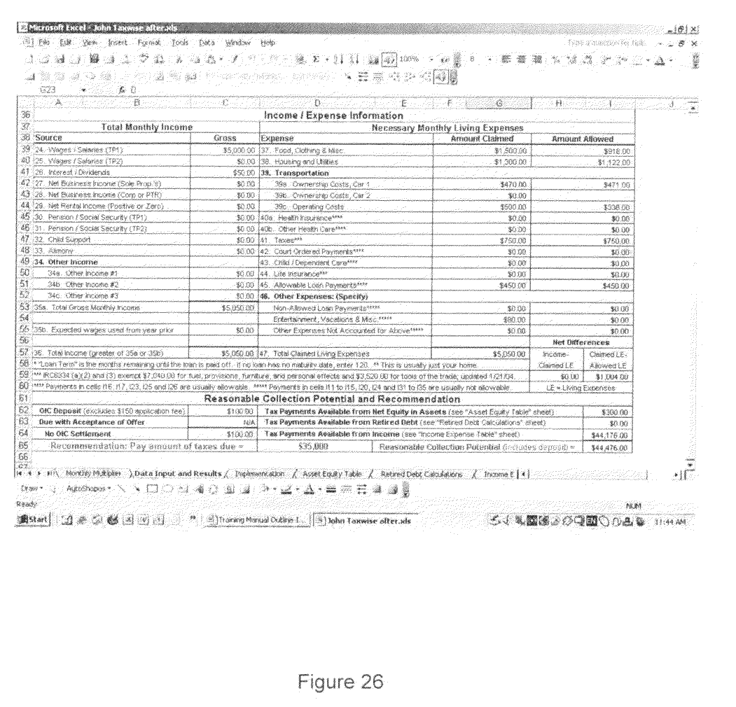

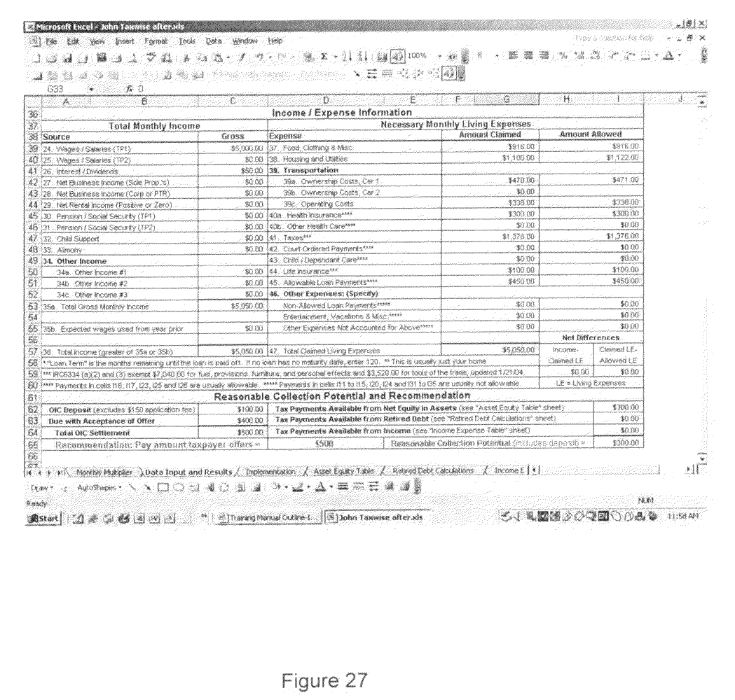

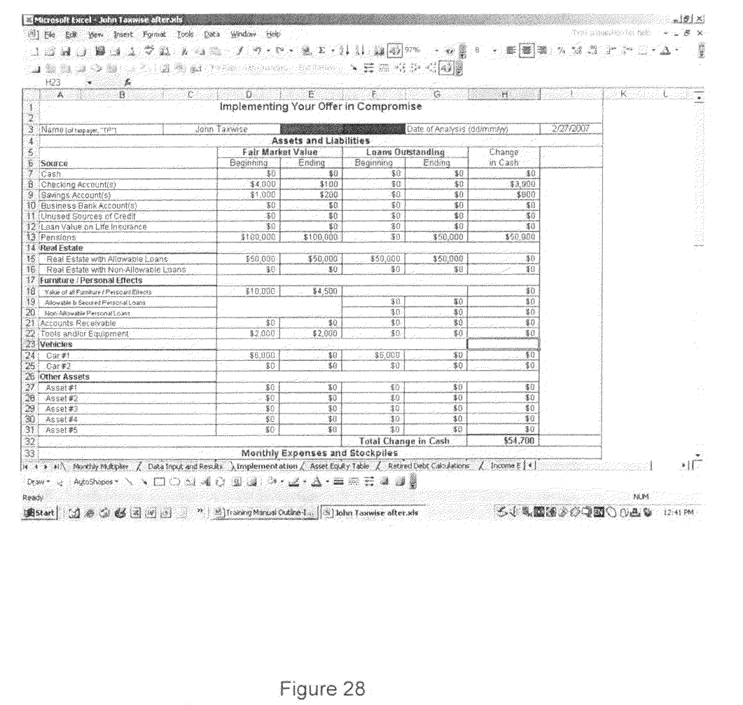

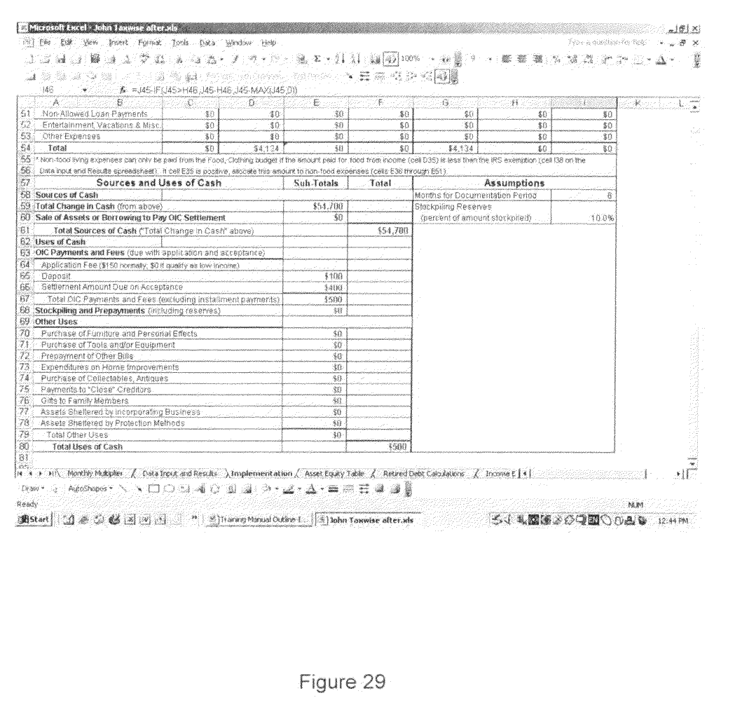

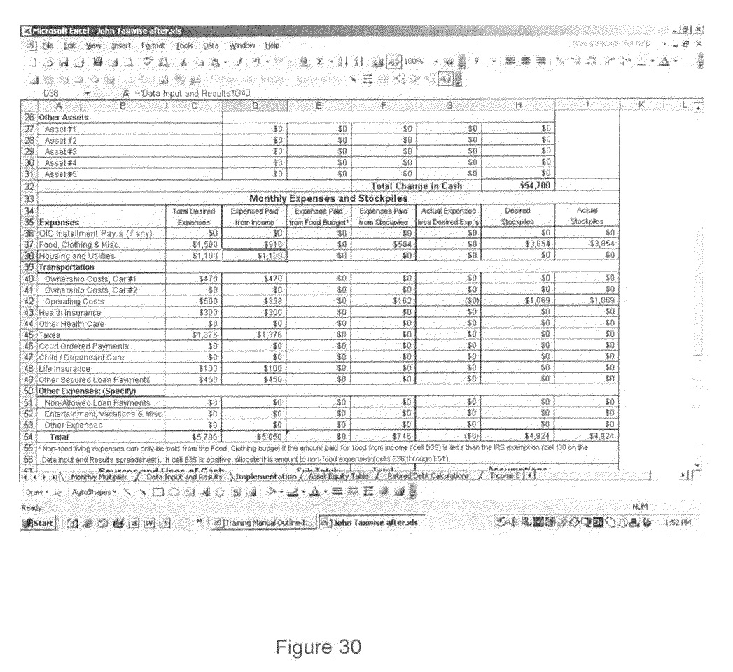

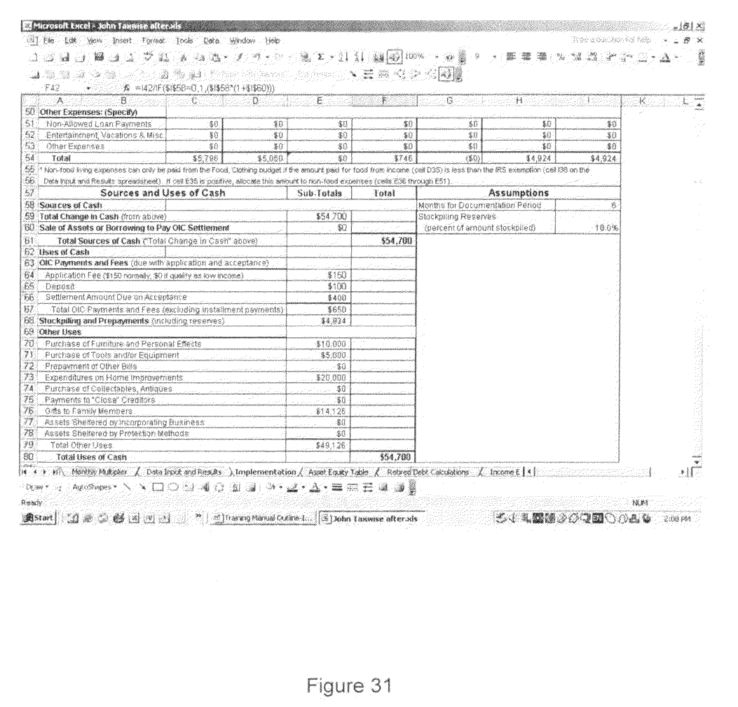

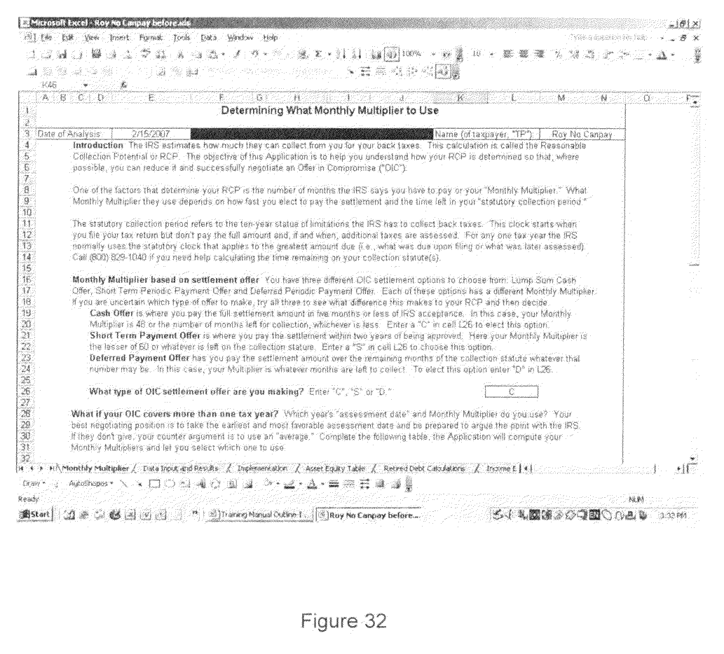

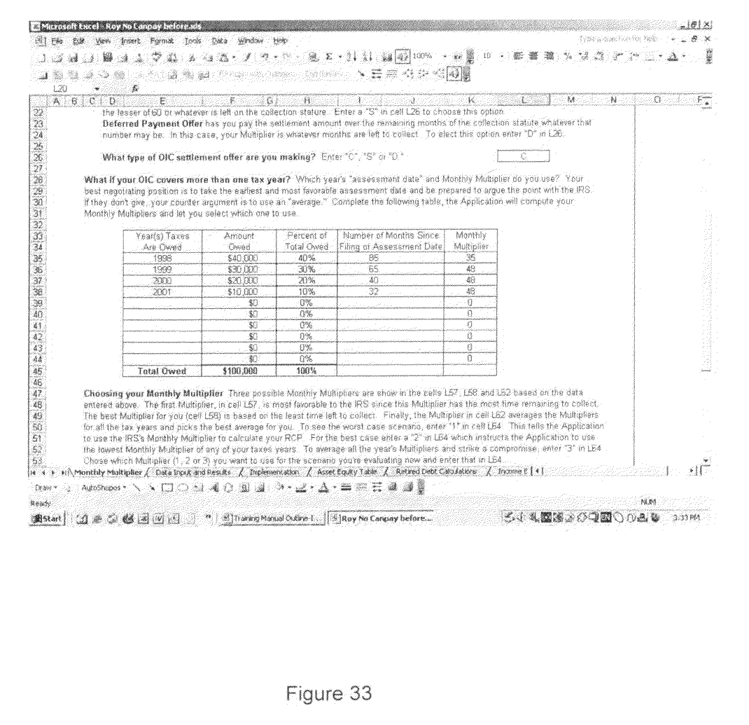

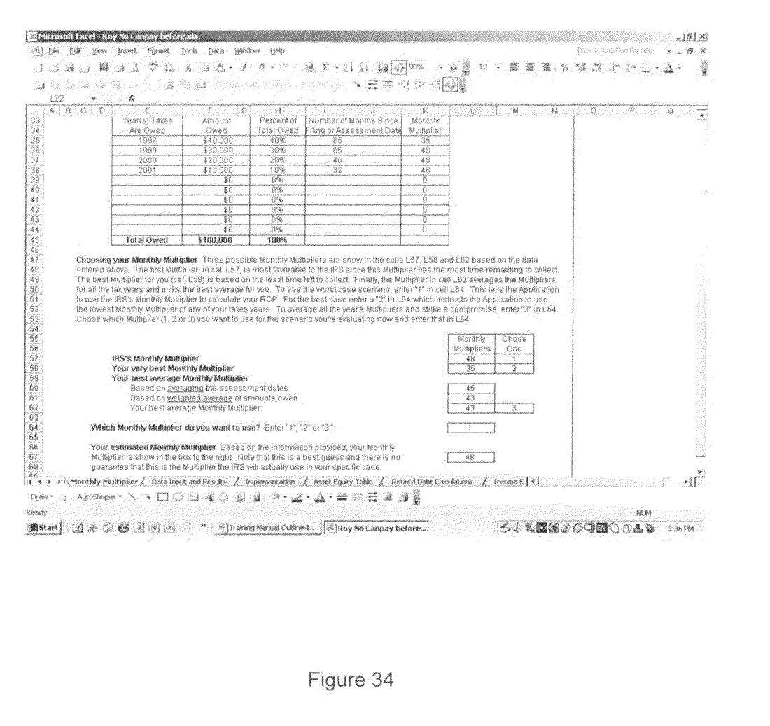

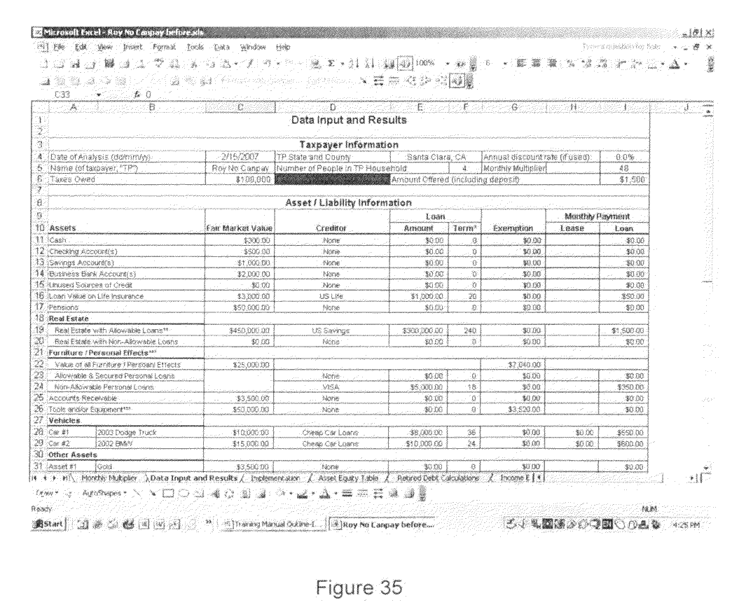

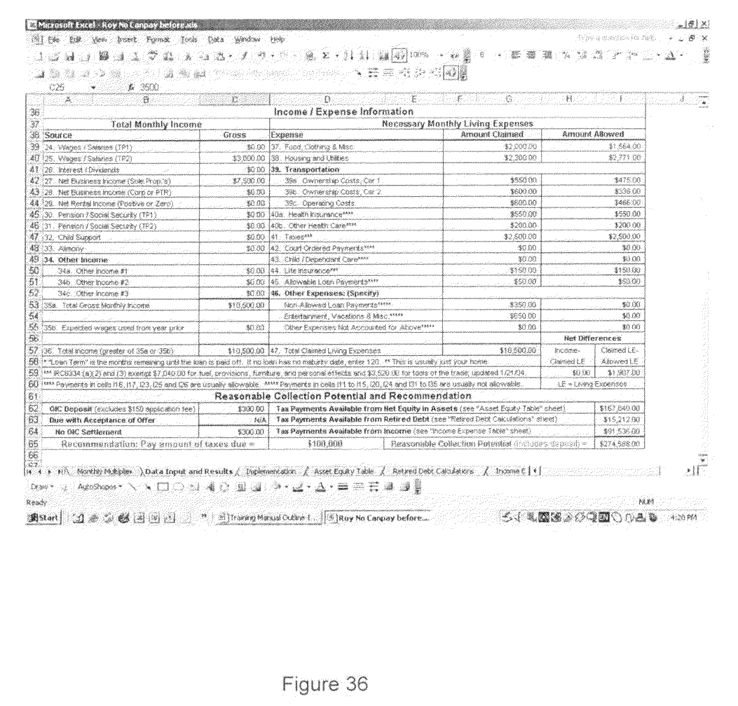

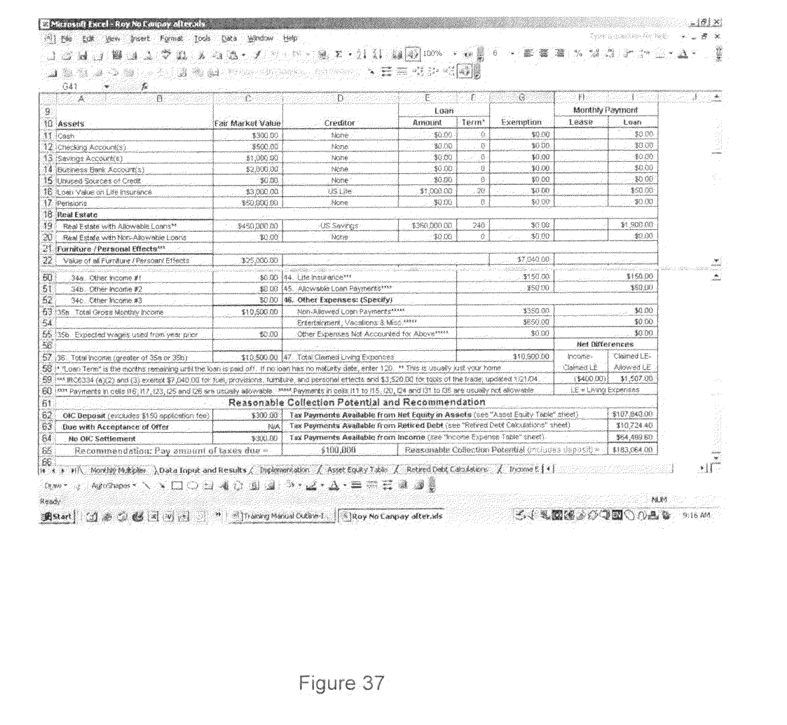

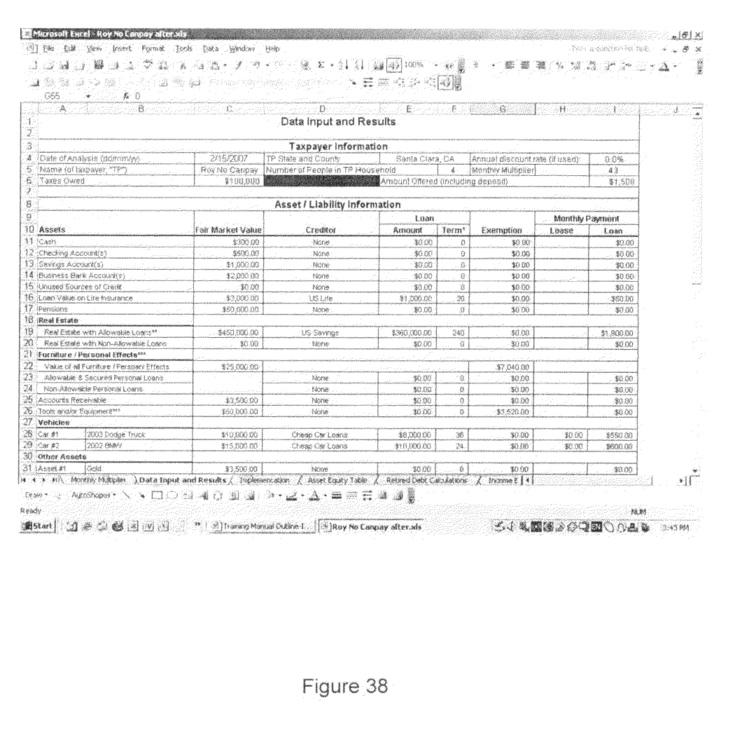

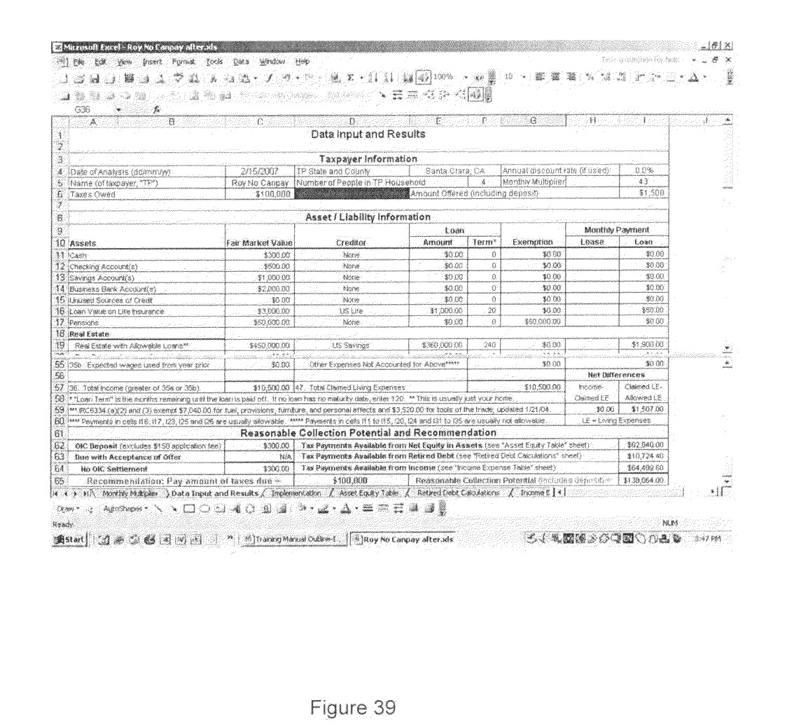

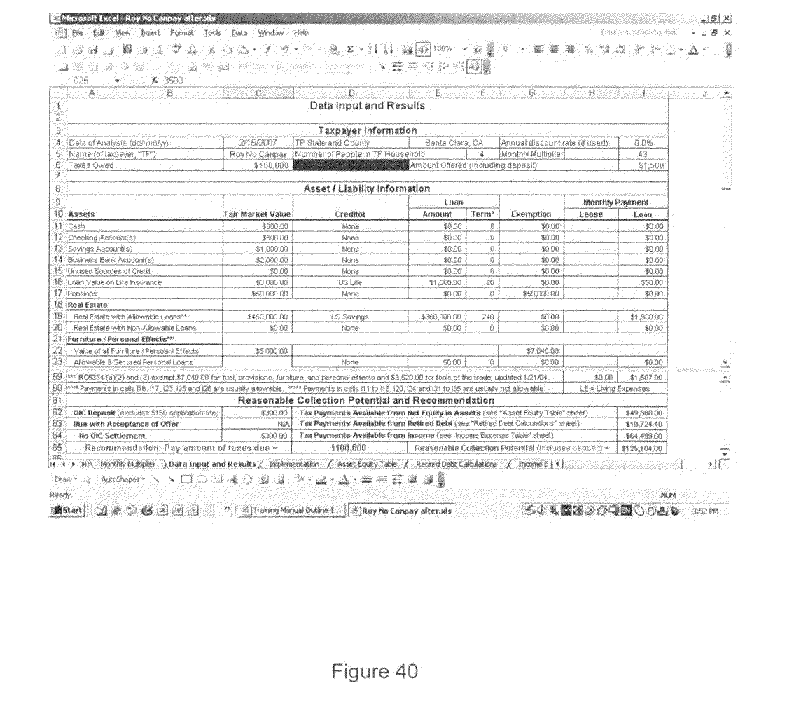

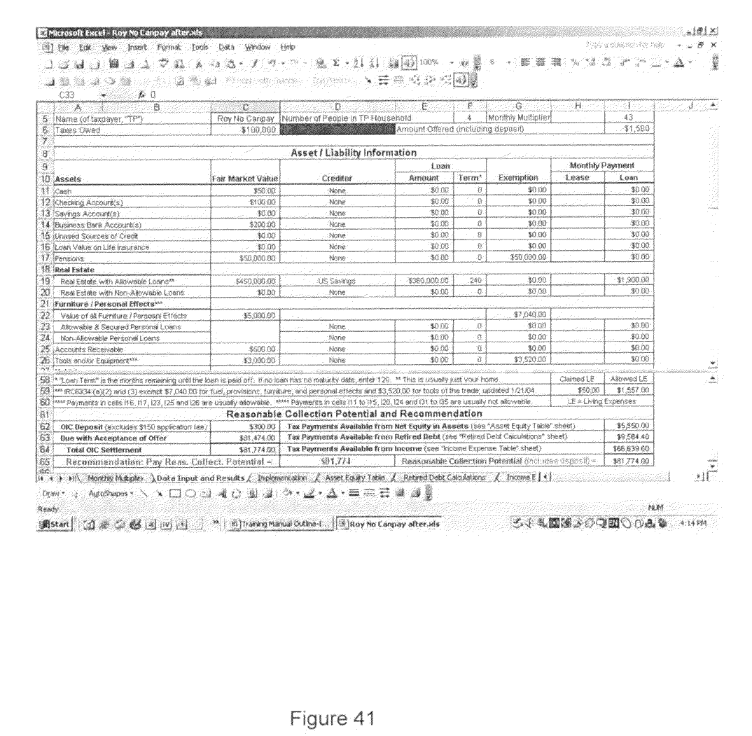

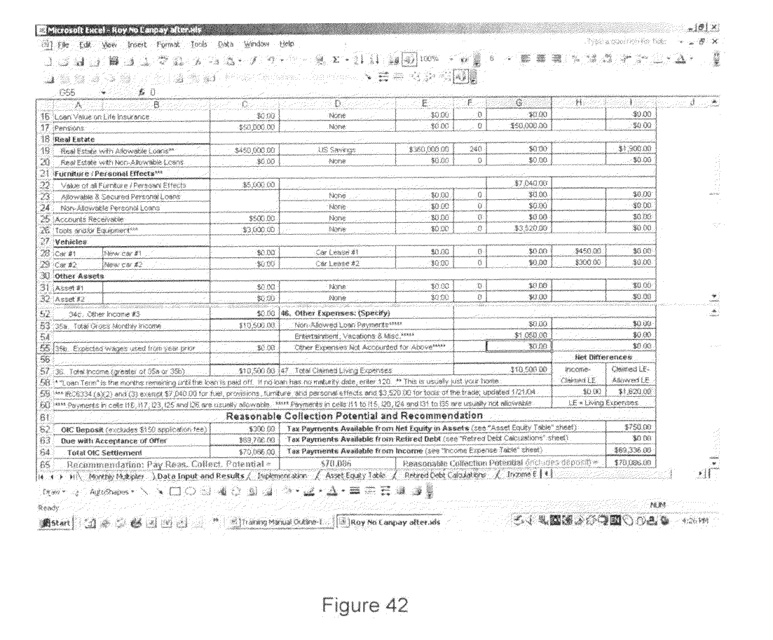

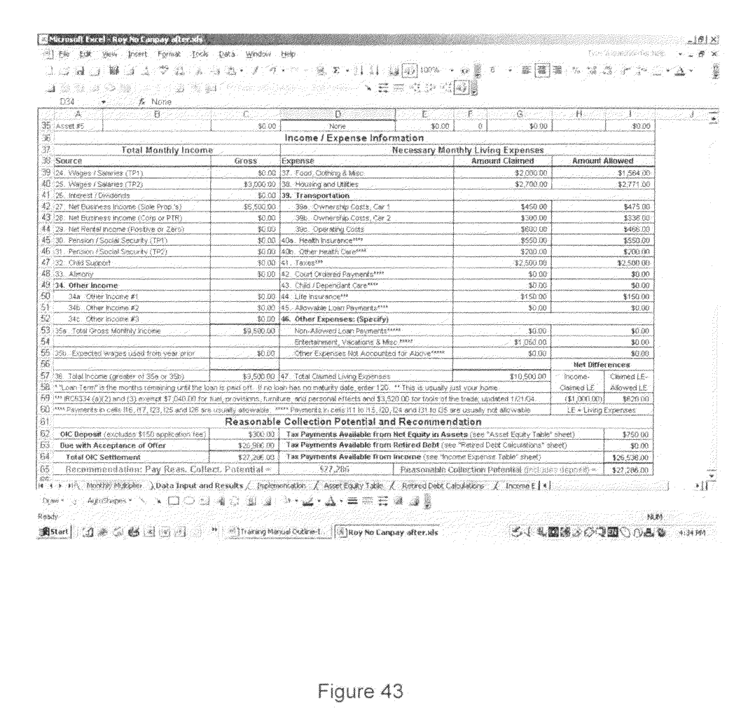

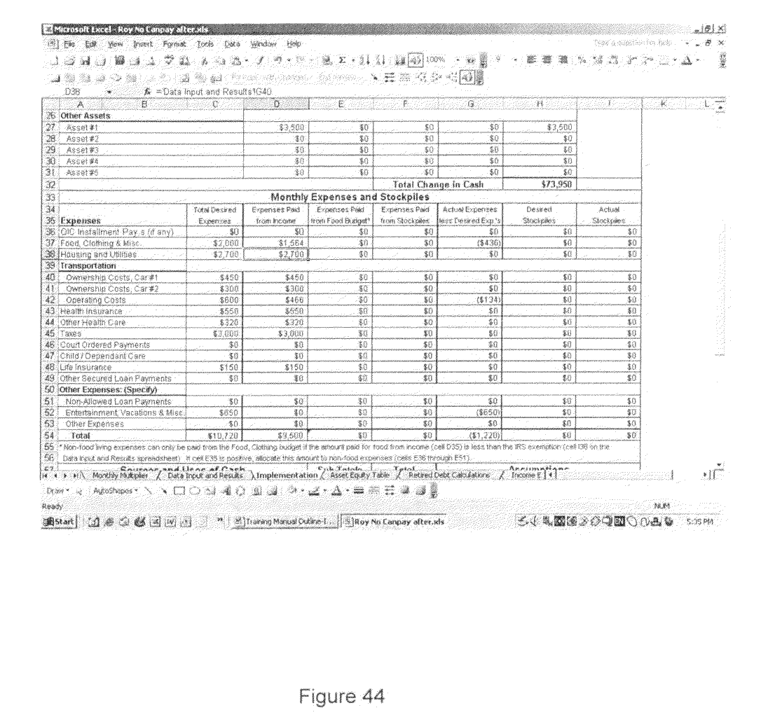

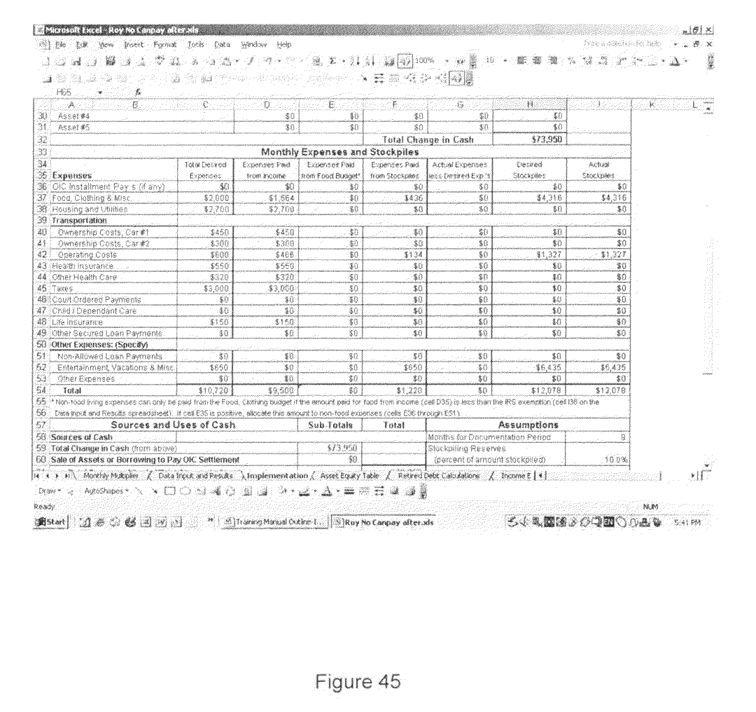

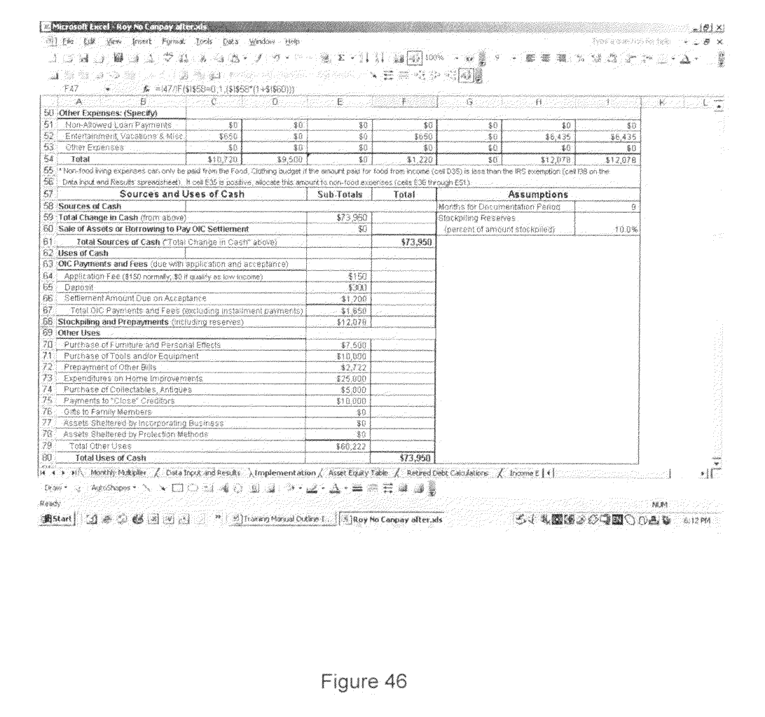

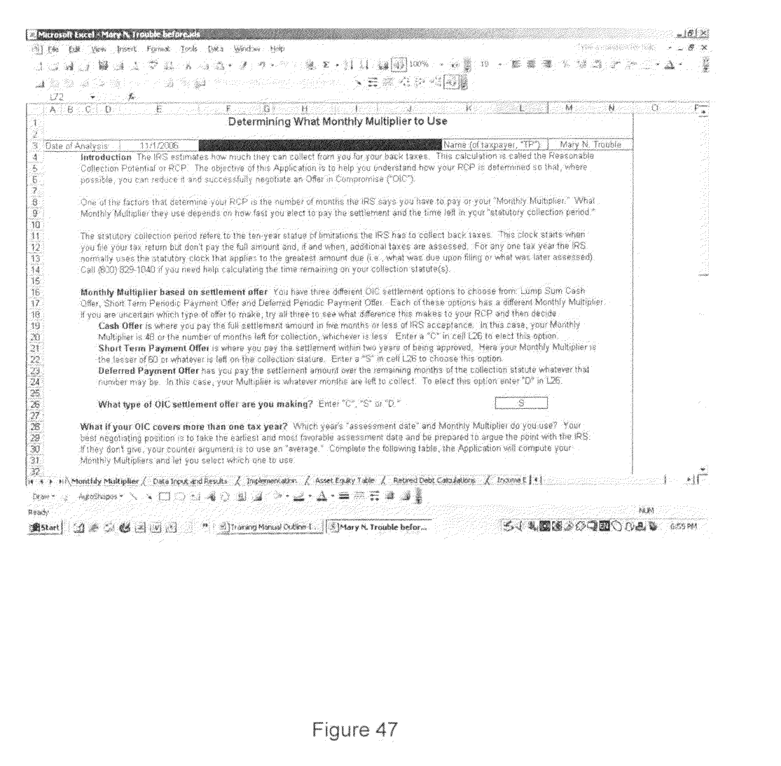

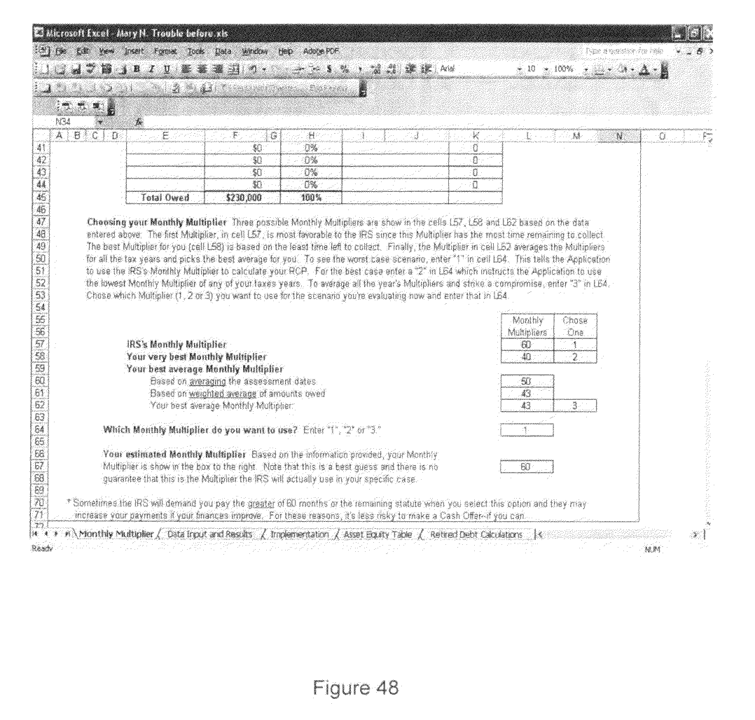

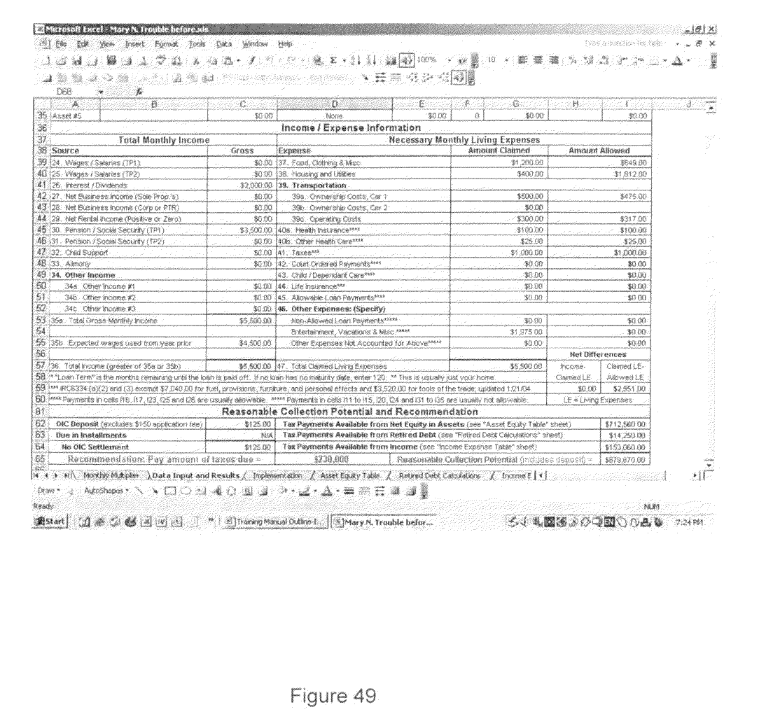

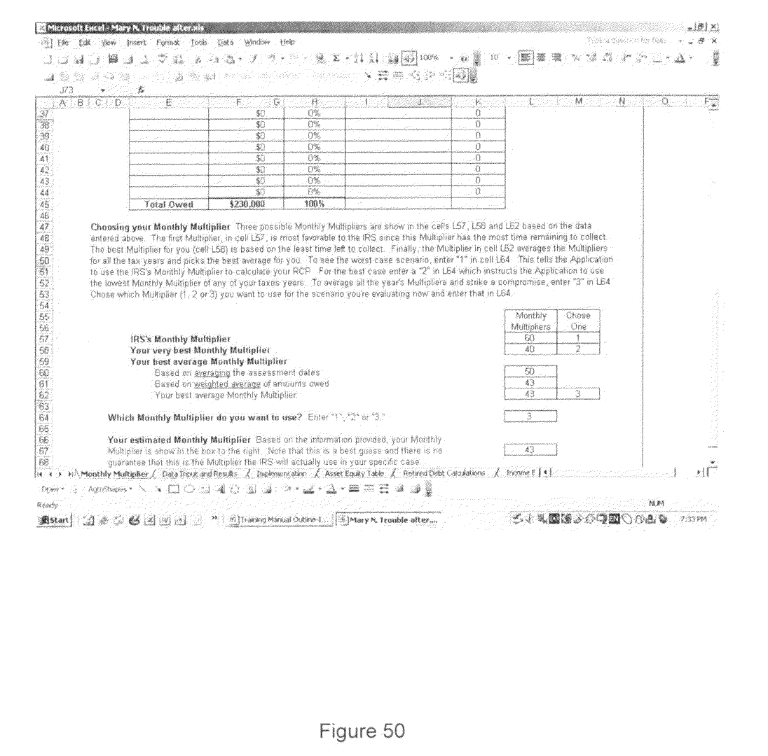

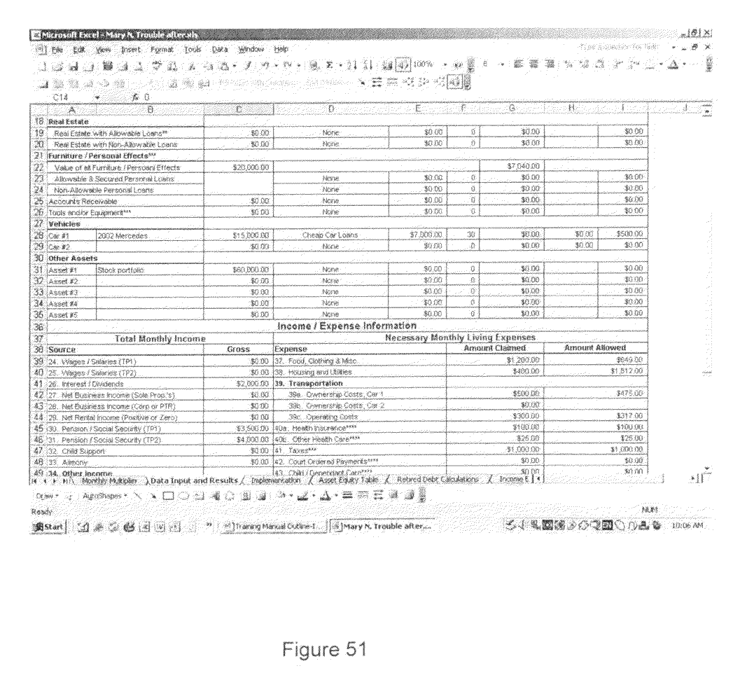

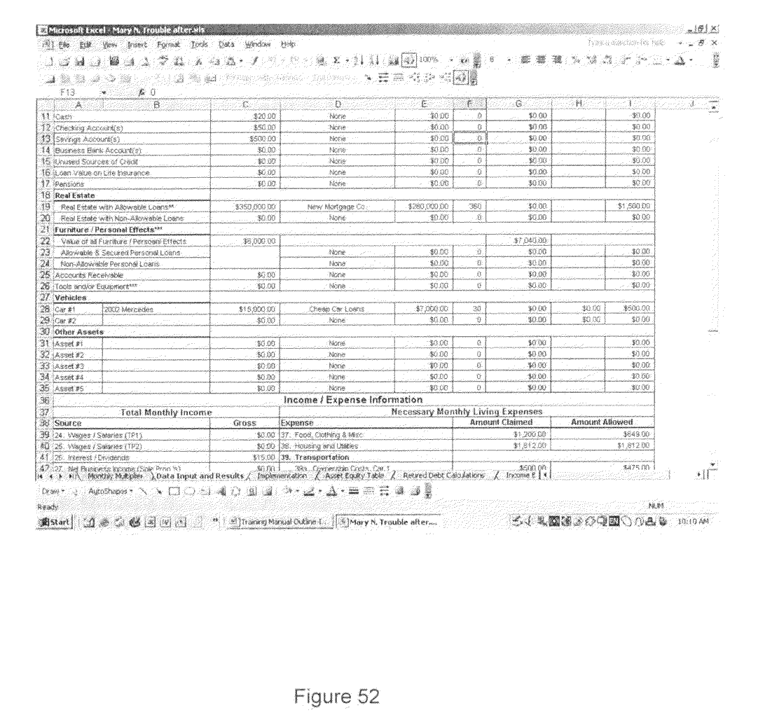

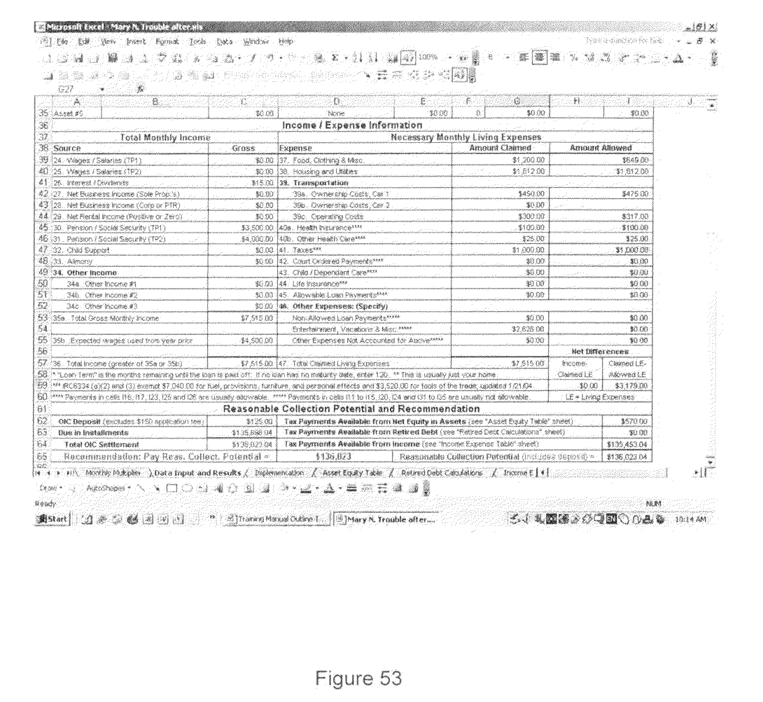

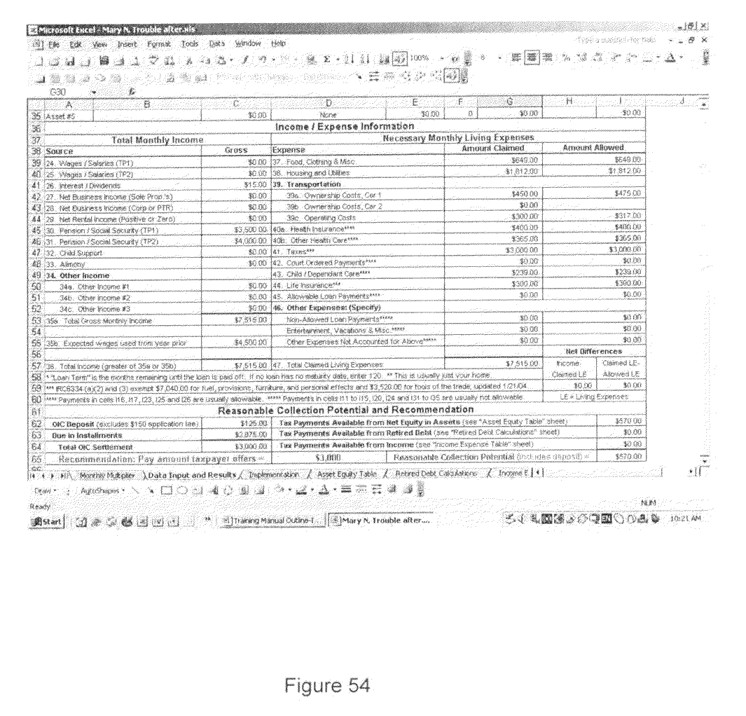

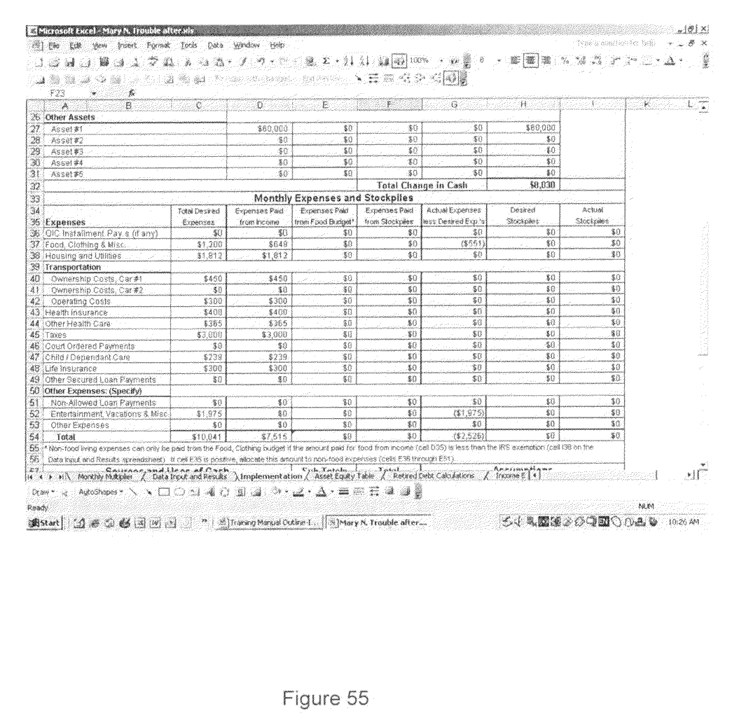

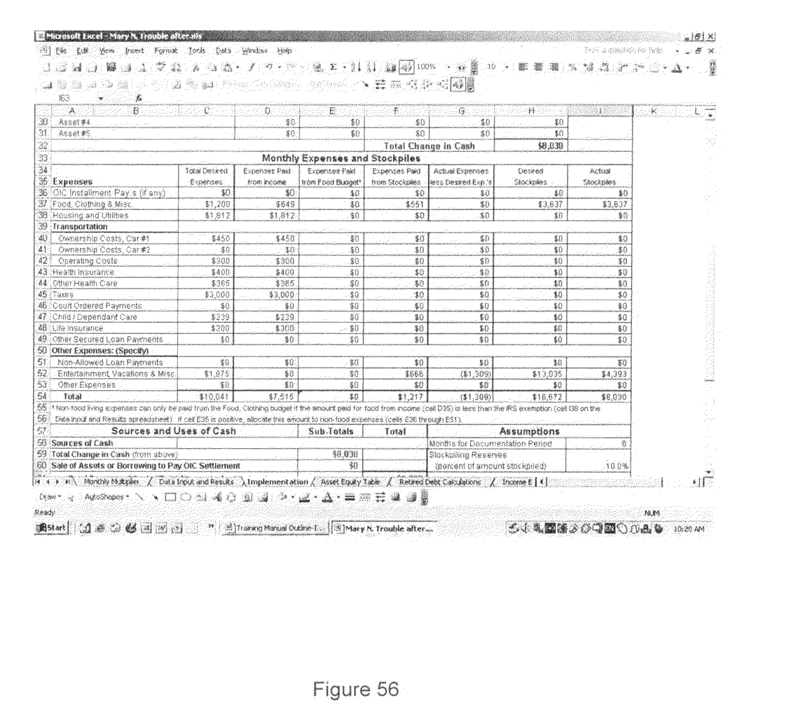

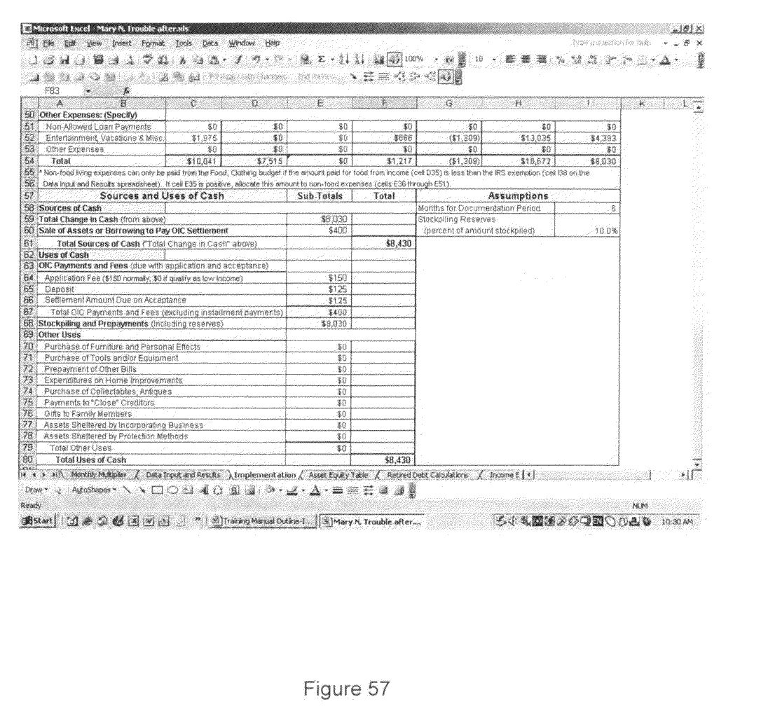

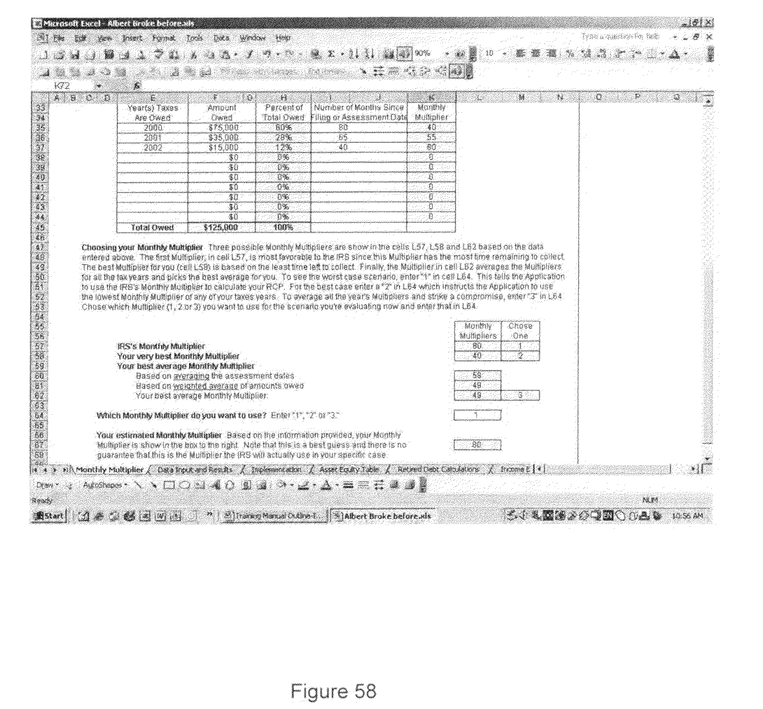

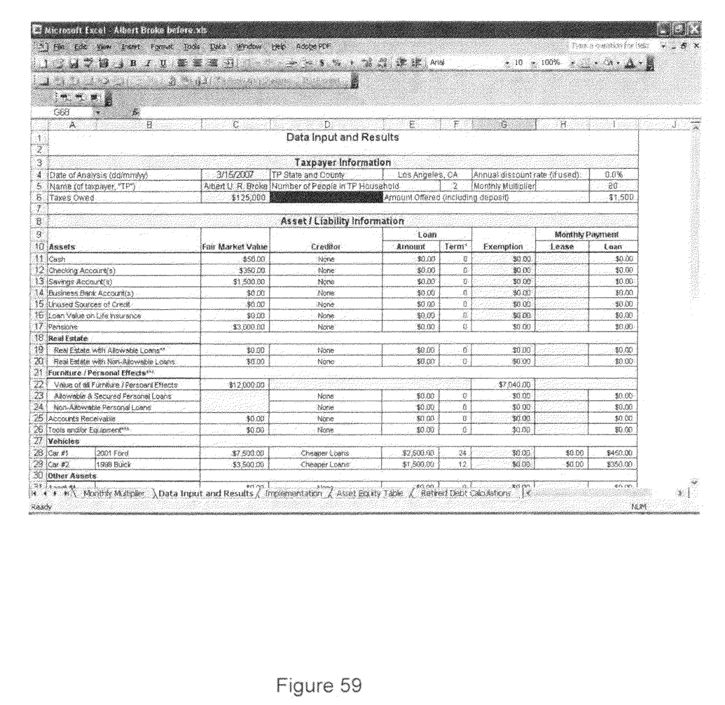

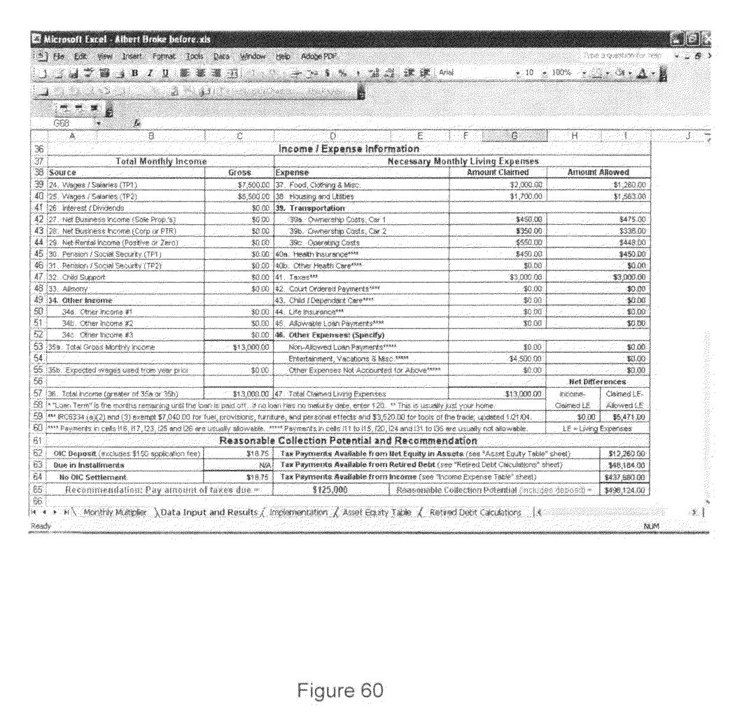

### See FIG. 6.

Next, fill in the table, starting in row 35, with this data:
4. “1999” in cell E35 (first year back taxes are owed)
5. “35000” in cell F35 (total taxes, penalties, and interest owed)
6. “80” in cell I35 (number of months since the first tax deficiency notice was received for this year)

### See FIG. 7.

Three Monthly Multipliers are computed and shown in the cells L57, L58, and L62 along with an explanation of each. Since only one tax year was entered, all three multipliers are the same. Now input a second year with taxes due:
7. “2004” in cell E36 (second year back taxes are owed)
8. “5000” in cell F36 (total taxes, penalties, and interest owed)
9. “30” in cell I36 (number of months since the first tax deficiency notice was received for this year)

### See FIG. 8.

With two years to analyze the multipliers diverge: a) the IRS uses the most recent first tax notice date (30 months ago) as shown in L57; b) Jeff's best multiplier, L58, is based on the oldest tax notice data (80 months ago); and c) the offer in compromise software application computes two averages of these extremes and reports back the average that is most favorable to him (see L62).

### See FIG. 9.

Choose one of the three Monthly Multipliers to use in the analysis by entering a “1”, “2”, or “3” in cell L64. Jeff wants to investigate how the IRS would regard his situation, so type:
10. “1” in cell L64 (the Monthly Multiplier being selected; in this case, the IRS's multiplier)

Input Jeff's current personal and financial data into the Data Input and Results spreadsheet (see tabs at the bottom of the Excel program):
11. “Santa Clara, Calif.” in E4 (taxpayer's county and state of residence)
12. “0” in cell I4 (he chooses not to discount future cash flows as described in more detail below

### See FIG. 10.

13. “2” in cell F5 (number of people in taxpayer's household)
14. “500” in cell I6 (amount offered to settle OIC).

Keep in mind the new OIC rules require a non-refundable deposit equal to either a) 20% of the amount offered for lump sum settlements or b) the first installment for settlements that are paid over time. Since he is making a cash offer, his deposit in cell C62 is 20% of $500 or $100. Continue entering his financial data:
15. “600” in cell C12 (checking account balance)
16. “1000” in cell C39 (monthly wages from first taxpayer)
17. “1000” in cell G54 (Entertainment, Vacations & Misc. spending);
   All his income is accounted for so his total income (cell C57) equals his total claimed living expenses (G57) and the Net Difference in cell H59 is zero.

### See FIG. 11.

Using the calculation of reasonable collection potential (or an embedded equivalent if the offer in compromise software application is a stand alone software application), the offer in compromise software application now shows Jeff's Reasonable Collection Potential (RCP) of $48,600 in cell I65 (i.e., his Monthly Multiplier of 48 times $1,000 plus $600 from his assets). The RCP is the IRS's estimate of what they can collect from him. Since this is greater than what is owed, Jeff would not qualify for an OIC and the IRS would require all taxes be paid in full (see A65 and D65). If he had applied, his deposit in C62 will have been applied to his tax liability but he would have forfeited his application fee of $150. Actually, given his low income, he would likely have filed IRS Form 656-A, Income Certification for Offer in Compromise Application Fee and Payment, to have the OIC application fee waived.

As things stand now his application would be rejected. But that can be fixed as shown below. Save the “Before” file and create a new “After” one that will be used to strategize how to reduce Jeff's RCP:
1. Save the “Jeff Alot before” file to retain prior work
2. Now using the “Save As . . . ” command, save the same file again under another name, “Jeff A lot after.”

Jeff can justifiably argue that the IRS's Monthly Multiplier overstates his true situation and that an average multiplier is much more appropriate. Also, he starts paying $1,000 per month to his in-laws for housing and utilities, which is $24 less than what the IRS allows in his case. To make these changes, enter:
3. “3” in cell L64 of the Monthly Multiplier spreadsheet (this automatically selects the lowest average Monthly Multiplier)
4. “1000” in cell G40 of the Data Input and Results spreadsheet (monthly claimed Housing and Utilities bills)
5. “1024” in cell I40 of the Data Input and Results spreadsheet (the IRS monthly allowance for Housing and Utilities; where to find this number is described below)
6. “0” in cell G54 (Entertainment, Vacations & Misc.);
   All of his income now pays for rent so his income and expenses are equal and cells H59 and I59 are zero. Thus, Jeff's RCP is cut to $600 and the IRS's recommendation in cells A65 and D65 changes to pay the RCP since it is more than his offer of $500. Even so, this amount saves $35,400 in taxes so he is happy to remit it.

### See FIG. 12.

Jeff has a plan but now he must test its feasibility and specify the financial adjustments required to execute it. Go to the Implementation spreadsheet and fill in this data:
7. “600” in cell D8 (Checking Account beginning balance)

### See FIG. 13.

8. “1000” in cell C38 (his desired spending on Housing and Utilities)
9. “1000” in cell C52 (assuming he desires to continue spending this amount on Entertainment, Vacations & Misc. outlays)
10. “6” in cell I58 (the number of months he needs to document his finances)
11. “10” in cell I60 (the percentage of reserves he wants for stockpiling and prepayment of expenses, as described in more detail below)

### See FIG. 14.

The offer in compromise software application compares the beginning and ending entries, so these observations can be made about his plan: There were no changes to his assets or loans so the Total Change in Cash, H32, is zero. If money had been freed up, this could be applied to purchasing stockpiles, prepaying expenses, submitting the OIC charges, or other uses.

For example, his Total Desired Expenses (cell C54) is $2,000 or $1,000 more than his income (cell D54). Cell G52 shows this shortfall occurs: $1,000 less spending for Entertainment, Vacations & Misc. than Jeff would like. It would take a stockpile, or pre-payment of expenses totaling $6,600 (cell H52), to maintain his entertainment budget at the desired level over the documentation period ($1,000 per month times six months plus a 10.0% reserve).

More will be described about stockpiles and prepaid expenses below, but if any amounts were spent in this manner, they would have to be disclosed on his financial statements as part of the OIC application. The overall consequences of his OIC settlement are shown starting in row 57. Enter his OIC application fee:
12. “150” in cell E64 (OIC Application Fee)
   Now the Total Change in Cash from cell H32 needs to be supplemented to fund the $750 required for Total OIC Payments and Fees (cell E67). Therefore, enter:
13. “750” in cell E60 (funds to pay OIC Settlement)
   With this done, his Total Sources of Cash (cell F61) equals the Total Uses of Cash (cell F80) and his OIC is complete. Note that the numbers in cells E59 through F80 will appear bold red until his sources and uses are equal.

In conclusion, Jeff's strategy is feasible if he pays rent, forgoes entertainment expenditures over the documentation period, and funds the OIC fees and settlement charges. Appendix A: Example 1 contains the before and after Excel printouts, the resulting financial disclosure (IRS Form 433-A) and Jeff's OIC application (IRS Form 656).

The steps to implement Jeff's OIC strategy are as follows:
1. Make the changes to his budget as planned above.
2. Stay within the “After” budget limits and document these income and expenditure amounts for three months (six months had he been self-employed).
3. Submit his OIC application together with the financial disclosure forms demonstrating three months of his “After” income and expenses.
4. Maintain his “After” budget so he is prepared to provide an additional three months of income and expense documentation (a common IRS request during the OIC application process).

### See FIG. 15.

The above example demonstrates that, once Jeff's personal and financial data are entered, the offer in compromise software application becomes a powerful tool for planning his OIC strategy. It is easy to change assumptions and immediately view the consequences. This will be useful as the taxpayer 10 test-drives the strategies described below and creates his or her own OIC plan.

Some options will better fit the taxpayer's 10 situation and goals than others. Save or print the scenarios he or she wants to keep. To save, click on the computer disk icon, or click on “File”, then “Save As”, and give the file a name and location. To create a hard copy, select the print area and click the printer icon on the toolbar. Alternatively, click on “File” and “Print”. Custom headers and footers may be added to print copies by going to “View”, “Header and Footer”, “Custom Header” or “Custom Footer”, and typing in notations.

The foregoing description demonstrates the importance of the reasonable collection potential (RCP) test. Jeff's RCP was pivotal in the IRS's analysis and recommendation. The prospect for success with the taxpayer's 10 OIC application also depends on his or her RCP.

The following describes three processes leading to assessing the taxpayer's 10 current RCP: 1) getting information from the IRS regarding the taxes he or she owes, 2) computing his or her “monthly multiplier”, and 3) entering his or her financial and personal data into the offer in compromise software application. With these done, the taxpayer's 10 RCP is automatically calculated and, when compared to the total owed, generates the likely IRS recommendation for the taxpayer's application. This initial assessment provides a starting point on which to build an OIC strategy. The example of John Taxwise will now be illustrated to show how specific strategies are executed.

The first step is getting the taxpayer's 10 tax information from the IRS. The goals with this step are:
The OIC analysis requires a few facts for each year the taxpayer 10 owes taxes. The objective is to have the IRS send this information if the taxpayer 10 does not already have it.
For each year the taxpayer 10 wants to know:
   How much is owed (including penalties and interest).
      The date the “10-Year Statue of Limitations” started for each tax year included in the OIC application (also called the “date of first tax assessment”). See explanation below on this statue of limitations. What the taxpayer 10 needs to do:
To obtain his or her tax information, file Form 4506-T, Request for Transcript of Tax Return. Copies of these forms are obtainable by calling 1-800-829-1040, or on the IRS website at www.irs.gov/formspubs/lists/0,,id=97817,00.html. The website allows the taxpayer 10 to select any IRS form, fill it out online, and print the form or save it to his or her computer.
For Question 6 check the box for “Record of Account” and in Question 7 indicate for which years the taxpayer 10 wants this information.
Print the completed Form 4506-T and fax it to the taxpayer's 10 regional IRS office (instructions included with the form).
Call the IRS at 1-800-829-1040 to get the first assessment dates on the taxpayer's 10 delinquent tax years.
The taxpayer 10 can also request his or her tax records under the Freedom of Information Act (FOIA) but this can take considerably longer.

It takes two to four weeks for the IRS to respond to a Form 4506-T request. It is preferable not to wait. If need be, approximate the first assessment by using the date the taxpayer 10 filed the tax return, and begin planning and implementing his or her strategy.

The IRS has a 10-year statute of limitations to collect taxes for any tax year. The statute starts when the taxpayer 10 files his or her tax return but does not pay the taxes that are due. Thus, it is to the taxpayer's 10 advantage to file his or her returns and start the statue, even if he or she cannot pay. Also, the IRS requires the taxpayer 10 to file all past tax returns before applying for an OIC.

The taxpayer 10 may have an additional collection statue (or more) for the same year if the IRS sends him or her a tax assessment notice. To simplify matters, the IRS normally uses the collection statue that applies to the largest amount due on any one tax year. For example, if the taxpayer 10 filed owing $15,000 and the IRS later assessed an additional $5,000 in taxes for that year, then they would likely start the statue when the taxpayer 10 filed his or her tax return. If the amounts were reversed, they would probably use the date the assessment was first mailed to the taxpayer 10.

Note that certain actions extend the 10-year statute, such as:
Filling for an OIC adds one year, plus the time the OIC is under consideration, to the 10-year statute on all the tax years included in the application.
Other delays in the statue occur when the taxpayer 10 sues the IRS, files for bankruptcy, or applies for a Taxpayer Assistance Order.
   The IRS may garnish the taxpayer's 10 wages and/or move to foreclose on his or her house just before the 10 years run out. These actions allow the IRS to continue collection beyond the statute.

Calculating the taxpayer's 10 Monthly Multiplier will now be described.

The taxpayer's 10 goals with this step:
The objective is to determine the “Monthly Multiplier” the IRS will likely use in his or her case and the lowest one he or she qualifies for.
A low multiplier is best because it reduces the taxpayer's 10 RCP. For instance, if the IRS calculates the taxpayer 10 can pay $200 per month on his or her back taxes, his or her RCP and minimum settlement amount is as follows:
   A multiplier of 12 results in an RCP of $2,400 ($200 times 12 months). However, a multiplier of 60 increases his or her RCP to $12,000 ($200 times 60 months).

Factors to consider:

What Monthly Multiplier the IRS uses depends on three components: 1) the time left in the taxpayer's 10 “statutory collection period”, 2) how fast he or she elects to pay the OIC settlement, and 3) the number of years included in his or her OIC application.

If the Monthly Multiplier is based on the time left to collect, then the Monthly Multiplier would be 120 (the months in the 10-year statue) less the months since the first assessment date. For instance, if the taxpayer 10 filed his or her return 80 months ago owing taxes and did not receive any additional assessment notices, then the multiplier would be 40 (i.e., 120 minus 80).

If the Monthly Multiplier is based on a settlement offer, the taxpayer 10 has three different OIC settlement options to choose from: Lump Sum Cash Offer, Short Term Periodic Payment Offer, and Deferred Periodic Payment Offer. Each of these options has a different Monthly Multiplier. If the taxpayer 10 is uncertain which type of offer to make, try all three in the Excel spreadsheet to see what difference this makes to his or her RCP and then decide.
Cash Offer is where the taxpayer 10 pays the full settlement amount in five months or less of IRS acceptance. In this case, the taxpayer's 10 Monthly Multiplier is 48 or the number of months left for collection, whichever is less. Enter a “C” in cell L26 of the Monthly Multiplier spreadsheet to elect this option.
Short Term Payment Offer is where the taxpayer 10 pays the settlement within two years of being approved. Here his or her Monthly Multiplier is the lesser of 60 or whatever is left on the collection statute. While this is the general rule for this type of offer, the IRS has taken the position in some cases to require payments until the collection statute expires. Enter an “S” in cell L26 to choose this option.
Deferred Payment Offer has the taxpayer 10 pay the settlement amount over the remaining months of the collection statute whatever that number may be. In this case, his or her Monthly Multiplier is whatever months are left to collect. To elect this option enter “D” in L26.

The Monthly Multiplier may alternatively be based on multiple tax years. If the taxpayer 10 owes for only one tax year, the multiplier is simple. However, usually more than one year is included in an OIC application. The best negotiating position is to take the earliest and most favorable assessment date and be prepared to argue the point with the IRS. If they do not agree, the counter argument is to use an “average.” Complete the table in the Monthly Multiplier spreadsheet and the offer in compromise software application will automatically compute two averages of the taxpayer's 10 Monthly Multipliers and select the one most favorable to him or her in cell L62.

With all the above said, a high multiplier, however, does not have to be fatal. There are present strategies that can usually work around this problem.

In order to select the Monthly Multiplier, open the first spreadsheet (Monthly Multiplier), read the explanation and follow the instructions. Next, fill in the date of analysis (cell E3), the taxpayer's 10 name in cell M3 and indicate the type of offering he or she desires to make in L26.

In terms of strategy, an immediate cash settlement has a higher likelihood of being accepted. In addition, this avoids the risk of the IRS renegotiating the OIC settlement if the taxpayer's 10 financial circumstances improve before all the installment payments are made. The IRS can and occasionally does do this. Multi-year contracts that offer a large down of perhaps 50% soon after approval and the remainder over time are also considered favorably. For example, the taxpayer 10 may borrow the money from a relative if he or she is able to do so.

If the taxpayer 10 has more than one tax year in dispute, he or she can choose which of three multipliers in cells L57, L58, or L62 to use by entering a “1”, “2”, or “3” in L64. For the purposes of analyzing his or her “worst case scenario” type “1” and apply the IRS's multiplier. The offer in compromise software application calculates the taxpayer's 10 Monthly Multiplier based on these assumptions and copies it into the remaining spreadsheets.

As an example, John Taxwise, will be used to illustrate the points as they occur. To start calculating John's Monthly Multiplier, enter his personal and financial data in the Monthly Multiplier spreadsheet:
1. “2/27/2007” in cell E3 (Date of Analysis)
2. “John Taxwise” in cell M3 (Taxpayer's Name)
3. “C” in cell L26 (cash OIC settlement option is selected)

### See FIG. 16.

Next enter his back taxes data and select the IRS's Monthly Multiplier by typing a “1” in cell L64. The result shows John's Monthly Multiplier at 48.
4. “2000” in cell E35 (year taxes owed), “10000” in F35 (taxes owed), “80” in I35 (months since first notice was received for this year)
5. “2003” in cell E36 (year taxes owed), “25000” in F36 (taxes owed), “40” in I36 (months since first notice was received for this year)
6. “1” in cell L64 (the monthly multiplier being selected; in this case, the IRS's multiplier)

### See FIG. 17.

It is instructive to understand the taxpayer's 10 case from the IRS perspective. The taxpayer's 10 goals with this step:
The objective is to calculate his or her RCP as it is now so the taxpayer 10 has a realistic assessment of his or her situation.
   Input all the information regarding his or her finances. The taxpayer 10 may be tempted not to tell the IRS about some of his or her assets and income but doing so could easily complicate his or her situation way beyond the problems he or she is dealing with presently.

Factors to consider include the following:

The RCP totals the IRS's collection potential from three sources:
The net equity in the taxpayer's 10 assets after subtracting liabilities and exemptions.
The taxpayer's 10 net income after subtracting allowable expenses.
Loans that are paid off sooner than the taxpayer's 10 Monthly Multiplier expires. For example, if his or her car payment is $300 per month for the next 20 months and the Monthly Multiplier is 48, then the IRS adds $8,400 to his or her RCP (i.e., $300 per month times the 28 months that remain after the loan is retired).
The taxpayer's 10 goal is to limit his or her RCP to no more than what he or she is willing to pay the IRS. There are two possibilities: either the taxpayer's 10 RCP is greater or less than what he or she is offering in settlement.
   If it's greater, the taxpayer 10 pays the RCP (up to the total taxes owed).
   If it's less, the taxpayer 10 pays what he or she offered.
If, for instance, the taxpayer 10 owes $50,000, his or her RCP is $10,000 and he or she offers $1,000, the IRS will reject the offer on the assumption it can collect $10,000. However, if the taxpayer 10 reduces his or her RCP to $500, the IRS now will accept his or her offer of $1,000. As mentioned earlier, the OIC rules were changed in July 2006 so that in addition to the non-refundable application fee, the taxpayer 10 now pays a deposit that is tied to a) the amount he or she offers to settle and b) the type of settlement offered.
   Complete entering the taxpayer's 10 data in the Monthly Multiplier spreadsheet, if that data is not already entered.

The next step is to enter the taxpayer's 10 asset and liability information. Type the taxpayer's 10 financial and personal data into the Data Input and Results spreadsheet. For each asset, its fair market value goes in column C, lender name in column D, loan amount and term in columns E and F, and lease and loan monthly payments in columns H and I, respectively. Estimate the value of all the taxpayer's 10 furniture and personal property, such as clothing, appliances, dishes, and so forth, in cell C22. The type of car and other assets are named in column B.

Real Estate assets are separated into those with “allowable” loans and those whose liabilities are not allowable. By allowable the IRS means that the mortgage payments are exempt (up to a maximum amount) from being available to pay back taxes. In this context, the only clearly allowable real estate loans are on the taxpayer's 10 home. Mortgages on other property are normally “non-allowable” unless some special circumstances can be established. For instance, a property could be your place of business and, thus, important in generating your income.

Auto loans are allowable only up to the IRS limits and whether loans on the taxpayer's 10 personal property or effects are “allowable” is a complex matter. In both instances, refer to “Installment loan strategies” described below for more clarification. For now, allocate allowable and non-allowable loans in accordance with the footnotes in row 60 of the Data Input and Results spreadsheet:

Allowable loan payments (in addition to the taxpayer's 10 home, cars, and business property) are for pensions, life insurance, business purpose (e.g., account receivable financing and equipment purchases), medical debts, judgments, and other secured debts on personal property.

Non-allowable loan payments are for investment or vacation property, boats, RV's, airplanes, and other non-essential items or purposes.

Note that vehicle market values and loans are handled separately starting in row 27. Lastly, “Other Assets,” such as investments, personal collections, and anything that does not fit into the categories provided are listed in rows 31 to 35. Amounts allowed or exempted by the IRS for pensions, Furniture/Personal Effects and Tools and/or Equipment are entered into cells G17, G22 and G26, respectively. How to find these figures is discussed below in “Locate IRS exemptions and allowances.”

Liquid or near-liquid assets are easy to value, assuming there are active markets in which to sell them. A “liquid” asset is cash or can be readily converted to cash. Subtract selling, shipping, other transaction costs and any loans against these assets to compute net equity. Illiquid assets are discounted due to the cost and effort required to sell them. For instance, personal possessions are presumed to be valued at garage-sale prices. Similarly, the discount on art, jewelry, and collectibles is very high. Consult a source such as eBay for comparable pricing, and subtract anticipated selling expenses.

Prices of cars, boats, RVs, airplanes, investment property, and so forth vary, depending on year, condition, features, and uniqueness. An IRS-acceptable way to determine their fair market value (FMV) and net equity is as follows:
Average published prices of comparable items to estimate the current market price. An excellent source for car prices is the Kelly Blue Book website at www.kbb.com. Alternatively, obtain written appraisals and use the lowest estimate to document the FMV. Take 70% or 80% of the FMV to calculate the “quick sale” value.
Use 70% if the taxpayer 10 needs to be aggressive or can justify a deeper discount. To be conservative, apply the IRS's percentage of 80%.
The offer in compromise software application assumes liquid assets are valued at 100% and other assets at 80%. The taxpayer 10 can change the quick sale percentage for any asset in column E of the Asset Equity Table spreadsheet. Subtract loans and selling costs to get net equity.

To estimate the FMV of the taxpayer's 10 home, average the asking prices for residences in his or her area and subtract 10%. Another approach would be to get appraisals from local real estate agents and use the lowest one to document the FMV. Subtract selling costs and the mortgage balance to derive net equity.

If there's a question of the taxpayer's 10 business' FMV, consult with business brokers or merger and acquisitions specialists for preliminary (free) valuations. Calculate net equity by subtracting selling costs and liabilities.

Personal property, such as clothing, furniture, and tools used in the taxpayer's 10 trade, is valued at garage-sale, flea-market, auction, or estate-liquidation prices (i.e., pennies on the dollar). The IRS rarely requires an inventory, so aggregate what the taxpayer 10 paid and multiply the total by 3% or 5% to get their FMV at open-market prices.

Continuing the example of John Taxwise, enter the following in his Data Input and Results spreadsheet:
7. “Harris, Tex.” in E4 (taxpayer's county and state of residence)
8. “0” in cell I4 (for now he chooses not to discount future cash flows)
9. “1” in cell F5 (number of people in taxpayer's household)
10. “500” in cell I6 (amount offered to settle OIC). Recall that this figure determines the amount he must submit for a deposit on his OIC application.
11. “4000” in cell C12 (Checking Account(s))
12. “1000” in cell C13 (Saving Account(s))
13. “100000” in cell C17 (Pensions)
14. “50000” in cell C19 (Real Estate with Allowable Loans)
15. “10000” in cell C22 (Value of all Furniture/Personal Effects)
16. “2000” in cell C26 (Tools and/or Equipment)
17. “2003 Ford F150” in cell B28, “6000” in cell C28 (Car #1)
18. “123 Mortgage Company” in cell D19 (Real Estate Creditor)
19. “Car Loan Company” in cell D28 (Car #1 Creditor)
20. “5000” in cell E19 (Real Estate Loan
21. “6000” in cell E28 (Car #1 Loan)
22. “120” in cell F19 (Real Estate Loan Term)
23. “20” in cell F28 (Car #1 Loan Term)
24. “7040” in cell G22 (Furniture/Personal Effects Exemption); in 2007 this was increased to $7,720
25. “3520” in cell G28 (Tools and/or Equipment Exemption); in 2007 this was increased to $3,860
26. “1000” in cell I19 (Real Estate Loan Payment)
27. “450” in cell I28 (Car #1 Loan Payment)

### See FIG. 18.

The taxpayer's 10 income and expense information is also entered. Estimate the taxpayer's 10 monthly income sources in cells C39 through C52. Allocate the taxpayer's 10 expenditures to cells G39 through G55. Car ownership costs are copied from the loan or lease payments specified in the Asset/Liability Information section; therefore, do not overwrite cells G42 and G43. Lump any expenses not allocated to cells G39 to G51 into cell G54 (Entertainment, Vacations & Misc.) so that all the taxpayer's 10 income is accounted for and cell H59 is zero.

What the taxpayer 10 now has is his or her own “before” spreadsheet. Save this file. The IRS's RCP and recommendation are shown in row 65 of the taxpayer's 10 Data Input and Results spreadsheet. The description that follows presents strategies to decrease the taxpayer's 10 RCP and likely secure approval for his or her OIC application on terms he or she can live with.

John Taxwise's income and expense data input is important. Once he finishes making the entries below, John's pre-planning RCP is $210,912. Save the work in the file, “John Taxwise before.” This is the starting point of his OIC planning.
28. “5000” in cell C39 (Wages/Salaries TP1)
29. “500” in cell C41 (Interest/Dividends)
30. “1500” in cell G39 (Food, Clothing & Misc. Expenses)
31. “1300” in cell G40 (Housing and Utilities Expenses)
32. “500” in cell G44 (Transportation Operating Costs)
33. “750” in cell G47 (Taxes)
34. “1000” in cell G54 (Entertainment, Vacation & Misc. Expenses)
35. “919” in cell I39 (Food, Clothing & Misc. Exemption)
36. “1122” in cell I40 (Housing and Utilities Exemption)
37. “471” in cell I42 (Car #1 Ownership Exemption)
38. “338” in cell I44 (Transportation Operating Exemption)

### See FIG. 19.

The taxpayer 10 also determines IRS exemptions and allowances. The IRS allowances for cells I39 to I44 and the various exemptions are found on the IRS web pages cited below. Keep in mind that the taxpayer 10 may be able to justify special circumstances and qualify for higher expenditures.
Pensions and retirement plans: The IRS excludes the amounts in retirement plans that cannot be borrowed or withdrawn by the taxpayer unless they quit, retire, or die when they apply for an OIC.
Furniture/personal effects: Internal Revenue Code section 6334 (a) (2) sets an exemption of $7,720 for “fuel, provisions, furniture, and personal effects” (last updated in 2007). Unless the taxpayer 10 can justify special circumstances, enter “7720” in cell G22.
Tools and/or equipment: Internal Revenue Code section 6334 (a) (3) limits the exclusion for “tools of the trade” at $3,860 (updated in 2007). If the taxpayer 10 is not claiming special circumstances, type “3860” in cell G26.
Allowable living expenses: The allowance for food, clothing, household, and personal care products is found at www.irs.gov/businesses/small/article/0,,id=104627,00.html. This amount depends on the taxpayer's 10 income and the number of people in his or her household. Enter the exemption in cell I39. Again, the taxpayer 10 may qualify for more than the guidelines.
Housing and utilities: The housing and utility cap varies according to where the taxpayer 10 lives and number of dependents. Go to www.irs.gov/businesses/small/article/0,,id=104696,00.html and enter it in cell I40.
Transportation: Car and public transportation allowances are found at www.irs.gov/businesses/small/article/0,,id=104623,00.html. Car exemptions are divided into “ownership” costs (cells I42 and I43) and “operating” expenses (cell I44). Ownership allowances depend on the number of cars owned, and operating costs vary with where the taxpayer 10 lives and the number of cars he or she has.

Various asset and liability strategies can be applied. The following description presents strategies to reduce the taxpayer's 10 Reasonable Collection Potential from two sources: a) his or her assets and b) his or her debts that are paid off before his or her Monthly Multiplier expires. However, before the taxpayer 10 begins planning, open and save his or her “before” Excel file as a new “after” file using the “Save As . . . ” command. This gives the taxpayer 10 a fresh template upon which to strategize his or her OIC.

To understand how the taxpayer's 10 assets hurt his or her position, start with the premise that the net equity in nearly every asset he or she owns is included in his or her RCP. Thus, the primary options are to sell excess assets and shelter the proceeds, or borrow against his or her assets and protect that money. The taxpayer 10 wants to max out his or her borrowing capacity since the IRS usually views lines of credit and credit cards as sources to pay back taxes. Also, the taxpayer 10 must act before the IRS puts liens in place, because doing so locks in their claim on the equity. Thereafter, the taxpayer's 10 ability to sell or encumber the property without turning over all the cash to the government becomes difficult and other strategies have to be utilized.

The analysis that follows divides the taxpayer's 10 assets into four categories, according to their liquidity and IRS collection potential. Again, a liquid asset is cash or something easily converted into cash; illiquid possessions, on the other hand, take time, effort, and expense to sell at a “fair market” price. For this analysis, here is how the taxpayer's 10 assets are classified:

Liquid or Near-Cash Assets
1. Cash on hand, plus checking, money market, and bank accounts
2. Stocks, bonds, mutual funds, and annuities
3. Accounts receivable and inheritances

Semi-Liquid Assets
1. Cash values and proceeds from insurance policies
2. Pensions, IRAs, 401(k)s, and other retirement plans
3. Revocable trusts

Illiquid Assets and Installment Loans
1. Cars, boats, RVs, art, jewelry, and collections
2. Investment and vacation real estate

Income and Lifestyle Assets
1. Business assets and equipment
2. Personal residence
3. Personal property (furniture, clothes, etc.)

Insofar as liquid or near-cash assets are concerned:

The taxpayer's 10 goals with this step:
The objective is to limit the taxpayer's 10 cash on hand, bank, checking, and money market accounts, stocks, bonds, mutual funds, annuities, accounts receivable, and inheritances, because the IRS includes all of these assets in his or her RCP.

Factors to consider:
It is illegal and ill-advised to lie to the IRS about what the taxpayer 10 owns. However, the taxpayer 10 can move assets after he or she tells the IRS where they are and use the offer in compromise software application to shelter his or her equity prior to applying for an OIC.

Possible strategies:
Sell, liquidate, and greatly limit near-cash assets. Shelter the proceeds using the strategies described below.
Borrow against these assets only if the loan matures after the Monthly Multiplier runs out.
Collect money owed to the taxpayer 10 and get advances on debts, lawsuits, inheritances, bonuses, liens, and so forth, even if at heavy discounts, because whatever the taxpayer does not receive now will go to the IRS.

What the taxpayer 10 needs to do:
Adjust his or her liquid and near-cash assets on the Data Input and Results spreadsheet for changes he or she will make to cut his or her RCP.

Insofar as semi-liquid assets are concerned:

The taxpayer's 10 goals with this step:
The goal is to reduce the impact on the taxpayer's 10 RCP from cash values and proceeds from insurance policies, pensions, IRAs, 401(k)'s and other retirement plans, and revocable trusts.

Factors to consider:
Plan and move quickly, because once liens are placed on them, any sales and transfers must be approved by the IRS.
   These types of assets are especially easy for the IRS to discover, so don't deny owning them.

Possible strategies:
Life insurance policies with cash values should be liquidated. Alternatively, check with an attorney to see if a life insurance trust can take them out of IRS reach. Another option is to borrow the cash values, but only if the loan term exceeds the taxpayer's 10 Monthly Multiplier.
If the taxpayer 10 has access to money in his or her retirement plans without having to quit, retire, or die, the IRS includes the available cash in his or her RCP. For instance, some retirement plans may be liquidated, but doing so usually generates substantial income taxes and selling charges. If the plan prohibits selling or borrowing, these funds are effectively sheltered from the IRS. Check the rules with the plan administrators.
   Some 401(k) and 457 plans allow the taxpayer 10 to borrow up to 50% of the funds. If so, do it and shelter the money before applying for the OIC (see example below).

If the taxpayer 10 has sizable sums in retirement plans, or they are a large portion of the taxpayer's 10 net worth, seek professional advice right away. If the bulk of the taxpayer's 10 life savings is in an IRA, it is possible that other, non-OIC strategies can better protect this asset.

Trusts are also beyond the scope of this offer in compromise software application, so check with an experienced attorney. For instance, should the IRS find that the trust is revocable or sufficiently under the taxpayer's 10 control, they add it to the taxpayer's RCP. Thus, the taxpayer 10 may need to transfer assets under trust to other, better protected venues. If the taxpayer 10 has loans outstanding against his or her semi-liquid assets, strategies to deal with this situation are described below.

What the taxpayer 10 needs to do:
Make adjustments to the taxpayer's 10 semi-liquid assets in the Data Input and Results spreadsheet to reduce the net equity available to the IRS.

The following illustrates an example relating to John Taxwise's Monthly Multiplier and asset strategies. Returning to the example described above, open the “John Taxwise before” file and use that to create a new “after” file.
1. Use the “Save As . . . ” command to save the same file again under another name, “John Taxwise after.”
   Amend the Monthly Multiplier to one that is more realistic and cut his RCP by $9,496.
2. “3” in cell L64 of the Monthly Multiplier spreadsheet

### See FIG. 20.

Next, John finds out from his 401(k) administrator that he can borrow half the funds in the account. Thus, $50,000 (half the total) is exempt from IRS seizure so he borrows the remainder and shelters it. In addition he reduces his checking and savings accounts and interest income since these directly contribute to his RCP. Implement these changes by entering the following in the Data Input and Results spreadsheet:
3. “50000” in cell G17 (the exempted Pension amount)
4. “401(k) Lender” in cell D17 (the Pension fund lender)
5. “50000” in cell E17 (amount of Pension borrowed)
6. “72” in cell F17 (term of the Pension loan in months)
7. “450” in cell I17 (the monthly payment on the Pension loan)
8. “100” in cell C12 (Checking Account)
9. “200” in cell C13 (Savings Account)
10. “50” in cell C41 (Interest/Dividends)
11. “450” in cell G51 (Allowable Loan Payments)
12. “100” in cell G54 (reduces Entertainment to balance income and expenses)

### See FIG. 21.

### See FIG. 22.

The pension loan payment should not only be allowable but also reduce his entertainment expenses. The total effect of these transactions takes another $144,300 off his RCP.

Insofar as ill-liquid assets and installment loans are concerned:

The taxpayer's 10 goals with this step:
The objective remains the same: limit the contribution to the taxpayer's 10 RCP from equity in his or her cars, boats, RVs, art, jewelry, collections, and investment and vacation real estate.

Factors to consider:
Assets of this type usually take some effort and expense to sell, so the IRS is more reluctant to seize them. However, they would no doubt restrict the taxpayer's 10 actions by putting liens in place.

Possible strategies:
The taxpayer 10 has some flexibility in calculating the Fair Market Value of his or her illiquid assets as described earlier. Also, the taxpayer 10 may borrow out the equity so long as the loan matures after his or her Monthly Multiplier expires.
Cars are a challenge, since the equity counts towards the taxpayer's 10 RCP and auto loans often end prior to his or her Monthly Multiplier. In addition, the IRS usually will not let the taxpayer 10 assume he or she will buy another car or refinance when the loan is paid off. Possible arguments to justify having to replace the taxpayer's 10 car at the end of the loan are its age and high mileage.
If these constraints add significantly to the taxpayer's 10 RCP, sell his or her cars, shelter the cash, and lease or temporarily rent new ones. This way the taxpayer 10 takes advantage of the car ownership exemption.
The taxpayer 10 may be able to keep his or her existing car and swap his or her payments for a lease by working with companies like D & M Leasing (www.dmautoleasing.com). The costs are a re-registration fee plus an acquisition charge, which can be rolled into the lease payment.
If the taxpayer 10 is married, he or she may want to transfer assets to his or her spouse and file separate tax returns. This strategy to protect those assets and focus all the tax problems on one spouse has the highest likelihood of working in non-community property states.
If the taxpayer 10 still has equity in illiquid assets, he or she may gift them to parents, children, or other trusted individuals.
   Items of significant value and a low cost basis (such as stocks, collections, businesses, homes, and so forth) can generate special benefits when sold through a charitable remainder trust. Here, the taxpayer 10 gifts the asset to a charity; and they sell it and fund an income stream for the taxpayer over his or her life from the proceeds. The taxpayer 10 does not pay capital gains taxes on the sale and, in fact, generates a gift tax deduction. This strategy is highly technical, so consult an attorney to make sure it fits the taxpayer's 10 situation and objectives. Most large universities and charities have experts to assist the taxpayer 10. For more information, go to www.charitableplanning.com.

The following is an example directed to John Taxwise's ill-liquid assets strategy. The contribution to John's RCP from Net Equity in Assets has been reduced to $1,260 (see cell I62). To investigate how this figure is calculated, go to the Asset Equity Table spreadsheet and find that most of it results from his Furniture/Personal Effects being valued at $960 more than the exemption (cell F23 minus cell H23).

Realizing this, John revalues his Furniture/Personal Effects at what they would yield at garage-sale prices ($4,500). Entering this amount in the Data Input and Results spreadsheet eliminates $960 of his RCP.
13. “4500” in cell C22 (Value of Furniture/Personal Effects)

### See FIG. 23.

Insofar as installment loan Strategies are concerned, the best strategy is to only keep or incur loans that are “allowable” (see description below), have payments that do not exceed the IRS's monthly exemption, and mature after the taxpayer's 10 Monthly Multiplier expires. Any borrowings that do not meet all of these criteria add to the taxpayer's 10 RCP.
“Allowable” liabilities are home mortgages, car loans, pension fund debt, life insurance borrowings, judgments, medical debts, and other “secured debts” as well as business-related loans.
Unsecured liabilities such as credit cards and personal loans may be allowed if the taxpayer's 10 excess income (after expenses) is not sufficient to repay them within 90 days, and making minimum payments leaves more than “a small amount” for the IRS.
Payments on boats, RV's, vacation homes, and liabilities not permitted above are normally excluded. Special circumstances would have to apply for them to qualify.
   What, if any, allowable borrowings add to the taxpayer's 10 RCP is shown in the Retired Debt Calculations spreadsheet (see column “I”, Final Retired Debt Amount).

The following is an example of how such a loan can cost the taxpayer 10: Say his or her monthly car payment of $500 goes for another 30 months, his or her Monthly Multiplier is 48, and the IRS exempts $475 per month. The fact that the loan term is less than the Monthly Multiplier increases the taxpayer's 10 RCP by $9,000 ($500 per month times the remaining 18 months after the payments end). The $25 over the IRS's allowance also boosts the taxpayer's 10 RCP by $1,200 ($25 times 48 months). Even if the taxpayer's 10 loan term were longer, say 50 months, it would still increase his or her RCP by $1,200 ($25 times 48 months).

An aggressive solution would be to prepay the portion of the payment that exceeds the IRS allowance. Assume the case above with a car payment $25 over the IRS maximum. If the documentation period is six months, the taxpayer 10 could prepay $150 ($25 times six months) prior to having to track his or her expenses and then make installments of $475 for six months to satisfy the IRS's requirement. This may work with the taxpayer's 10 mortgage which is also subject to IRS limits but make sure the taxpayer 10 discloses any prepaid expenses to the IRS in his or her financial disclosure forms.

The following are a few more points on installment debt to consider:
Should the taxpayer 10 end up negotiating with the IRS over retired debt computations, be aware that they use a short cut that overstates the impact on the taxpayer's 10 RCP. They divide the taxpayer's 10 monthly payment into the outstanding balance to estimate the number of months remaining on the loan. This method is only accurate if the taxpayer's 10 loans are at an interest rate of zero. Since this is virtually never the case, the actual number of months remaining is invariably higher.
The taxpayer 10 wants more months because less is added to his or her RCP. For instance, an interest only debt that takes 60 months to repay would require 24 more months to discharge if it were at 10% annual interest. Therefore be sure the loan maturities used by the IRS are accurate.
   Non-allowable loan and other expenses are aggregated in the Data Input and Results spreadsheet in cell G53. They are significant because each dollar times the taxpayer's 10 Monthly Multiplier is added to his or her RCP.

In summary, if the taxpayer's 10 Monthly Multiplier is 60 or greater, he or she is probably better off eliminating all his or her installment debts (allowable and non-allowable). In such cases only the taxpayer's 10 home mortgage may pass the RCP test, but use the offer I compromise software application to verify which strategies best fit the taxpayer's 10 circumstances.

What the taxpayer 10 needs to do:
Given the strategies the taxpayer 10 desires to implement, make appropriate adjustments to his or her ill-liquid assets for changes in equity positions, liabilities, and expenses. Enter these into the Data Input and Results spreadsheet.

An example of John Taxwise's installment loan strategies is as follows. In the case of John Taxwise, he sees that $10,800 of RCP comes from Tax Payments Available from Retired Debt (cell I63). To drill down on this figure, he goes to the Retired Debt Calculations spreadsheet:

### See FIG. 24.

The spreadsheet shows that all of the $10,800 comes from the IRS's assumption that, once his car is paid off, the $450 monthly payment is available to pay back taxes (i.e., 44 [his Monthly Multiplier] minus 20 [the term of the loan] times $450). To fix this, John decides to sell his truck and lease another vehicle:
14. “2007 Ford Mustang” in cell B28 (type of Car #1)
15. “0” in cell C28 (Fair Market Value of Car #1)
16. “Car Lease Company” in cell D28 (Car #1 creditor)
17. “0” in cell E28 (Car #1 loan)
18. “0” in cell F28 (Car #1 loan term)
19. “470” in cell H28 (Car #1 monthly lease payment)
20. “0” in cell I28 (Car #1 loan payment)
21. “80” in cell G54 (Entertainment to balance his income and living expenses in cell H59)
   This eliminates the problem so that essentially all of his RCP is attributable to Tax Payments Available from Income (cell I64). The following description deals with this challenge.

### See FIG. 25.

The offer in compromise software application also enables the taxpayer 10 to develop a strategy respecting income and lifestyle assets.

The taxpayer's 10 goals with this step:
The goal is to shrink the additions to the taxpayer's 10 RCP from a) business assets and equipment, b) home, and c) personal property (e.g., furniture, clothes, and so forth).

Factors to consider:
The IRS readily places liens on such property, but of anything the taxpayer 10 owns, these assets are the ones the IRS is the most reluctant to seize and sell. If they take the taxpayer's 10 business assets, that will likely reduce or eliminate the taxpayer's ability to pay taxes. Similarly, economic hardship would probably result from depriving the taxpayer 10 of his or her home and personal possessions.
Exceptions to this guideline are assets the IRS views as less essential to maintaining the taxpayer's 10 business or life style. So the IRS is more willing to liquidate the taxpayer's 10 accounts receivable, valuable collections, jewelry, and art.
On the whole, however, the IRS's strategy in dealing with income and life style assets is markedly different than other possessions. If the IRS determines these resources are significant, they will place liens, garnish the taxpayer's 10 wages, and wait to collect as opportunities arise.
   The IRS views time as on their side because their claim is secured and it is earning at least 8% per year.

Possible strategies:
The IRS's partial exemption for personal property and tools of the taxpayer's 10 trade provides ample room to shelter considerable cash (see the description below).
   Incorporation is often cited by asset protection specialists as a preferred method to get business equity out of the IRS's reach. A negative consequence can occur if the IRS values the closely held corporation at one times current sales and adds the taxpayer's 10 proportionate equity to his or her RCP. Ways to limit the valuation are:
      1. To decrease the taxpayer's 10 business' short-term profitability and capitalized value by delaying or reducing sales and receipts and prepaying or increasing costs.
      2. Cut profits and transfer income by hiring the taxpayer's 10 children, but do not pay them more than what the taxpayer 10 would compensate anyone else for the same work.
      3. Forming a new corporation may shelter personal assets and income. However, be sure to consult with a qualified attorney or asset protection specialist to guide the taxpayer 10 in this strategy so that he or she does not violate the law.
   Max out the taxpayer's 10 credit lines or sell part or all of the taxpayer's company and acquire business assets or find other ways to shelter the cash.
   If the taxpayer 10 can, refinance his or her home and pull out any equity that would be added to his or her RCP. Proceeds can be sheltered or used for home improvements, purchasing furniture, repaying short-term borrowings, paying off and closing credit cards or lines of credit, as well as other legitimate purposes. Alternatively the taxpayer 10 could sell his or her home, put a minimum down payment on another, and utilize legal means to shelter the remaining cash.
   Ways to plan the taxpayer's 10 housing and utilities bills so as not to add to his or her RCP will be described below.
      As mentioned above, gifting highly appreciated assets through a charitable remainder trust can provide significant benefits in special situations.

What the taxpayer 10 needs to do:
Update the Data Input and Results spreadsheet for any anticipated borrowings, sales, and other transfers that will impact the taxpayer's 10 RCP as well as consequent changes to his or her income and expenses.

Various strategies for sheltering cash exist. Buy things the IRS does not normally seize such as personal assets (e.g., furniture, clothing, etc.) and tools for the taxpayer's 10 business. This works because the IRS exempts a given amount of these items and the taxpayer 10 can value them at garage-sale prices.

In 2007 the exclusion for “fuel, provisions, furniture and personal effects” was increased to $7,720. Note that at five cents per dollar, $7,720 can shelter $154,400 of personal effects. To arrive at this number multiply $154,400 by $0.05 to get the fair market value of $7,720. At three cents per dollar, the amount sheltered is $257,333.

To estimate the prices paid for the taxpayer's 10 personal property, multiply this total by 3% or 5% to get an idea how much more the taxpayer can buy without exceeding the exclusion. The next section shows how to combine this allowance with the need to stockpile food and supplies to hold the taxpayer's 10 living expenses within IRS limits.

Similarly, the exemption on “tools of the trade” was raised to $3,860 in 2007. This can shelter $77,200 and $128,667 at five and three cents per dollar at retail prices, respectively. Determine if the taxpayer 10 can use freed-up cash to procure more business assets without going over the limit.

A riskier strategy is to acquire antiques, gold, collectibles, and the like, that can later be re-converted into cash. Unfortunately, this strategy could be problematic, because of the necessity to disclose such transactions to the IRS. Also, the possibility arises that the IRS would consider these transactions “bad faith” and refuse to give the taxpayer 10 an OIC agreement.

Within reasonable limits and proper disclosure, excess cash can pay for past, current, and future (prepaid) expenses for the taxpayer's 10 business, utilities, cable and interne services, rent, legal and medical bills, child's education and support payments, spousal support, and so forth. Cash can also be paid to “close” creditors such as family members for old loans like repaying the taxpayer's 10 parents for money spent on college expenses. The taxpayer 10 may be able to use this occasion to negotiate debt settlements with other creditors. The taxpayer 10 will probably want to engage a professional to help implement this strategy.

The taxpayer 10 can give $12,000 to any number of persons (such as family members) per year without incurring gift taxes. However, this strategy is illegal if the purpose of these gifts was to avoid money going to creditors, including the IRS.

Other potentially legal options for sheltering cash from the IRS and other creditors include creating an irrevocable trust, special partnership, corporation, or offshore entity. These tactics are most cost-effective for high-net-worth individuals wanting to protect significant sums, so the taxpayer 10 should consult with an asset protection specialist and other professionals before attempting to implement such strategies.

Various income and expense strategies may be applied. In the taxpayer's 10 OIC application, he or she must provide a detailed analysis of his or her financial inflows and outflows over a three-month period (six months if he or she is self-employed). The IRS usually asks for an additional three months' records, so if the taxpayer 10 wants to be safe, prepare to analyze his or her transactions for six months (nine months for the self-employed). The IRS compares this data against allowances for various necessities in calculating the taxpayer's 10 RCP. The objective is to show little or no surplus money available for back taxes, because every dollar of income above what the IRS permits is multiplied by the taxpayer's 10 Monthly Multiplier and added to his or her RCP.

To illustrate, assume the taxpayer 10 has good income potential, his or her excess income averages $200 per month, and his or her monthly multiplier is 60. In this case, just an extra $200 per month increases the taxpayer's 10 RCP by $12,000 ($200 times 60).

Accordingly, the taxpayer 10 has various income and expenses goals. The taxpayer's 10

goals with this step:
The objective is to have the taxpayer's 10 monthly income equal or even slightly less than what he or she spends on IRS-authorized necessities. The IRS limits are not especially generous, and any expenditure greater than the IRS allows is added to the taxpayer's 10 RCP.

So the taxpayer 10 must adjust his or her income and outlays during the documentation period such that:
Every dollar of income is spent.
All the taxpayer's 10 expenditures are for items allowed by the IRS and within the dollar limits they prescribe.
   Achieving these goals will minimize the taxpayer's 10 excess income but it takes planning and discipline. The following strategies will show how to do so while minimizing the impact on the taxpayer's 10 lifestyle.

Factors to consider:
Without any planning or budgeting, the taxpayer's 10 claimed expenditures (cell G57 on the Data Input and Results spreadsheet) are either higher or lower than his or her declared income (cell C57). Cell H59 shows the Net Difference. As described earlier, these were forced to be equal by lumping any expenditures not accounted for in cells G39 through G51 into cell G54 (Entertainment, Vacations & Misc.) as non-allowed expenditures.

At this point, however, the taxpayer 10 wants to jointly strategize his or her reported income and disbursements to bring them into parity without much, if any, non-allowed expenses like vacations because:
If the taxpayer's 10 spending significantly exceeds his or her income, the IRS will assume he or she is not telling the truth about his or her earnings or is receiving payments or subsidies from undisclosed sources.
   If the taxpayer's 10 spending is less than his or her income or the taxpayer purchases non-authorized items (e.g., entertainment, vacations, etc.), these increase his or her RCP.

Different documentation period strategies can also be elected. The taxpayer 10 has some flexibility concerning which months he or she picks to document his or her finances. They must be three or six sequential months, but if it is to the taxpayer's 10 advantage, he or she can include or exclude the prior full month. For example, assume the current month is June and the taxpayer 10 needs to submit records for three months. The taxpayer 10 has a choice to document either a) February through April or b) March through May. Another option, if the taxpayer 10 can respond within 30 days to an IRS request for the data, is to wait until June is over and submit April through June figures.

The following are income strategies that can be applied. If the taxpayer 10 is employed by a company, he or she usually has only minor discretion over his or her earnings. The taxpayer 10 may, nevertheless, employ some strategies to temporarily reduce his or her income during the documentation period:
Decrease the taxpayer's 10 overtime pay or defer bonuses (if he or she can).
Lessen or eliminate the number of exemptions so more taxes are withheld from the taxpayer's 10 check.
Increase the taxpayer's 10 contributions to his or her 401(k) or other retirement plans if he or she can, especially if there are rules against borrowing.
Include in the taxpayer's 10 tax payments any installments he or she is remitting to his or her state for past due taxes.
If the taxpayer 10 has the option to do so, he or she may become an independent contractor and create a corporation to shelter his or her earnings.
   Clearly these are aggressive and should only be implemented if they are legal to do so in the taxpayer's 10 situation.

When the taxpayer 10 is self-employed, owns his or her own company, or generates investment income, he or she has much greater control over his or her earnings. Suggestions for cutting the profitability of the taxpayer's 10 business also may apply to discretionary distributions from investments. Specifically, to shrink such profits:

Delay or decrease sales and receipts and prepay or increase costs.

Purchase and immediately write off equipment.

Hire the taxpayer's 10 children to work in his or her company.

Incorporate the business or investment activity.

Establish a 401(k) plan without borrowing privileges.

Keep in mind that not only must whatever adjustments the taxpayer 10 makes conform to tax and other laws, but be in place and documented over six months, so plan ahead. If the taxpayer's 10 income varies from year to year, the IRS typically uses a three or four year average to estimate his or her income. To justify a lower base, the taxpayer 10 must provide adequate documentation to support his or her numbers.

If the taxpayer's 10 spouse is female, the taxpayer may argue to have her earnings excluded because of family issues such as having a baby and raising children that will require her to stop working in the future. For either spouse, health, job security, and other problems may be legitimate claims for limiting their projected income.

Social Security benefits and retirement payments are generally impossible to shelter from the IRS. However, if these are now the major source of the taxpayer's 10 income because he or she has done a good job arranging his or her assets and other income, the taxpayer might consider applying for a hardship OIC. If rejected, make an application to the Taxpayer Advocate Service and, even if this fails, the taxpayer 10 could consider filing bankruptcy.

The taxpayer 10 may consider using a discount rate on future income and expenses. When forecasting the taxpayer's 10 income, one negotiating tool is to take the present value of his or her future earnings. Just as a dollar discounted at 10% per annum is worth only $0.90 today if it is to be received a year from now, so is the taxpayer's 10 future income worth less in today's dollars. The offer in compromise software application offers the taxpayer 10 the option of utilizing a discount rate, and, if he or she so chooses, to specify the annual discount rate (see cell I4 in the Data Input and Results spreadsheet). When the taxpayer 10 elects this option, the offer in compromise software application discounts the Net Difference between the taxpayer's 10 gross monthly income and total allowed disbursements (cell I27 in the Income Expense Table spreadsheet).

The offer in compromise software application also discounts each loan in the Retired Debt Calculations spreadsheet that contributes to the Retired Debt Available for IA (cell I34). Note that if the taxpayer 10 is able to zero out or greatly reduce his or her RCP using the offer in compromise software application strategies and is able to zero out or greatly reduce the Net Difference and Retired Debt amounts, then the taxpayer does not need to employ a discount rate to cut them further. Only discount when the taxpayer 10 cannot get these numbers low enough. As the IRS does not discount, the taxpayer 10 will have to explain what he or she is doing, how it is being applied, and why he or she chose the particular discount rate that is used. Sample language if the taxpayer 10 does discount could be:
“I applied a discount rate to a) the net difference between my gross monthly income and total allowed expenses and b) the retired debt calculations. This adjusts the value of money to be received in the future to present dollars. The discount rate used was 10% [or pick other rate] per year, which is the current rate on high-risk creditors.”

There are also expense strategies that may be applied. Recall that the taxpayer's 10 goals are to have a) his or her monthly outlays essentially equal to income and b) most or all of it accepted by the IRS as necessary, reasonable, and within their guidelines.

Specifically, the taxpayer 10 has to:
Research the IRS allowances for the taxpayer's 10 circumstances (as described earlier).
Plan so the taxpayer 10 comes under or does not greatly exceed the guidelines.
Decrease the taxpayer's 10 expenditures in non-sanctioned categories (e.g., entertainment, vacations, and so forth).
Have little (if anything) left over for back taxes.

There are various categories of expenses. To help the taxpayer's 10 plan, be aware that his or her expenditures fall into four categories:
Allowed but capped expenses: There are three of these: “Food, Clothing & Misc.”, “Housing & Utilities”, and “Transportation” (for cars or public transit). Some of the capped amounts increase with the taxpayer's 10 income, number of dependents, and the standard of living in his or her local area as described above for determining the IRS budgets in the taxpayer's specific situation.
Allowed but not necessarily capped expenses: The IRS generally permits reasonable outlays for health insurance, other health care costs, payments ordered by a court (e.g., child and spousal support), child and dependent care, life insurance premiums on term life policies, secured debt payments (e.g., car and furniture loans), and business costs. The offer in compromise software application assumes 100% of the taxpayer's 10 purchases in each of these categories are allowed. If the taxpayer 10 has unusually large charges for these, however, be prepared to justify them to the IRS.
Questionable expenses: These might include things like church tithing, pension plan contributions, and other special uses of money. Be prepared for IRS challenges by having explanations and records to demonstrate why they are necessary and consistent with the taxpayer's 10 past expenditures, as well as the special circumstances that require these payments for the taxpayer and his or her family's health, welfare, and production of income.
Normally not allowed expenses: As indicated, money expended on anything else normally adds to the taxpayer's 10 RCP. This includes entertainment, vacations, non-allowable loan payments and the like.
   The really bad news is that the IRS can, and occasionally does, confiscate 100% of the taxpayer's 10 income, regardless of his or her bills. Also, they can and will padlock the taxpayer's 10 business, put a guard in place and make him or her pay for it. Such drastic actions are employed to get the attention and cooperation of especially abusive, flagrant, and fraudulent tax avoiders, all the more reason to be polite and compliant with IRS agents and observe the tax laws.

Insofar as allowed but capped expenses are concerned, the following approaches will help the taxpayer's 10 plan and control these outflows:
Food, clothing, etc. is the only category that the taxpayer 10 does not have to track and provide receipts for. Be careful, however, because anything the taxpayer 10 spends above the IRS maximum is included in his or her RCP.
One aggressive strategy is to prepay and stockpile those items the taxpayer 10 can prior to the documentation period so that his or her actual outlays are below the exclusion. This frees up money the taxpayer 10 can allocate to other things he or she wants to buy. Remember to disclose any such inventories to the IRS.
   For example, the IRS's current food budget for a family of three earning $5,000 per month is $1,156. Assume the taxpayer 10 were able to hold it to only $400 per month. That means the taxpayer 10 now has $756 per month that he or she does not need to keep track of and apply elsewhere. How is this possible? The only items the taxpayer 10 cannot inventory are perishables like fruits, vegetables, and dairy products. Budgeting $100 per person per month for these makes it doable. Consider buying a freezer and stocking it with meat.

Thus, amend the amount claimed for Food, Clothing & Misc. in the taxpayer's 10 Income/Expense Information (cell G39) to match what is allowed (cell I39). Once the taxpayer's 10 plan is complete, use the Implementation spreadsheet to calculate what he or she can prepay or stockpile, and thus, the sum he or she will spend on these items over the documentation period. While the taxpayer 10 must provide canceled checks and the like for his or her housing and utilities bills, these can be handled in a similar manner. For instance, assume that the taxpayer's 10 rent or mortgage is $200 under the IRS exemption for Housing and Utilities, but when he or she includes utility expenses, his or her total is $20 over the limit. Simply prepay the taxpayer's 10 utilities by $20 times the number of months he or she has to document his or her finances. This way, the taxpayer 10 still writes $200 worth of checks for his or her utilities each month. Again, be sure to disclose any prepaid expenses to the IRS.

Therefore, change the taxpayer's 10 declared housing outlays (cell G40) to no more than the amount the IRS accepts (cell I40). Also, review the transportation budget strategies described above so that cells G42 through G44 do not exceed the IRS limits.

Insofar as allowed but not necessarily capped expenses are concerned, the taxpayer 10 has much more latitude over these expenditures, so long as the IRS considers them reasonable. Also, if the taxpayer 10 can justify special circumstances, the IRS may approve even greater amounts.

These are very important because many of the adjustments to balance the taxpayer's 10 income and spending take place here. If, after the adjustments the taxpayer 10 has made so far, his or her income still exceeds his or her stated charges, consider the following strategies:
Medical: There is no set maximum and it is perhaps the easiest to justify. Plus, if the taxpayer 10 wants to justify “special circumstances” for his or her OIC, incurring large medical and psychiatric bills provides evidence for such claims. For example, no doubt the taxpayer 10 is under stress or has other psychological problems. Start seeing a therapist. In fact, other members of the taxpayer's 10 family may need this kind of intervention, too. While the IRS instructs the taxpayer 10 not to count “one time” events, consider incurring medical care the taxpayer 10 has been putting off, especially if it is the beginning of the year on his or her medical plan and his or her co-payment is an annual deductible.
Child and dependent care: There is no cap on these expenditures either, and care for elderly dependents applies, too. Just make it reasonable and document the need for such outlays.
Quarterly estimated taxes: Be sure to make generous payments of the taxpayer's 10 estimated taxes during the documentation period so he or she does not fall behind again. The taxpayer 10 will want to monitor these closely, however, because any overpayments for the full tax year will be applied to his or her back taxes, even if the IRS accepts his or her OIC.
Life insurance: Only premiums on term-life insurance polices are deductible. Consider whether the taxpayer 10 and one or more dependents could use some insurance, and can the annual premium be paid in advance.
Business and miscellaneous purchases: The IRS usually considers unreimbursed employee expenses, union dues, professional association fees, and savings into retirement plans reasonable and allowable. Also, do not forget charges by advisors to fix the taxpayer's 10 tax problems and so forth.
Loan payments: As noted before, generally avoid borrowing where the debt matures sooner than the taxpayer's 10 Monthly Multiplier expires.
Questionable purchases: Expenditures that the taxpayer 10 believes qualify as special circumstances have to be adequately documented and justified for IRS approval. If the taxpayer 10 thinks they qualify, allocate these to the appropriate categories in cells G39 through G51. Ideally, cells G53 through G55 (Other Expenses) should be zero or close to it.

Total income and expenses: The taxpayer's 10 claimed outgo should not significantly exceed his or her income (cell H59 would be negative). If so, reduce the taxpayer's 10 expenditures to approximate his or her income.

Be sure to save the taxpayer's 10 records and receipts to document his or her income and expenditures (with the exception of Food, Clothing & Misc.). Documentation means saving and producing copies of checks as well as credit and debit card and cash receipts. To get in the habit, remember that not being able to justify and prove just $10 per month could cost you $600 or more.

Update the Data Input and Results spreadsheet for changes to the taxpayer's 10 reported finances. For the taxpayer's 10 convenience, the Net Differences shown in cells H59 and I59 monitors the impact of these changes. The taxpayer's 10 goal is to get both of these numbers close to zero.

The example of John Taxwise illustrates how to implement several expense strategies. Recall from the earlier description he has been able to reduce his RCP from $210,912 to $44,476. All but $300 of the remaining is due to his Claimed Living Expenses exceeding his Allowed Living Expenses by $1,004 per month (see cell I59). Since his Monthly Multiplier is 44, the addition to his RCP is $44,176 (i.e., 44 times $1,004).

### See FIG. 26.

To bring his living expenses in line, John takes these steps: 1) creates an inventory of Food, Clothing & Misc. so that the Amount Claimed (cell G39) equals the Amount Allowed (cell I39); 2) refinances his mobile home for a longer term so that his monthly mortgage payment is cut by $200; 3) starts taking the bus to work so that his Transportation Operating Costs (cell G44) is reduced to the amount allowed (cell I44); 4) buys a supplemental health insurance policy for $300 per month; 5) increases his monthly tax withholding to $1,376; 6) purchases term life insurance for $100 per month; and 7) eliminates the $80 per month going to Entertainment. The following entries accomplish these strategies:
1. “916” in cell G39 (Claimed Food, Clothing & Misc.)
2. “180” in cell F19 (Mortgage Term)
3. “800” in cell I19 (Mortgage Payment)
4. “1100” in cell G40 (Claimed Housing and Utilities Expenses)
5. “338” in cell G44 (Claimed Transportation Operating Costs)
6. “300” in cell G45 (Claimed Health Insurance premium)
7. “1376” in cell G47 (Taxes withheld)
8. “100” in cell G50 (Life Insurance premium)
9. “0” in cell G54 (Entertainment)
At this point John's RCP is $300, well below the amount needed to qualify and have his $500 offer in compromise accepted.

### See FIG. 27.

Based on the foregoing description of applicable strategies and entry of data, the taxpayer 10 can test and execute his or her OIC strategy. At this point the taxpayer 10 has completed the “before” and “after” analyses of his or her finances. The “after” perspective contains the taxpayer's 10 strategy for qualifying for an OIC and the settlement terms he or she can live with. The taxpayer 10 is cautioned not to give the printouts of his or her plan to the IRS as documentation for his or her OIC application. Doing so could invite requests for even more information from the IRS. In he following description, the taxpayer 10 tests the feasibility of his or her plan by examining:
The changes to the taxpayer's 10 assets and liabilities prior to applying for an OIC.
The taxpayer's 10 income and outflows during the documentation period.
The allocation of funds such that the taxpayer's 10 sources and uses of cash are equal.

The taxpayer 10 initially determines his or her total change in cash. The purpose of this step is to ascertain how much cash, if any, will be generated by the planned changes to the taxpayer's 10 assets and liabilities. In cells D7 through D31 of the Implementation spreadsheet, enter the beginning Fair Market Values (FMV) on all the taxpayer's 10 assets (get these numbers from his or her “Before” file). Similarly, enter the taxpayer's 10 beginning debts in cells F7 through F31. The offer in compromise software application automatically calculates the Total Change in Cash resulting from all the adjustments the taxpayer 10 plans for these accounts and reports that figure in cell H32. This is copied into cell E59, the taxpayer's 10 Total Sources of Cash.

The taxpayer 10 is cautioned that if he or she plans to gift an asset, not to include its FMV or related loans in the beginning numbers. Otherwise, the offer in compromise software application will assume the taxpayer 10 sold it and increases the Total Change in Cash by that amount. Also, devaluing the taxpayer's 10 Furniture/Personal Effects and Tools and/or Equipment to garage-sale prices does not impact the taxpayer's 10 cash because no transaction takes place.

How much cash is freed up and applied toward stockpiles or prepayment of services varies with three assumptions. The first is the number of months the taxpayer 10 needs to document his or her financial data (cell I58). Usually this is up to six months if the taxpayer 10 is employed by a company, or nine months if self-employed. The second assumption is the reserves (if any) the taxpayer 10 wants on top of his or her stockpiles. Suppose the offer in compromise software application indicates the taxpayer 10 needs a stockpile of $1,000. If the taxpayer 10 wants a 10% reserve ($100) to make sure he or she has enough, then enter “10” in cell I60. The third is the level of spending the taxpayer 10 desires to budget for during the documentation period.

As an example consider John Taxwise's cash flow strategies. Once the beginning asset values and loan amounts are entered into John's Implementation spreadsheet, the offer in compromise software application calculates that $54,700 of cash is freed up from the changes in his finances (see cell H32).
1. “4000” in cell D8 (Beginning Checking Account)
2. “1000” in cell D9 (Beginning Savings Account)
3. “100000” in cell D13 (Beginning Pensions)
4. “50000” in cell D15 (Beginning Real Estate with Allowable Loans)
5. “10000” in cell D18 (Beginning Value of Furniture/Personal Effects); revising this figure downward does not generate any cash so cell H18 is zero
6. “2000” in cell D22 (Beginning Tool and/or Equipment); if this had been revised downward it, too, would not have generated any cash or changed cell H22
7. “6000” in cell D24 (Beginning Car #1 Fair Market Value)
8. “50000” in cell F15 (Beginning Real Estate Loan)
9. “6000” in cell F24 (Beginning Car #1 Loan)

### See FIG. 28.

John is an employee and desires a 10% reserve so he enters:
10. “6” in cell I58 (Months for Documentation)
11. “10” in cell I60 (Stockpiling Reserves)

### See FIG. 29.

Budgeting strategies can also be applied. Here the taxpayer 10 reconciles his or her desired level of consumption during the documentation period with how much cash is available from repositioning his or her assets and liabilities. The goal is to stockpile or prepay enough of what the taxpayer 10 consumes so that his or her cash expenditures are within the IRS limits. This will be true only if the taxpayer 10 has sufficient cash to acquire these items ahead of time. If not, the taxpayer 10 must allocate whatever money is available to minimize the inconvenience. The examples that follow will make this clear.

Start by entering the taxpayer's 10 desired monthly expenditures (not the IRS exemptions) in cells C37 through C53 of the taxpayer's 10 Implementation spreadsheet. The taxpayer's 10 planned food purchases (cell C37) are likely to be the same as “Before.” In other words, if the taxpayer 10 normally spends $2,000 per month for food, clothing, and miscellaneous expenses, he or she would probably want to keep that level even during the documentation period. Enter what the taxpayer 10 plans to pay for food, etc. out of current income in cell D37. Typically, this will be the IRS exemption but the taxpayer 10 may find it advantageous to make it even less than this limit as will be described below.

Housing related expenses (cell C38) should reflect any mortgage refinancings plus the taxpayer's 10 actual expected utility bills. The taxpayer's 10 transportation disbursements in cells C40 through C42 are the forecasted amounts (again, not the IRS exclusions). Enter all the taxpayer's 10 other allowed necessities as projected in cells C43 to C49 (mostly these should be the same as forecasted in the “After” file). Lastly, the taxpayer's 10 preference, no doubt, is to maintain his or her entertainment outgo at the “Before” levels, so enter this in cell C53. Other Expense items have likely been eliminated so put zeros in cells C51 and C53 or, if not completely done away with, the projected expenditures.

The use of prepaid expenses and stockpiles may also be considered. The strategies that follow only apply if the taxpayer's 10 Total Change in Cash is positive. In other words, the adjustments to the taxpayer's 10 assets must generate cash to procure stockpiles, make prepayments, and be available for other purposes.

The offer in compromise software application automatically allocates available cash when desired disbursements are greater than what the taxpayer 10 can pay for from monthly income. It does this by creating stockpiles in the following descending rank of importance: food, housing, transportation, other accepted categories, and lastly, other (non-sanctioned) expenses such as entertainment.

For instance, assume that after moving the taxpayer's 10 assets around, his or her Total Change in Cash is $5,000. Say the taxpayer 10 needs a stockpile of $1,000 to keep his or her food budget at the desired level. The offer in compromise software application automatically makes $1,000 available for this purpose. If there is a shortfall for housing, the next $4,000 could be applied to that and so on to cells E38 through E53, until all the classes of expenditures are at the desired level and the need for stockpiles is fulfilled or the available cash is exhausted.

If not enough money is available, then offer in compromise software application covers the most critical payments in the order of the listed class of expenditures (food, then housing, then transportation, and so forth). If the taxpayer 10 wants to adjust these priorities, change the desired outgo in cells E37 through E53.

To demonstrate, if the taxpayer 10 cannot do without a stockpile of $1,000 to operate his or her cars, but all the cash is being absorbed by his or her food fund, then reduce his or her desired food spending level until the $1,000 trickles down to operate his or her cars. Keep in mind such amendments replicate how the taxpayer 10 plans to allocate his or her money. In other words, the taxpayer 10 really is going to buy $1,000 less food per month so he or she can run his or her cars.

The next strategy to address is the option to re-allocate surpluses, if any, from Food, Clothing & Misc. Recall that the IRS sets maximums for this category, but the taxpayer 10 does not have to provide receipts. So, if the taxpayer 10 is under the allowance, the excess can be applied to other categories. Enter the taxpayer's 10 plan to spend from current income (i.e., cash payments each month) on Food, Clothing & Misc. in cell D37. The offer in compromise software application automatically shows the excess (if any) in cell E37. If E37 is positive, distribute this surplus to cells E38 to E53 until all the money is used and cells E37 and E54 are equal.

For example, say the IRS's limit for the taxpayer's 10 family is $1,500 per month and he or she plans to actually buy only $500 and prepay or draw down from stockpiles whatever else is desired. This frees up $1,000 to allocate to other necessities. Suppose further that the taxpayer's 10 housing bills are $300 over what the IRS authorizes. Apply $300 of the $1,000 to housing. If the operating costs for the taxpayer's 10 cars are $200 a month over the exemption, use the next $200 to cover this shortfall. If no other classes of expense are in deficit, the remaining $500 can go for entertainment. Again the taxpayer 10 is strongly advised to inform the IRS of any stockpiles and prepaid expenses in his or her OIC financial disclosure forms (examples of how to do this are described below).

Excess cash to can also be allocated to other uses. Any money that remains after stockpiling is applied to 1) the OIC payments and fees (cells E64 through E66) and 2) the alternatives presented in cells E70 to E78. Regarding the former, enter the OIC application fee in cell E64. This will normally be $150, unless the taxpayer 10 files for a low income exemption using IRS Form 656-A. The other OIC payments are entered automatically for the taxpayer 10. The other places to put cash (cells E70 to E78) were described above, “Strategies for Sheltering the Cash.” When these entries are complete the taxpayer's 10 sources and uses of cash (cells F61 and F80) should be equal and all the numbers in cells E59 to F80 should be black (if in red that indicates cells F61 and F80 are unequal).

An example will now be described for John Taxwise's budget strategies. John plans his budget as follows: 1) keep his Food, Clothing & Misc. spending at the pre-documentation levels ($1,500 per month) but only have cash outlays equal to the IRS exemption ($916) so he will have to stockpile to do this; 2) pay his mortgage and utilities bills at the new lower amount ($1,100) after refinancing his loan; 3) make his car lease payment ($470); 4) retain his car operating costs at the pre-documentation level ($500) by prepaying expenses; 5) pay his health insurance premium ($300); 6) increase his tax withholding to $1,376; 7) spend $100 on his new life insurance policy; and 8) make a $450 payment to his 401(k) plan. This budget is finalized with these entries in his Implementation spreadsheet,
12. “1500” in cell C37 (Desired Food, Clothing & Misc. expenses)
13. “1100” in cell C38 (Desired Housing and Utilities expenses)
14. “470” in cell C40 (Desired Car #1 Ownership costs)
15. “500” in cell C42 (Desired Car Operating costs)
16. “300” in cell C43 (Desired Health Insurance premium)
17. “1376” in cell C45 (Desired Tax withholding)
18. “100” in cell C48 (Desired Life Insurance premium)
19. “450” in cell C49 (Desired Secured Loan payments)
20. “916” in cell D37 (Food, Clothing & Misc. expenses paid from income)

### See FIG. 30.

Note that the shortfall in John's monthly Food, Clothing & Misc. budget of $584 is shown in cell F37. This amount is his desired spending of $1,500 in cell C37 minus the amount to be paid out of his earnings of $916 in cell D37. The shortfall is made up by creating a reserve of $3,854 (cells H37 and 137). In addition, the $162 deficit (cell F42) in his monthly car operating costs is eliminated by funding a $1,069 stockpile (cells H42 and I42) or prepaying expenses in that amount.

The total stockpiles are $4,924 (cell I54) and copied into cell E68 under Uses of Cash. John values these inventories at 5% of their purchase price and either adds $246 to his Furniture/Personal Effects or lists $246 as “Prepaid Expenses” on his OIC application.

John makes these allocations for the remaining cash:
21. “150” in cell E64 (OIC Application Fee)
22. “10000” in cell E70 (Purchase of Furniture and Personal Effects)
23. “5000” in cell E71 (Purchase of Tools and/or Equipment)
24. “20000” in cell E73 (Expenditures on Home Improvements)
25. “14126” in cell E76 (Gifts to Family Members)

### See FIG. 31.

Now the taxpayer 10 knows where his or her cash is coming from and where to apply it. Also, the taxpayer 10 has a specific, concrete plan to see him or her through the documentation period. The following description illustrates how all this comes together in three extensive examples.

Consider the following examples using the OIC strategies described above. Three separate examples are presented to demonstrate how the offer in compromise software application can be used in various OIC situations, even when the starting RCP is very high. The first shows a taxpayer with moderate assets and income. The second emphasizes strategies for those with high assets and the last deals with a high income OIC challenge.

The taxpayer 10 has to plan his or her OIC offer, reposition his or her assets, and maintain a strict budget for six to nine months while he or she documents his or her income and spending. The result may be that the taxpayer 10 can save $98,500 like Roy in the first example or $227,000 as Mary does in the second.

First, consider the example of Roy No Canpay's OIC. Roy is a self-employed building contractor who got behind in his taxes during the start-up years of his business. His total tax debt with penalties and interest is $100,000. A summary of this and his financial circumstances before any planning is shown in Appendix A as Example #3: Roy No Canpay's OIC. One can recreate this scenario by saving the offer in compromise software application template as “Roy No Canpay before” and entering the data as described below.

Without any planning Roy's RCP would be $274,588. Since this far exceeds the $100,000 he owes, the IRS would demand payment of all the taxes owed. Fortunately, however, Roy can adjust his finances and qualify for an OIC. In fact, detailed below are the steps to reduce his RCP to only $750, even less than what he offers to settle.

Enter Roy's personal and financial data in the offer in compromise software application as follows:

Monthly Multiplier spreadsheet:
1. “2/15/2007” in cell E3 (Date of Analysis)
   2. “Roy No Canpay” in cell M3 (Name)
   3. “C” in L26 (cash OIC settlement option is selected).
   4. “1998” in cell E35 (year taxes owed), “40000” in F35 (taxes owed), “85” in I35 (months since first notice received for this year)
5. “1999” in cell E36 (year taxes owed), “30000” in F36 (taxes owed), “65” in I36 (months since first notice received for this year)
6. “2000” in cell E37 (year taxes owed), “20000” in F37 (taxes owed), “40” in I37 (months since first notice received for this year)
7. “2001” in cell E38 (year taxes owed), “10000” in F38 (taxes owed), “32” in I38 (months since first notice received for this year)
8. “1” in cell L64 (the Monthly Multiplier being selected; in this case, the IRS's multiplier)

### See FIG. 32.

### See FIG. 33.

### See FIG. 34.

Data Input and Results spreadsheet:
9. “Santa Clara, Calif.” in E4 (taxpayer's county and state of residence)
10. “0” in cell I4 (for now he chooses not to discount future cash flows)
11. “4” in cell F5 (number of people in taxpayer's household)
12. “1500” in cell I6 (amount offered to settle OIC). Recall that this figure determines the amount he must submit for a deposit on his OIC application.
13. “300” in cell C11 (Cash)
14. “500” in cell C12 (Checking Account(s))
15. “1000” in cell C13 (Savings Account(s))
16. “2000” in cell C14 (Business Bank Account(s))
17. “3000” in cell C16 (Life Insurance Cash Value)
18. “50000” in cell C17 (Pensions)
19. “450000” in cell C19 (Real Estate with Allowable Loans)
20. “25000” in cell C22 (Value of all Furniture/Personal Effects)
21. “3500” in cell C25 (Accounts Receivable)
22. “50000” in cell C26 (Tools and/or Equipment)
23. “2003 Dodge truck” in cell B28, “10000” in cell C28 (Car #1)
24. “2002 BMW” in cell B29, “15000” in cell C29 (Car #2)
25. “Gold” in cell B31, “3500” in cell C31 (Asset #1)
26. “3000” in cell C40 (Wages/Salaries: TP2)
27. “7500” in cell C42 (Net Business Income: Sole Prop.'s)
28. “US Life” in cell D16 (Life Insurance Creditor)
29. “US Savings” in cell D19 (Real Estate Creditor)
30. “VISA” in cell D24 (Personal Loan Creditor)
31. “Cheap Car Loans” in cell D28 (Car #1 Creditor)
32. “Cheap Car Loans” in cell D29 (Car #2 Creditor)
33. “1000” in cell E16 (Life Insurance Loan)
34. “300000” in cell E19 (Real Estate Loan)
35. “5000” in cell E24 (Personal Loan)
36. “8000” in cell E28 (Car #1 Loan)
37. “10000” in cell E29 (Car #2 Loan)
38. “20” in cell F16 (Life Insurance Loan Term)
39. “240” in cell F19 (Real Estate Loan Term)
40. “18” in cell F24 (Personal Loan Term)
41. “36” in cell F28 (Car #1 Loan Term)
42. “24” in cell F29 (Car#2 Loan Term)
43. “7040” in cell G22 (Furniture/Personal Effects Exemption); in 2007 this was increased to $7,720
44. “3520” in cell G26 (Tools and/or Equipment Exemption); in 2007 this was increased to $3,860
45. “2000” in cell G39 (Food, Clothing & Misc. Expenses)
46. “2300” in cell G40 (Housing and Utilities Expenses)
47. “600” in cell G44 (Transportation Operating Costs)
48. “550” in cell G45 (Health Insurance Expense)
49. “200” in cell G46 (Other Health Expenses)
50. “2500” in cell G47 (Taxes)
51. “150” in cell G50 (Life Insurance Premiums)
52. “50” in cell G51 (Allowable Loan Payments)
53. “350” in cell G53 (Non-Allowable Loan Payments)
54. “650” in cell G54 (Entertainment, Vacation & Misc. Expenses)
55. “50” in cell I16 (Life Insurance Loan Payment)
56. “1500” in cell I19 (Real Estate Loan Payment)
57. “350” in cell I24 (Personal Loan Payment)
58. “550” in cell I28 (Car #1 Loan Payment)
59. “600” in cell I29 (Car #2 Loan Payment)
60. “1564” in cell I39 (Food, Clothing & Misc. Exemption)
61. “2771” in cell I40 (Housing and Utilities Exemption)
62. “475” in cell I42 (Car #1 Ownership Exemption)
63. “338” in cell I43 (Car #2 Ownership Exemption)
64. “466” in cell I44 (Transportation Operating Exemption)

### See FIG. 35.

To check that the numbers entered are accurate, his RCP should total $274,588 when completed. Save this file to keep the work and use it later to strategize Roy's OIC plan. Clearly the IRS will reject his offer and recommend he pay the full amount due (see cells A65 and D65). Thus, his OIC deposit of $300 (cell C62) will be applied to his outstanding tax liability and he will lose his application fee of $150.

### See FIG. 36.

How Roy can qualify for his OIC will now be described.

Regarding Monthly Multiplier strategies, sometimes the IRS proposes to base Monthly Multipliers solely on the most recent tax year. Roy can justifiably point out that using a weighted average would result in a more equitable multiplier of 43 rather than 48. Note that even if the IRS stubbornly holds to their position, using a multiplier of 48 would not increase Roy's ending RCP of $750. This is possible because, by reducing his excess income and eliminating his retired debt problems, it will not matter how high the multiplier is.

Select the most favorable averaging multiplier, which cuts his RCP by $14,404.
1. Use “Save As . . . ” and the “Before” file to create a new file: “Roy No Canpay after”
2. “3” in L64 of the Monthly Multiplier spreadsheet

Insofar as asset and liability strategies are concerned, the above change does not alter the contribution that the equity in Roy's assets makes to his RCP. It remains unchanged at $167,840 (cell I62 of the Data Input and Results spreadsheet).

To determine the source, go to the Asset Equity Table spreadsheet and review the figures in the right column, Net Realizable Equity. While there are many smaller items to fix, the largest four ones account for $154,440 or 92% of the problem. As a test, Roy opts to see what impact discounting his future cash flows would have: enter “10” in cell I4 (the annual discount rate selected). This change would lessen his RCP by $15,867. While this looks substantial, Roy decides to pursue other strategies before resorting to the discounting option. Cancel this by entering “0” in I4.

On the Data Input and Results spreadsheet, make the following changes, which will decrease his RCP by $77,120 to $183,064. To zero out the $60,000 of equity in his home, Roy refinances and increases his mortgage to $360,000. One would think this would only take $60,000 off his RCP but the increased mortgage payment also cuts his excess income. If the IRS had a lien on his home, however, refinancing would require their permission and they would apply the $60,000 to his tax bill.
3. “360000” in cell E19 (Real Estate with Allowable Loans); this debt is “allowable” since it is on his home
4. “1900” in cell I19 (Monthly Loan Payment)
5. “2700” in cell G40 (Housing and Utilities)

### See FIG. 37.

Next, the $60,000 can be used for a variety of purposes: home improvements, living expense provisions, business requirements (e.g., tools, equipment and promotion), home furnishings, and so forth. For instance, $5,000 is used to eliminate his Visa charges:
6. “None” in cell D24 (Non-Allowable Personal Loans), “0” in cells E24 (Loan Amount), F24 (Loan Term) and I24 (Loan Payment)
7. “0” in cell G53 (Non-Allowed Loan Payments) because $350 per month no longer goes to Visa
8. “600” in G54 (Entertainment, Vacations & Misc.) which balances his income and claimed outlays after the above changes

### See FIG. 38.

Note that discharging the Visa debt boosts his RCP by $5,000 because it increases the equity in his Furniture/Personal Effects. Curiously, the IRS disallows the Visa bill as a necessity but permits it as a deduction from the equity in his personal property. Next Roy researches his wife's pension plan and discovers that she cannot borrow against it or otherwise access the funds, which takes his RCP down to $138,064.
9. “50000” in cell G17 (Exemption—pension plans)

### See FIG. 39.

Roy realizes he has been looking at their Furniture/Personal Effects from the perspective of their cost, rather than their garage-sale, flea market, eBay, or auction value. This more realistic appraisal puts their Fair Market Value at $5,000 rather than $25,000.
10. 10. “5000” in cell C22 (the Total Fair Market Value of all his Furniture/Personal Effects)

### See FIG. 40.

In fact, he would have to have more than $7,720 in cell C24 before it would start to increase his RCP because of the exclusion. So, if he valued this property at five cents on the dollar, $7,720 could represent $154,400 of goods at their original purchase price (or $257,333 at three cents per dollar).

The same re-evaluation of his business tools and equipment takes this number down to $3,000, not $50,000 as he originally assumed. Also recall that he could have up to $3,860 in cell C26 without adding to his RCP. As described above this could shelter up to $77,200 or $128,667 if valued at five cents or three cents rather than at retail prices, respectively.
11. “3000” in cell C26 (Tools and Equipment);

At this point his RCP is $88,624. Roy now pulls cash out of various accounts, trades in his whole life insurance policy with a cash value for a term life policy at the same monthly fee and makes the adjustments below to his Data Input and Results spreadsheet.
12. “50” in cell C11 (Cash)
13. “100” in cell C12 (Checking Account)
14. “0” in cell C13 (Savings Account)
15. “200” in cell C14 (Business Bank Account)
16. “0” in cell C16 (Life Insurance Cash Value), “None” in cell D16, “0” in cell E16 (Loan Amount—life insurance), “0” in cell F16 (Loan Term), “0” in I16 (Loan Payment),
17. “0” in G51 (Allowable Loan Payments); as he cashes out the policy and eliminates the debt
18. “500” in cell C25 (Accounts Receivable)

### See FIG. 41.

Roy sells his current cars and leases replacement vehicles:
19. “New car #1” in cell B28 (name of Vehicle #1), “0” in cell C28 (Car #1 Fair Market Value) and “Car Lease #1” in cell D28 (Creditor)
20. “0” in cell E28 (Loan Amount), “0” in cell F28 (Loan Term), “450” in cell H28 (Lease Payment) and “0” in I28 (Loan Payment)
21. “New car #2” in cell B29 (name of Vehicle #2), “0” in cell C29 (Car #2 Fair Market Value) and “Car Lease #2” in cell D29 (Creditor)
22. “0” in cell E29 (Loan Amount), “0” in cell F29 (Loan Term), “300” in cell H29 (Lease Payment) and “0” in 129 (Loan Payment)
   Selling his cars and leasing new ones also zeros out the $9,584 that his car ownership costs added to his RCP from retiring those obligations ahead of the expiration of his Monthly Multiplier. Lastly, he sells his gold investments and balances his income and expenditures:
23. “0” in cell C31 (Asset #1) and delete “Gold” in cell B31
24. “1050” in cell G54 (Entertainment, Vacations & Misc.) to re-balance his income and claimed spending so that H59 is zero

### See FIG. 42.

The total of these changes reduces his RCP by $18,538 to $70,086.

There are also income and expense strategies that Roy can employ. At this stage 99% of his RCP comes from the imbalance of his income and authorized expenditures. To further reduce it, Roy must adjust his income and expenses over the period he is documenting these transactions. Recall from the description above that there are five basic strategies to bring monthly cash flows into acceptable IRS guidelines. These are 1) reducing income, 2) increasing allowable expenses that normally do not have set limits, 3) decreasing allowable expenses that are above the limits, 4) cutting non-allowable expenses, and 5) pre-paying expenses and/or buy provisions. Here is how Roy utilizes these approaches to win his OIC.

To begin, Roy reduces his earnings by decreasing sales or increasing his business costs by $1,000 per month so that his income declines by $1,000.
25. “6500” in cell C42 (Net business Income—sole proprietorship)

### See FIG. 43.

Next, he spends more on allowable expenses that are not usually capped.
26. “320” in cell G46 (Other Health Care); Roy and his wife seek counseling over the financial stresses in their life
27. “3000” in cell G47 (Taxes); Roy negotiated his back state taxes and included that $500 per month in this category

Now, he cuts expenses that are over the IRS allowances. Recall that Food, Clothing & Misc. is the only category of expense that he is not required to keep records or receipts for amounts up to the IRS exemption, which in his case is $1,564.
28. “1564” in cell G39 (Food, Clothing & Misc.) to equal the IRS allowance for his situation
29. “466” in cell G44 (Car Operating Costs) to bring these costs in line with IRS guidelines

Lastly, he budgets less for non-allowable expenses. The net difference in cell H59 shows Roy would spend $1,045 more than his income, so he eliminates his entertainment outlays to balance his income with his claimed and allowed living expenditures.
30. “0” in G54 (Entertainment, vacations & misc.), now H59 and I59 are zero

The strategies described take Roy's RCP to $750 (cell I65). Importantly, the IRS's recommendation changes and they accept his offer to pay $1,500 (cells A65 and D65).

To test his plan Roy utilizes the Implementation spreadsheet of his “After” file, which has his final RCP of $750. The offer in compromise software application automatically entered the ending asset values in cells E7 through E31, as well as the ending liabilities (cells G7 through G31). Now he enters the beginning assets (cells D7 to D31) and liabilities (F7 to F31).
31. “300” in cell D7 (Cash)
32. “500” in cell D8 (Checking Account(s))
33. “1000” in cell D9 (Savings Account(s))
34. “2000” in cell D10 (Business Bank Account(s))
35. “3000” in cell D12 (Life Insurance Cash Value)
36. “50000” in cell D13 (Pensions)
37. “450000” in cell D15 (Real Estate with Allowable Loans)
38. “25000” in cell D18 (Value of all Furniture/Personal Effects)
39. “3500” in cell D21 (Accounts Receivable)
40. “50000” in cell D22 (Tools and/or Equipment)
41. “10000” in cell D24 (Car #1)
42. “15000” in cell D25 (Car #2)
43. “3500” in cell D27 (Asset #1)
44. “1000” in cell F12 (Life Insurance Cash Value)
45. “300000” in cell F15 (Real Estate with Allowable Loans)
46. “5000” in cell F20 (Non-Allowable Personal Loans)
47. “8000” in cell F24 (Car #1)
48. “10000” in cell F25 (Car #2)
   The offer in compromise software application calculates the change in his cash from each asset and liability transaction. For example, in Roy's case the Total Change in Cash in cell H32 should be $73,950. Note that revaluing his Furniture/Personal Effects from $25,000 (cell D18) down to $5,000 (E18) does not decrease his cash in cell H18, because no transaction has taken place. Similarly, restating the value of his Tools and/or Equipment in row 22 doesn't impact his cash.

Now he enters his projected budget into cells C37 through C53 (do not enter the IRS exemptions).
49. “2000” in cell C37 (Food, Clothing & Misc.); his prior budget and the level he would like to continue consuming
50. “1564” in cell D37 (Food, Clothing & Misc.); he limits his cash outlays for these items to the IRS's exemption
51. “2700” in cell C38 (Housing and Utilities); this payment includes his new mortgage obligation
52. “450” and “300” in cells C40 and C41 (Car Ownership Costs); the monthly payments on his new leases
53. “600” in cell C42 (Car Operating Costs); his prior budget and the level he would like to continue consuming
54. “550” in cell C43 (Health Insurance); his prior spending level
55. “320” in cell C44 (Other Health Care); the new budgeted amount
56. “3000” in cell C45 (Taxes); the increased withholding FIG.
57. “150” in cell C48 (Life Insurance); the prior spending amount
58. “650” in cell C52 (Entertainment, Vacations & Misc.); his prior budget and the level he would like to continue consuming

### See FIG. 44.

Note that the $1,564 per month he now plans to spend for food, clothing, and miscellaneous is $436 less than what he had been buying. One strategy to fill this gap is to create an inventory of goods (e.g., frozen meat, can goods, toiletries, apparel, and so forth) that can be drawn down over the documentation period. In this way Roy can maintain his standard of living in this important category. Similarly there are $134 and $650 shortfalls per month for Car Operating Costs and Entertainment, respectively. To calculate how much inventory or prepaid expenses his family needs for these purposes, make the following entries:
59. “9” in cell I58 (Months for Documentation Period); Roy enters “9” because he's self-employed and wants an extra three-month cushion to record his spending patterns
60. “10” in cell I60 (Stockpiling Reserves); this sets a 10% reserve on top of the stockpiles and prepayments See FIG. 45.
   Row 37 shows the results for his food budget: what he wants to consume ($2,000 per month in cell C37) is paid for from current income ($1,564 in cell D37) leaving a shortfall of $436 (cell F37). The amount of reserves he would like is $4,316 ($436 times nine months plus a 10% reserve; see cell H37). Sufficient money is freed up (cell H32) so that he can fully fund this use of cash as well as reserves for his car and entertainment expenses. Actual Stockpiles (cell I54) now equals $12,078.

Including reserves for food, car operating and entertainment expenses, his Monthly Expenses and Stockpiles (rows 33 through 54) are specified. Compare the sums shown in Appendix A: Roy's (after) Implementation spreadsheet printout to verify entries.

The total amount of Actual Stockpiles (I54) is copied into cell E68 to start planning of his sources and uses of funding beginning in row 57. Enter his OIC application fee:
61. “150” in cell E64 (OIC Application Fee)

Cells E70 through E78 offer alternative ways for Roy to allocate his remaining cash. Fill in these amounts according to what Roy chooses (refer to the “After” Implementation spreadsheet) so that his Total Sources of Cash and Total Uses of Cash are equal (cells F61 and F80).
62. “7500” in cell E70 (Purchase of Furniture and Personal Effects)
63. “10000” in cell E71 (Purchase of Tools and/or Equipment)
64. “2722” in cell E72 (Prepayment of Other Bills)
65. “25000” in cell E73 (Expenditures on Home Improvements)
66. “5000” in cell E75 (Payments to “Close” Creditors)
67. “10000” in cell E76 (Gifts to Family Members)
   Note that the numbers will remain bold red until cells F61 and F80 balance.

### See FIG. 46.

In summary, Roy started owing $100,000 in taxes and an RCP of $274,588. Clearly, he could not negotiate an OIC but would have to pay in full. However, various strategies helped him to qualify and remit what he offered in settlement. The resulting savings total $98,500.

The test of his plan confirms its feasibility and specifies his cash flows and planned disbursements. All of his desired expenditures can be met during the documentation period by utilizing stockpiles and prepaying expenses. Full disclosure of these transactions is made on his IRS financial applications (see IRS Forms 433-A and 433-B in Appendix A, Example #2: Roy No Canpay).

For instance, the additions to Roy's provisions of Food, Clothing & Misc. ($4,316 in cell I37 and $7,500 in cell E70 of the Implementation spreadsheet) total $11,816, but when valued at five cents on the dollar only increase his Furniture/Personal Effects by $591. Therefore, Roy adds this amount to his prior balance of $5,000 and enters $5,591 in line 21a of his financial disclosure form 433-A (see Appendix A).

Also, his prepaid expenses ($1,327 in cell I42, $6,435 in cell I52 and $2,722 in cell E72) total $10,484 which, at 5% of purchase price, is $524. This figure goes in line 21d (“Deposits, Prepaid Expenses”) of his Form 433-A. Similarly, the $10,000 purchase of Tools and/or Equipment (cell E71) only boosts line item 22a (“Tools used in Trade/Business”) by $500 to a total of $3,500. In addition, Roy remembers to enter the revised amount for his tools on line 11a of his business financial disclosure form (IRA Form 443-B, see Appendix A).

In conclusion, to implement his OIC strategy, Roy would take these actions:
1. Make the changes to his assets and liabilities as described above.
2. Stay within the “After” budget limits and document these income and expenditure amounts for six months (three months had he been an employee or retired).
3. Submit his OIC application together with the IRS financial disclosure forms demonstrating six months of his “After” income and expenses.
   Maintain his “After” budget and be prepared to provide an additional three months of income and expense documentation.

As a second example, consider Mary N. Trouble's OIC. Mary N. Trouble sold her business in 1999, used the proceeds to pay off her mortgage and other borrowings and retired. Unfortunately she did not pay all the taxes due on the sale, so this liability has grown to $230,000. Her dilemma is that she can either a) take out a mortgage on her house to eliminate her tax debt but incur a high monthly payment or b) sell the house and wipe out a high percentage of her net worth with capital gains and back taxes. If she approached the IRS with her present RCP of $879,870, they would demand all her back taxes be paid.

This is an instance of having high assets and relatively modest income. Nevertheless, there is a strategy where Mary's tax debt can be settled for what she is offering, $3,000. Moreover, the offer in compromise software application could cut her RCP to zero and she could offer just that. However, it is best to let the IRS recover something; otherwise they will look for a reason not to accept the offer.

Enter Mary's starting data and implement the strategy step-by-step.

In the Monthly Multiplier spreadsheet enter:
1. “11/1/2006” in cell E3 (Date of Analysis)
2. “Mary N. Trouble” in cell M3 (Name)
3. “S” in cell L26 (the type of settlement offer being made)
4. “1999” in cell E35 (year taxes owed), “200000” in F35 (taxes owed), “80” in I35 (months since first notice received for this year)
5. “2000” in cell E36 (year taxes owed), “30000” in F36 (taxes owed), “50” in I36 (months since first notice received for this year)
6. “1” in cell L64 (the Monthly Multiplier being selected; in this case, the IRS's multiplier)

### See FIG. 47.

### See FIG. 48.

In the Data Input and Results spreadsheet enter:
7. “Santa Clara, Calif.” in E4 (taxpayer's county and state of residence)
8. “0” in cell I4 (for now she chooses not to discount future cash flows)
9. “1” in cell F5 (number of people in taxpayer's household)
10. “3000” in cell I6 (amount offered to settle OIC, which impacts how much her OIC deposit is)
11. “100” in cell C11 (Cash)
12. “500” in cell C12 (Checking Account(s))
13. “10000” in cell C13 (Savings Account(s))
14. “800000” in cell C19 (Real Estate with Allowable Loans)
15. “20000” in cell C22 (Value of all Furniture/Personal Effects)
16. “2002 Mercedes” in cell B28, “15000” in cell C28 (Car #1)
17. “Stock portfolio” in cell B31, “60000” in cell C31 (Asset #1)
18. “2000” in cell C41 (Interest—Dividends)
19. “3500” in cell C45 (Pension/Social Security: TP1)
20. “4500” in cell C55 (Expected wages used from year prior)
21. “Cheap Car Loans” in cell D28 (Car #1 Creditor)
22. “7000” in cell E28 (Car #1 Loan)
23. “30” in cell F28 (Car #1 Loan Term)
24. “7040” in cell G22 (Furniture/Personal Effects Exemption); in 2007 this was increased to $7,720
25. “1200” in cell G39 (Food, Clothing & Misc. Expenses)
26. “400” in cell G40 (Housing and Utilities Expenses)
27. “300” in cell G44 (Transportation Operating Costs)
28. “100” in cell G45 (Health Insurance Expense)
29. “25” in cell G46 (Other Health Expenses)
30. “1000” in cell G47 (Taxes)
31. “1975” in cell G54 (Entertainment, Vacation & Misc. Expenses)
32. “500” in cell I28 (Car #1 Loan Payment)
33. “649” in cell I39 (Food, Clothing & Misc. Exemption)
34. “1812” in cell I40 (Housing and Utilities Exemption)
35. “475” in cell I42 (Car #1 Ownership Exemption)
36. “317” in cell I44 (Transportation Operating Exemption)
   To check that the numbers inputted are accurate, her RCP should total $985,780. Save this file.

### See FIG. 49.

The following describes how Mary can qualify for her OIC. Insofar as Monthly Multiplier strategies are concerned, use Mary's “Before” file to save a new one: “Mary N. Trouble after.” Amending her Monthly Multiplier to one that averages the two years decreases her RCP by $52,626.
1. “3” in L64 of the Monthly Multiplier spreadsheet

### See FIG. 50.

Regarding asset and liability strategies, Mary performs a sensitivity analysis to discover the benefit that discounting her future cash flows may provide. But, since it only cuts her RCP by $19,056 (using a 10% annual discount rate), she chooses not to do this.

Perhaps the best solution would be to gift the house to a charity using a charitable remainder trust. There are several advantages for Mary from this strategy: The house is sold and no capital gains taxes are due. All of the proceeds ($800,000) are used to fund a lifetime income stream for her. A gift tax deduction is created for her current tax year, due to the charitable contribution. The amount of the deduction varies according the options she selects for her trust. Mary needs professional advice to make sure this solution fits her situation and goals.

Assume Mary did receive professional assistance and she picked an option that pays a 6% yield or $48,000 per year ($4,000 a month). Enter these changes in her Data Input and Results spreadsheet:
2. “0” in cell C19 (Real Estate)
3. “4000” in C46 (Pension/Social Security (TP2)).

### See FIG. 51.

Mary then sells her stocks (the capital gains taxes are partially or wholly offset by the above charitable deduction), takes out $9,500 from her savings, puts $70,000 down on a $350,000 home with a mortgage of $1,500 per month and adjusts other assets as follows:
4. “20” in C11 (Cash)
5. “50” in C12 (Checking Account(s))
6. “500” in C13 (Savings Account(s))
7. “350000” in C19 (Real Estate FMV), “New Mortgage Co.” in D19 (Creditor), “280000” in E19 (Real Estate Loan), “360” in F19 (Loan Term) and “1500” in I19 (Monthly Payment Loan)
8. “6000” in C22 (the Total Fair Market Value of all her Furniture/Personal Effects); after reevaluating the true ‘garage-sale’ value of these items
9. “0” in C31 (Assets #1) and delete B31 (“Stock portfolio”)
10. “15” in C41 (Interest—Dividends); due to the sale of her stocks and reduced savings account
11. “1812” in G40 (Housing and Utilities); due to her new mortgage

### See FIG. 52.

Next she sells her car and leases a new one:
12. “2006 Ford” in B28, “0” in C28 (Fair Market Value), “Car Lease Inc.” in B28, “0” in E28 (Loan Amount), F28 (Loan Term), “450” in H28 (Monthly Lease Payment) and “0” in I28 (Monthly Loan Payment)
13. “2628” in G54 (Entertainment, Vacations & Misc. to balances her income and claimed outlays so that H59 is zero)
   With all the above changes, Mary's RCP goes down $691,221 to $136,023.

### See FIG. 52.

Mary can also apply income and expense strategies. Some of her reported monthly living expenditures were adjusted above. These additional strategies will aid in cutting her RCP:
14. “649” in G39 (the IRS's allowance for Food, Clothing & Misc.); remember that $649 is the only amount she doesn't need to show records of having spent
15. “400” in G45 (Health Insurance); Mary procures a new or supplements her current insurance plan
16. “365” in G46 (Other Health Care); she finds other physical or mental health issues that need attention
17. “3000” in G47 (Taxes); her higher pension income, higher withholding and remittances to the state warrant this increase
18. “239” in G49 (Child/Dependent Care); she starts providing for some of her mother's upkeep
19. “300” in G50 (Life Insurance); from a new life insurance policy she takes out
20. “0” in G54 (Entertainment, Vacations & Misc.); since she doesn't have any income left over
   These strategies reduce Mary's RCP to $570 (cell I65) so the IRS would likely accept her OIC offer to pay $3,000, and thus, save her $227,000 in taxes.

### See FIG. 54 in Appendix.

To test the strategy, Mary enters the beginning Fair Market Values and Loans Outstanding for each class of asset she owns into the Implementation spreadsheet as follows:
21. “100” in cell D7 (Cash)
22. “500” in cell D8 (Checking Account(s))
23. “10000” in cell D9 (Savings Account(s))
24. “25000” in cell D18 (Value of all Furniture/Personal Effects)
25. “15000” in cell D24 (Car #1)
26. “7000” in cell F24 (Car #1 Loan)
27. “60000” in cell D27 (Asset #1)
   The result is that she frees up $8,030 in cash (cell I54). Remember that revaluing her Furniture/Personal Effects from $20,000 (cell D18) to $7,000 (E18) does not change her cash in cell H18 since no transaction has occurred. Similarly, gifting her home away through a charitable remainder trust does not generate cash as if she sold it.

Now Mary enters her desired payments into cells C37 through C53 as follows:
28. “1200” in cell C37 (Food, Clothing & Misc.); her prior budget and the level she would like to continue consuming
29. “649” in cell D37 (Food, Clothing & Misc.); amount paid from current income
30. “1812” in cell C38 (Housing and Utilities); the payment includes her new mortgage obligation
31. “450” in cell C40; the monthly payment on her new lease
32. “300” in cell C42 (Car Operating Costs); her prior budget and the level she would like to continue consuming
33. “400” in cell C43 (Health Insurance); her new budget
34. “365” in cell C44 (Other Health Care); the new budget
35. “3000” in cell C45 (Taxes); the increased withholding FIG.
36. “239” in cell C47 (Child/Dependent Care); new budget
37. “300” in cell C48 (Life Insurance); new budget
38. “1975” in cell C52 (Entertainment, Vacations & Misc.); her prior budget, which she would like to maintain

### See FIG. 55.

Her Total Desired Expenses should sum to $10,041. To determine the amount of stockpiles and prepaid expenses she will require, enter:
39. “6” in cell I58 (Months for Documentation Period); Mary is not working so she should only have to track her financial data for three months plus another three months for insurance
40. “10” in cell I60 (Stockpiling Reserves); the percentage of additional funds she wants available)

### See FIG. 56.

To continue enjoying $1,200 per month of Food, Clothing & Misc., she allocates $3,637 of her cash to stockpiling these items (cell I37). She uses the remaining cash to create an Entertainment, Vacations & Misc. reserve of $4,393 (cell I52).

All of her spending objectives are met with the exception of Entertainment. During the documentation period she will have only $666 per month (cell F52) for this purpose rather than $1,975 she was spending before. Note that, if she decreased her 10% reserve assumption to zero in cell I60, this would free up an additional $121 per month for entertainment activities.

The summary of her OIC settlement is shown starting in rows 57 through 76. To balance the sources and uses of funds:
41. “400” in cell E60, indicating the need to borrow or sell assets to pay the OIC monthly payment due upon acceptance
42. “150” in cell E64 (OIC Application Fee)

### See FIG. 57.

In summary, the above strategies help Mary substantially cut her RCP and qualify for an OIC. Paying her offer of $3,000 saves $227,000 in taxes. The tradeoff, however, is that she has to shift her portfolio around and reduce her monthly entertainment spending by $1,309 for six months.

Appendix A contains Mary's financial disclosure form (443-A) which reflects the above changes. Valuing her reserves for Food, Clothing & Misc. ($3,637) and Entertainment, Vacations & Misc. ($4,393) at five cents on the dollar yields a combined amount of $402. This figure is added to the $6,000 value given for her Furniture/Personal Effects raising the total to $6,402 (see line item 21a on Form 443-A). Thus, Mary's implementation of her OIC strategy is as follows:
1. Make the changes to her assets and liabilities as described above.
2. Stay within the “After” budget limits, and document these income and expenditure amounts for three months (six months had she been self-employed).
3. Submit her OIC application together with the financial disclosure forms demonstrating three months of her “After” income and expenses.
4. Maintain her “After” budget and be prepared to provide an additional three months of income and expense documentation.

Finally, consider the example of Albert U. R. Broke's OIC. Albert and his wife's income jumped sharply starting in 2000 and they ratcheted up their discretionary spending rather than remitting all the income taxes that were due. Now they are facing a $125,000 tax bill with very little in assets to draw upon. Also, their RCP is $498,124 so the IRS would require full payment. Being in this situation presents a challenge but is not impossible to resolve. The essence of the problem is to find ways to lower their income and shift disbursements from non-allowed categories to those that are permitted such that little or no RCP is left over. In the end, Albert can document an RCP of only $410 for his OIC application.

Note that the starting difference between his claimed and allowed expenses totals $5,471 per month (see cell I59 in the Data Input and Results spreadsheet). This considerable sum must somehow be cut to nearly zero. One possible step would be to argue that his wife will be quitting her job to have a child or adopt, so that her future salary would be zero. In addition, if Albert can justify special circumstances, large expenditures could be lumped into one or more of the authorized categories as described earlier. Assuming this in not possible, the approach taken below is to incrementally spread the $5,471 out in order to avoid relying too much on any one strategy.

Enter Albert's personal and financial data in spreadsheets as follows:

Monthly Multiplier spreadsheet:
1. “3/15/2007” in cell E3 (Date of Analysis)
2. “Albert U. R. Broke” in cell M3 (Name)
3. “2000” in cell E35 (year taxes owed), “75000” in F35 (taxes owed), “80” in I35 (months since first notice received for this year)
4. “2001” in cell E36 (year taxes owed), “35000” in F36 (taxes owed), “65” in I36 (months since first notice received for this year)
5. “2002” in cell E37 (year taxes owed), “15000” in F37 (taxes owed), “40” in I37 (months since first notice received for this year)
6. “1” in cell L64 (the Monthly Multiplier being selected; in this case, the IRS's multiplier)

### See FIG. 58.

In the Data Input and Results spreadsheet enter:
7. “Los Angeles, Calif.” in E4 (taxpayer's county and state of residence)
8. “0” in cell I4 (for now he chooses not to discount future cash flows)
9. “2” in cell F5 (number of people in taxpayer's household)
10. “1500” in cell I6 (amount offered to settle OIC)
11. “50” in cell C11 (Cash)
12. “350” in cell C12 (Checking Account(s))
13. “1500” in cell C13 (Savings Account(s))
14. “3000” in cell C17 (Pensions)
15. “12000” in cell C22 (Value of all Furniture/Personal Effects)
16. “2001 Ford” in cell B28, “7500” in cell C28 (Car #1)
17. “1988 Buick” in cell B29, “3500” in cell C29 (Car #2)
18. “7500” in cell C39 (Wages/Salaries: TP1)
19. “5500” in cell C40 (Wages/Salaries: TP2)
20. “Cheap Car Loans” in cell D28 (Car #1 Creditor)
21. “Cheap Car Loans” in cell D29 (Car #2 Creditor)
22. “2500” in cell E28 (Car #1 Loan)
23. “1500” in cell E29 (Car #2 Loan)
24. “24” in cell F28 (Car #1 Loan Term)
25. “12” in cell F29 (Car#2 Loan Term)
26. “7040” in cell G22 (Furniture/Personal Effects Exemption); in 2007 this was increased to $7,720
27. “2000” in cell G39 (Food, Clothing & Misc. Expenses)
28. “1700” in cell G40 (Housing and Utilities Expenses)
29. “550” in cell G44 (Transportation Operating Costs)
30. “450” in cell G45 (Health Insurance Expense)
31. “3000” in cell G47 (Taxes)
32. “4500” in cell G54 (Entertainment, Vacation & Misc. Expenses)
33. “450” in cell I28 (Car #1 Loan Payment)
34. “350” in cell I29 (Car #2 Loan Payment)
35. “1280” in cell I39 (Food, Clothing & Misc. Exemption)
36. “1563” in cell I40 (Housing and Utilities Exemption)
37. “475” in cell I42 (Car #1 Ownership Exemption)
38. “338” in cell I43 (Car #2 Ownership Exemption)
39. “448” in cell I44 (Transportation Operating Exemption)

### See FIG. 59.

### See FIG. 60.

To check that the numbers entered are accurate, his RCP should total $498,124. Obviously, IRS's recommendation would be to deny his OIC application, as illustrated in cells A65 and D65.

The following describes how Albert qualifies for his OIC. Monthly Multiplier strategies

include using a weighted average of the tax years to decrease his multiplier from 80 to 49 which cuts $194,029 from his RCP.
1. “3” in L64 (Monthly Multiplier selected)

Insofar as asset and liability strategies are concerned, a long-term wealth building strategy would be for Albert to stop renting and acquire a home but that is beyond the scope of this offer in compromise software application. Similar to the previous examples, he can make the following changes to reduce his RCP:
2. “200” in C12 (Checking Accounts)
3. “0” in C13 (Savings Accounts)
4. “3000” in G17 (Exemption for Pension); he found out his wife's 401(k) did not permit borrowing (if it did, she should borrow the maximum over a term longer than their multiplier)
5. “9000” in C22 (the Total Fair Market Value of all his Furniture/Personal Effects); after reevaluating the true, garage-sale value of these items

Next they sell their cars, lease new ones, and use the proceeds from these actions to buy food and household provisions to offset expenditures in excess of that allowed by the IRS:
6. Change B28 and B29 to “New car #1” and “New car #2”, respectively, and enter “0” in C28 and C29 (Fair Market Value)
7. “Car Lease Inc.” in D28 and D29
8. “0” in E28 and E29 (Loan Amount) as well as F28 and F29 (Loan Term)
9. “450” in H28 and “300” in H29 (Monthly Lease Payment) and “0” in I28 and I29 (Monthly Loan Payment)
10. “4550” in G54 (Entertainment, Vacations & Misc. to equalize his income and declared outlays)

### See FIG. 61.

### See FIG. 62.

The net impact of the above changes takes his RCP down to $270,351.

Income and expense strategies can also be employed. This is where most of the action takes place to successfully prosecute Albert's OIC. It will require good documentation to justify how he and his wife allocate their relatively high income. Remember, the reasons for allowing high expenses that most resonate with the IRS involve the taxpayer and his or her family's health, welfare, and production of income.

They reduce food and other purchases to the IRS allowances:
11. “1280” G39 (allowance for Food, Clothing & Misc.); recall that this amount, $1,280, is the only part of their spending that does not have to be documented
12. “1563” in G40 (Housing and Utilities)
13. “448” in G44 (Car Operating Expenses)

To decrease their take home pay, Albert and his wife cut their claimed exemptions to zero and increase their tax withholding.
14. “5000” in G47 (Taxes)

Next, spread the remaining surplus over various authorized but not capped necessities (keep in mind that one must provide the IRS with proof of these expenditures):
15. “900” in G45 (Health Insurance); they obtain a new or supplement current insurance plans
16. “1200” in G46 (Other Health Care); they seek counseling and find other physical or mental health issues that need attention
17. “1109” in G49 (Child/Dependent Care); due to dependent care for their parents
18. “750” in G50 (Life Insurance); comes from a new life insurance policy Albert and his wife take out
19. “0” in G54 (Entertainment, vacations & misc.); since they don't have any income left over
   These last actions take Albert's Net Difference between his income and allowed expenditures down to zero (cell I59) so that their RCP is only $410. At this point electing to discount his future cash flows would not decrease his RCP so he does not make this election.

To test the strategy, on the Implementation spreadsheet, Albert enters his beginning Fair Market Values and Loans Outstanding for each class of asset as follows:
20. “50” in cell D7 (Cash)
21. “350” in cell D8 (Checking Account(s))
22. “1500” in cell D9 (Savings Account(s))
23. “3000” in cell D13 (Pensions)
24. “12000” in cell D18 (Value of all Furniture/Personal Effects)
25. “7500” in cell D24 (Car #1)
26. “3500” in cell D25 (Car #2)
27. “2500” in cell F24 (Car #1)
28. “1500” in cell F25 (Car #2)
   The Implementation spreadsheet reports that $8,650 of cash is freed up. Now he enters his desired spending into cells C37 through C53 so that his Total Desired Expenses sum to $18,476 as follows:
29. “2000” in cell C37 (Food, Clothing & Misc.); his prior budget
30. “1280” in cell D37 (Food, Clothing & Misc.); amount paid from current income
31. “1700” in cell C38 (Housing and Utilities); his prior budget
32. “450” in cell C40; Ownership Costs, Car #1); new budget
33. “300” in cell C41; Ownership Costs, Car #2); new budget
34. “550” in cell C42 (Car Operating Costs); his prior budget
35. “900” in cell C43 (Health Insurance); new budget
36. “1200” in cell C44 (Other Health Care); his new budget
37. “5000” in cell C45 (Taxes); his new budget
38. “1109” in cell C47 (Child/Dependent Care); his new budget
39. “750” in cell C48 (Life Insurance); his new budget
40. “4500” in cell C52 (Entertainment, Vacations & Misc.); his prior budget
   To complete the assumptions table, enter:
41. “6” in cell I58 (Months for Documentation Period, since Albert and his wife are not self-employed)
42. “0” in cell I60 (Stockpiling Reserves), Albert decides not to have any reserves

His budget falls short in four categories: 1) Food, Clothing & Misc., 2) Housing and Utilities, 3) Operating Costs (for their cars), and 4) Entertainment, Vacations & Misc. However, creating stockpiles and prepaying expenses allow Albert and his wife to maintain their desired standard of living in all the areas except number 4, Entertainment. Thus, the total stockpiles (cell I54) equals the Total Change in Cash (H32).

### See FIG. 63.

### See FIG. 64.

To finish his plan, make these entries for sources and uses of cash:
43. “150” in cell E64 (his OIC Application Fee)
44. “184” in cell E60 (Sale of Assets or Borrowings) to balance his sources and uses of funds.

In summary, with an ending RCP of $410, the IRS's recommendation would be to pay the amount offered ($1,500), thereby saving Albert $123,500 in taxes. The downside is he has to limit his entertainment spending to $483 per month over the next six months to get his OIC approved. Most people would feel it is worth it. Appendix A contains his financial disclosure form 443-A, including the disclosure of the $432 of stockpiles created (i.e., $8,650 times 5%).

Thus, Albert's OIC plan is as follows:
1. Make the changes to their assets and liabilities as described above.
2. Stay within the “After” budget limits, and document these income and expenditure amounts for three months (six months had either of them been self-employed).
3. Submit his OIC application together with the financial disclosure forms demonstrating three months of their “After” income and expenses.
4. Maintain the “After” budget and be prepared to provide an additional three months of income and expense documentation (which the IRS will likely request during the application period).

The following describes the type of information often requested by the IRS and saves time in organizing it for presentation. To apply for an OIC, the taxpayer 10 must supply a brief cover letter, the application, and disclosure forms along with backup data and documentation. In addition, the taxpayer 10 will have to answer questions posed by the revenue officer who reviews his or her offer. Appendix B has OIC applications that other taxpayers have successfully negotiated with the IRS.

Various documents are submitted with the taxpayer's 10 OIC application. Note that the documentation requirements do not apply to the taxpayer 10 if his or her OIC application is based on the premise that “I don't owe the tax (for some very good reason).” Simply complete IRS Form 656 and a letter explaining why the tax does not apply in that situation.

Assuming the taxpayer 10 admits he or she owes the tax, be prepared to include the following documents along with the taxpayer's 10 application. Send copies only.
1. In summary the government forms that may be used include the following:
   a) Form 656: Offer in Compromise starts the OIC process, so it must be filed by all applicants. Be sure to use the February, 2007 version of this form.
   b) Form 656-A: Income Certification for Offer in Compromise Application Fee and Payment is used only if applying for wavier of OIC application fee.
   c) Form 656-L: Offer in Compromise (Doubt as to Liability) is submitted only if applying under the assumption the taxpayer 10 does not owe the tax.
   d) Form 433-A Collection Information Statement for Wage Earners and Self-Employed Individuals is the financial disclosure statement required from all applicants.
   e) Form 433-B Collection Information Statement for Businesses is required if the applicant has a business.
   f) Form 2848 Power of Attorney and Declaration of Representative is only needed if the taxpayer 10 wants to authorize someone to represent him or her before the IRS (e.g., handle his or her OIC).
   g) Form 4506-T Request for Transcript of Tax Return is used to obtain the taxpayer's 10 IRS records.
2. The non-refundable OIC application fee of $150 must be submitted unless waived by applying under either Income Certification for Offer in Compromise Application Fee and Payment (IRS Form 656-A) or Offer in Compromise (Doubt as to Liability) (IRS Form 656-L).
3. Include an OIC application deposit equal to 20% of the taxpayer's 10 settlement offer (if the total amount is to be paid in five or less installments) or the first installment (if paid over more than five months).
   a) In the latter case, all subsequent installments must be paid as proposed even while the taxpayer's 10 application is under consideration.
   b) If the taxpayer's 10 offer is rejected, the deposit or installments will be applied to the taxpayer's tax liability.
   c) One strategy to limit the required deposit would be to submit a low, but not unreasonable, cash settlement offer with the taxpayer's 10 application.
4. A letter explaining the taxpayer's 10 circumstances in detail and why his or her offer is not frivolous.
5. Tax returns for the last three years.
6. Bank, credit card, and brokerage account statements for the last twelve months.
7. Income and expense records (e.g., cancel checks, credit card receipts, paycheck stubs, and so forth) for the documentation period.
8. Supporting materials to document special circumstances (e.g., statements from doctors, medical records, legal proceedings, and the like).
9. Collateral agreement(s) if advantageous to the taxpayer 10 as described below.
10. Additional information requests by the IRS can be for any of the following as well as documentation on other subjects relevant to the taxpayer's 10 situation:
   a) Title and deeds to assets owned
   b) Inventory of personal assets, including collections, art, money receivable from all sources, insurance claims, inheritances
   c) Inventory of business assets, including inventories, accounts receivable
   d) Appraisals of real estate and other valuable holdings
   e) Records regarding pension and profit-sharing plans
   f) Information on stock, bond, and other security transactions and holdings
   g) Life insurance policies
   h) Legal obligations such as divorce and child support agreements, court judgments, bankruptcies and liens

There is a large potential pitfall in the OIC process that the taxpayer 10 should be aware of and avoid. If the IRS asks for supplemental information or substantiation regarding aspects of the taxpayer's 10 application, do all he or she can to give them what they want. The “Catch-22” the taxpayer 10 could fall into otherwise is as follows:
1. If for any reason a Revenue Officer does not want to grant his or her OIC, all they have to do is declare that the taxpayer 10 has not provided enough information to substantiate his or her application. This closes the taxpayer's 10 case and there is no way to appeal their decision. The taxpayer 10 can only appeal if his or her application was denied or rejected. In this case, it was “closed.”
2. Furthermore, the taxpayer's 10 cannot request help from the Taxpayer Advocate Service because the taxpayer 10 never came under their jurisdiction. The taxpayer's 10 OIC application is either a) in process and under consideration, b) closed for lack of substantiation and cannot be re-opened, or c) not rejected and in the appeal process. The TAS cannot intervene in any of these situations.
3. Thus, the sole arbitrator(s) of the taxpayer's 10 application could be his or her Revenue Officer and their immediate supervisor. With no ability to request a review of their decision to “close” the taxpayer's 10 offer, his or her only recourse is to reapply and start the OIC process over.
   The taxpayer's 10 should provide direct, truthful, and concise answers and avoid giving more information than is absolutely necessary.

The best presentation of quantitative data (and the easiest way to compile numerical information) is with an Excel spreadsheet. Six templates are included with the offer in compromise software application and a copy of the printouts for each is described below. The taxpayer 10 can open the spreadsheets and begin filling in his or her own data as he or she collects it. A brief introduction to each template is as follows:

### Templates #1 (Checks) and #2 (Credit Cards):

These formats are suitable for tracking checks as well as credit and debit card transactions. Note that if the taxpayer 10 creates a record of all the items debited from an account, he or she can use it to make schedules for specific types of expenditures. For example, if the taxpayer 10 wants a record of just his or her credit card business entertainment outlays, copy the “mother” spreadsheet showing all transactions from that account, change the title on the new spreadsheet, and delete all the non-business entertainment charges. Do this for all the separate categories of expenditures the taxpayer 10 has to report on from that account.

### See FIG. 65 in Appendix.

### See FIG. 66.

### Templates #3 (Business) and #4 (Special Circumstances):

These templates summarize business income and purchases or documents and justify expenditures for special circumstances. They provide an overview that is supplemented with separate spreadsheets showing the details for each category of income and expense cited. Such professional-looking, quantitative records help convey the reasonableness and necessity of the activity.

### See FIG. 67.

### See FIG. 68.

### Template #5 (Income) and #6 (Expense):

Here are the backup spreadsheets that can be cloned from a “mother” spreadsheet as discussed above. In a similar fashion, if the taxpayer 10 creates a master spreadsheet of all his or her bank deposits and needs to document just his or her business income, he or she can copy it and delete all non-business deposits.

### See FIG. 69.

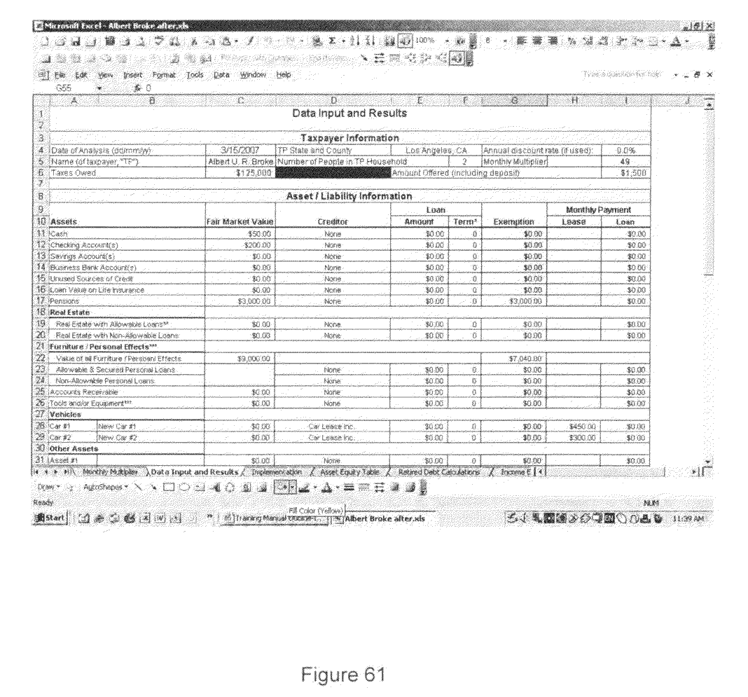

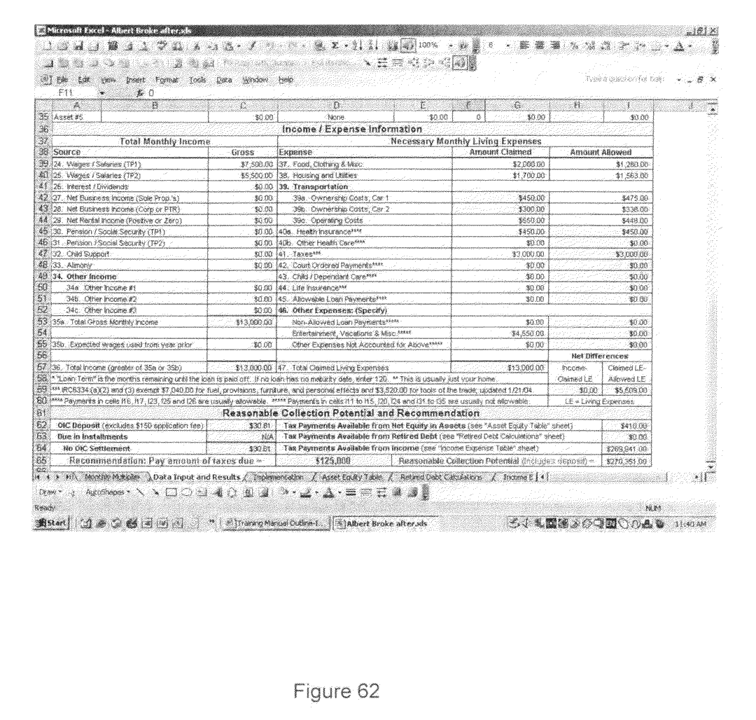

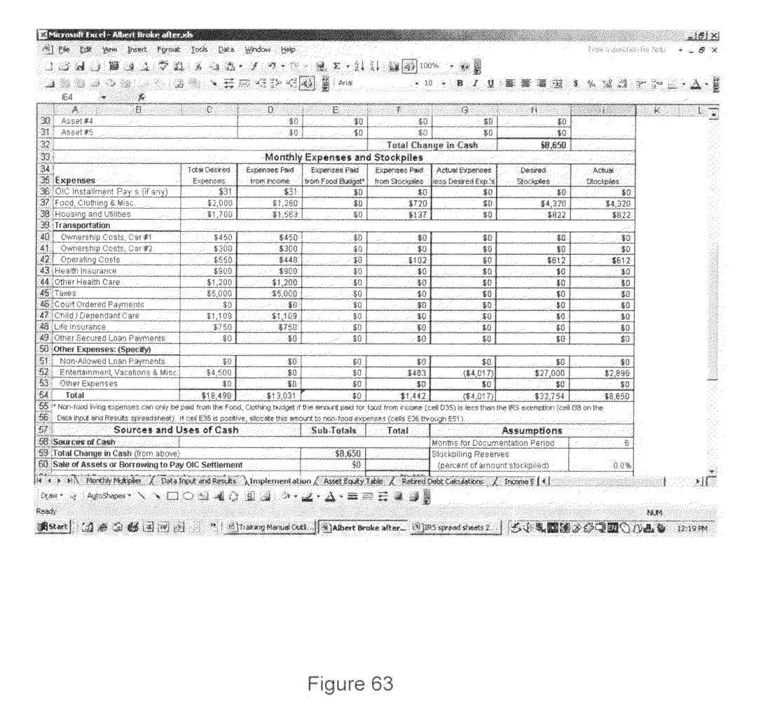

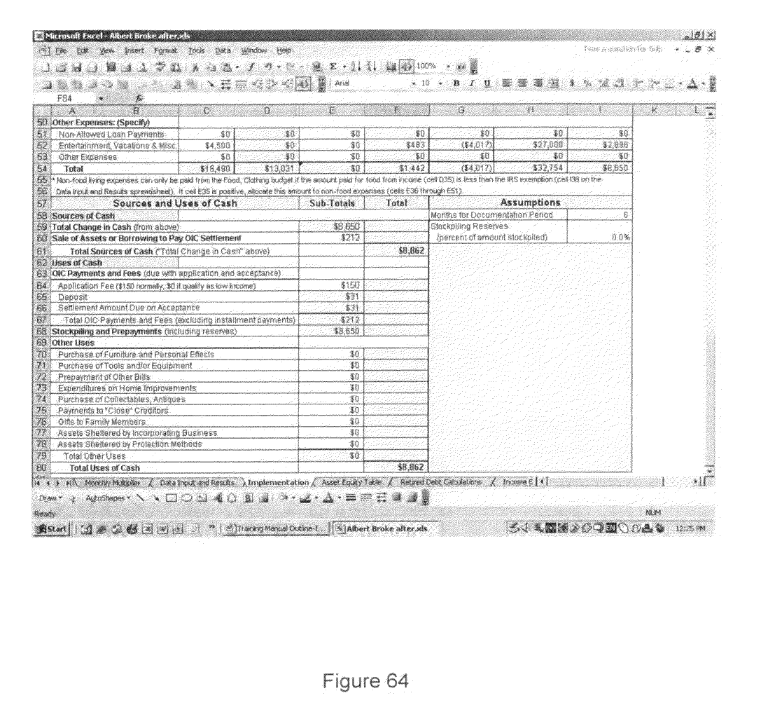

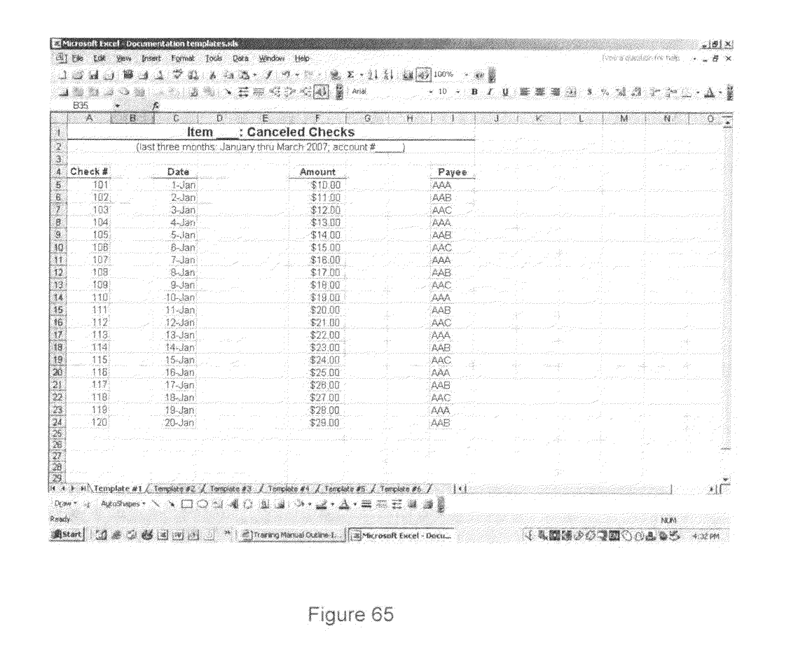

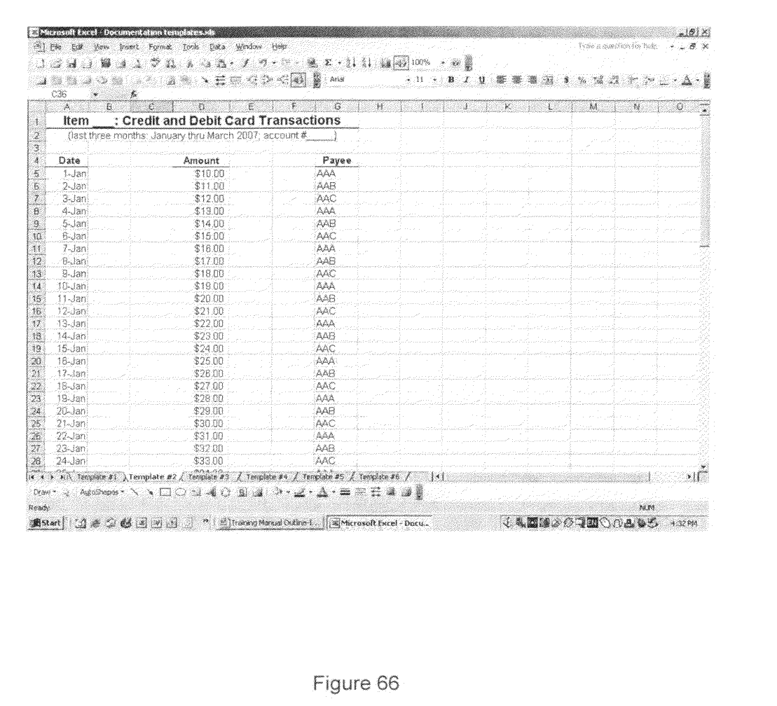

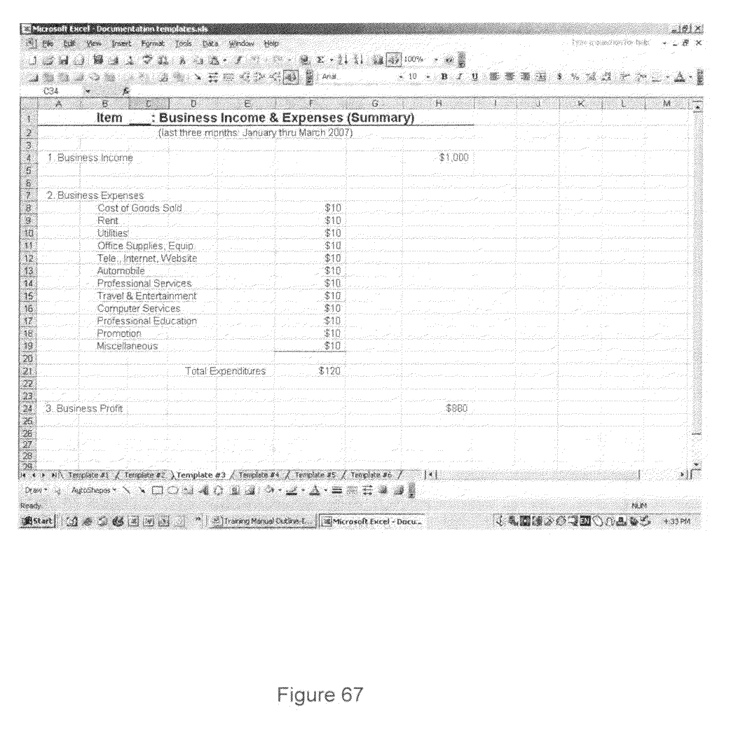

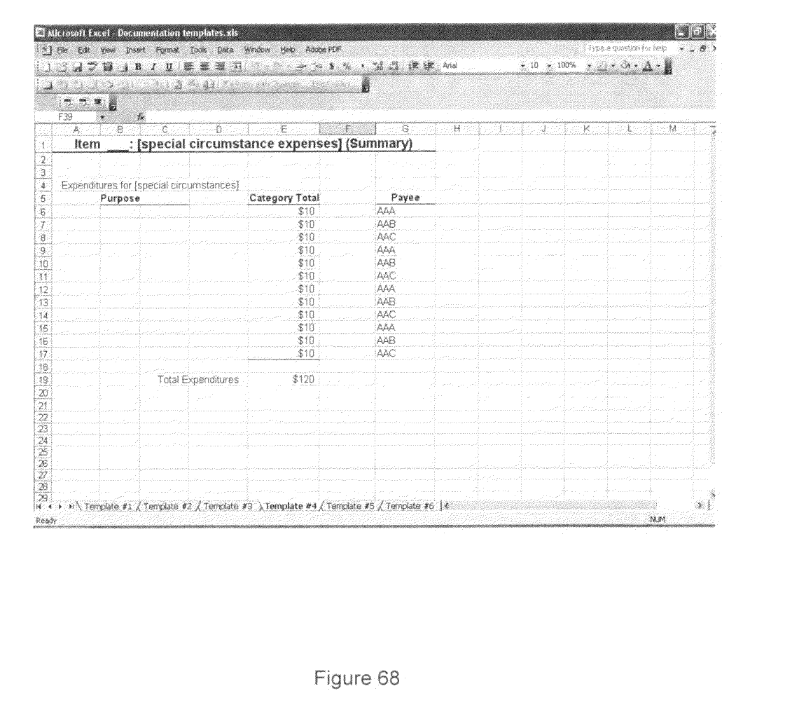

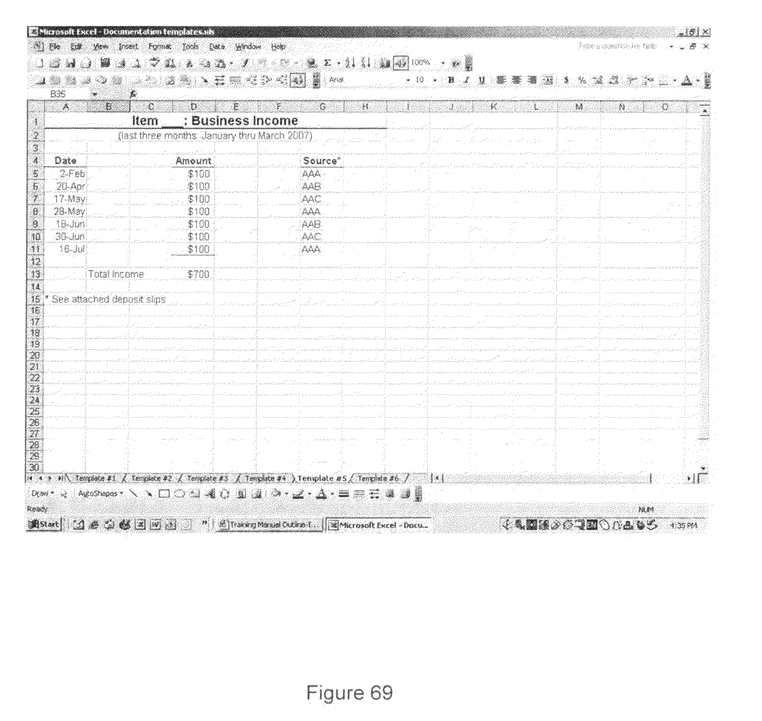

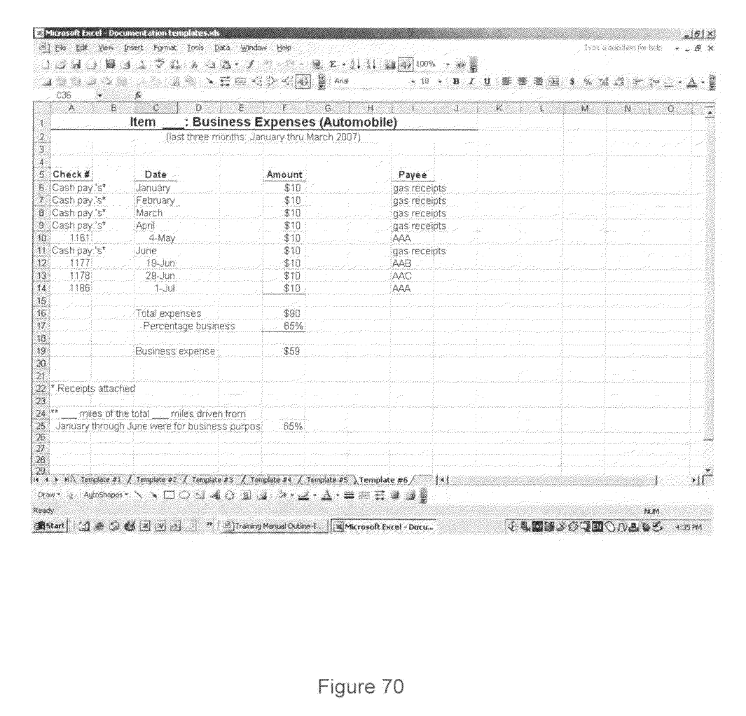

### See FIG. 70.

In addition, referring again to FIG. 1 the report of solution analysis 150 calculates the IRS's reasonable collection potential 100 and interprets what that means in terms of the agency's likely strategy for resolving the taxpayer's delinquency.

The user can save the report of solution analysis 150 in their individual secure workspace in taxpayer data, document storage 90 shown in FIG. 1.

The step 500 shown in FIG. 4 continues to the top of FIG. 5. As shown in FIG. 5, a step 510 enables the user to select a solution to implement. If they choose not to select a solution, the process ends, as indicated by a step 520. If the user selects a solution, they also can choose to make changes to their finances or circumstances prior to implementing their solution, as indicated by the step 525. Examples of pre-implementation changes may include filing past due tax returns or altering their reasonable collection potential calculation as earlier described to increase the likelihood of success of various solutions under consideration.

As shown in FIG. 5, the user is given the option of updating their data, as indicated by a step 660 which continues to the step 300 shown in FIG. 2. Not amending the data takes the user back to the step 510 shown in FIG. 5 where the user selects solution(s) to implement, at which point the user can affirm the previous solution selection or select another solution(s) and proceed to solution(s) document preparation in a step 530 without making any further changes, or electing to make changes in the steps 660 and 330, or selecting another solution(s) to implement in the step 510, or ending the process in the step 520.

Then, the user proceeds to creating their solution(s) documents starting with a step 530. A taxpayer 10 can create the solution(s) documents 550 themselves, as indicated by a step 535, or, alternatively, have a tax professional 20 do so in a step 540 by selecting such an expert from a database of tax professionals 160. In one contemplated modification, the database of tax professionals may also comprise other professionals such as tax or bankruptcy lawyers. In accordance with another embodiment, the taxpayer 10 may engage a tax professional 20 to review and advise them on their taxpayer data 70, report of solution analysis 150, solution selection 510, solution(s) documents 550, and/or any other aspect of their tax resolution.

Either the taxpayer 10 or their tax professional 20 accesses the document creation tools 545 consisting of a database of solution resources 170, software to customize solution documentation 180, a database of solution documentation 190, and the taxpayer data 70 saved on the host computer 60.

The database of solution resources 170 comprises any or all of the following: white papers, glossary, frequently asked questions, live and recorded seminars, discussion groups plus other resources to help them research and understand the solution(s).

The software to customize solution documentation 180 is word processing, spreadsheet, and any other such programs needed to create and display the solution(s) documents 550.

The database of solution documentation 190 preferably contains step-by-step instructions together with word processing tools, time lines for completion, check lists, sample applications, templates, financial models, and data input forms. For example, if the taxpayer 10 wants to access their IRS tax records under the Freedom of Information Act (FOIA), they are provided detailed procedures for implementing this task along with sample completed forms, a blank form to fill out using word processing software, an explanation of the process, terms, and the reports they will receive plus tips on how to use this information in resolving their tax problem.

The user employs software to customize solution documentation 180 to modify existing files and create solution(s) documents 550. Such documentation can be saved and accessed later, printed, downloaded to a PDF, DVD or other electronic media, and/or made available to another user whom they authorize to access their workspace.

As shown in FIG. 2, the user's solution may or may not be accepted, as indicated by a step 610. If it is, the delinquent tax problem is resolved, and their need for further use of the tax resolution system 40 ends, as indicated by a step 630. If not, the user can search for another solution, as indicated by a step 650. Assuming that they decline to search for an alternative solution, the tax resolution process ends in a step 640. If they continue to search for a solution, the user is given the option of updating their taxpayer data 70 in accordance with a step 660. In this manner the tax resolution system 40 can be employed iteratively until a satisfactory resolution is found or all potential solutions are exhausted.

Whether or not the user's solution is accepted in the step 610, this outcome is preferably used in a step 620 to update and amend the tax resolution system 40 components such as the taxpayer data checker rules 80, calculation of reasonable collection potential 100, IRS, Tax, and bankruptcy court law and procedures 110, decision tree of strategic choices 120, solution algorithms 130, database of solution metrics 140, report of solution analysis 150, database of tax professionals 160, database of solution resources 170, software to customize solution documentation 180, and database of solution documentation 190.

At the user's option, their taxpayer data 70, report of solution analysis 150 and solution(s) documents 550 can be printed out, downloaded to a computer, PDF, PDA, DVD or other electronic media, or device and/or made available to another user whom they authorize to access their workspace.

In the foregoing manner, a taxpayer who is delinquent is guided to provide pertinent data and preferences to be analyzed to derive one or more potential solutions to resolve tax problems or plan a future tax strategy. The taxpayer or a tax professional is provided with the data and support information to solve tax problems and prepare documentation to implement potential solutions.

While the foregoing description has been with reference to particular embodiments of the present invention, it will be appreciated by those skilled in the art that changes in these embodiments may be made without departing from the principles and spirit of the invention. For example, as mentioned above, the offer in compromise software application can be a discreet spreadsheet application, rather than a component of the tax resolution system 40. Also, the offer in compromise software application can be modified to incorporate changes based on amendments by the IRS, as demonstrated by the modifications to the offer in compromise software application described in the accompanying November 2007 Addendum. Accordingly, the scope of the present invention can only be ascertained with reference to the appended claims.

What is claimed is:

1. A tax resolution system to assist a taxpayer or tax professional in identifying and implementing solutions to tax delinquency problems, comprising:
at least one computer;
an offer in compromise software application executed on the at least one computer to calculate a reasonable collection potential (RCP) to enable the taxpayer to determine what, if any, benefit could result from an offer in compromise, wherein the RCP is a measure employed by the Internal Revenue Service (IRS) of the capacity of a taxpayer to pay current and past due taxes based on calculations comprising: a) the net equity in the taxpayer's assets, b) income of the taxpayer available to pay taxes after allowing for allowable expenditures, and c) income that will become available after existing loans of the taxpayer are paid off;
wherein the taxpayer or the tax professional can make adjustments to the taxpayer's finances to adjust the RCP to plan ahead and further increase the likelihood of achieving acceptance of an offer in compromise with the IRS; and
document creation tools to create one or more documents relating to an offer in compromise application.

2. The system of claim 1 wherein the offer in compromise software application enables the taxpayer to plan his or her offer in compromise offer, reposition his or her assets, and maintain a strict budget for six to nine months while he or she documents his or her income and spending.

3. The system of claim 1 wherein the adjustments are based on strategies to reduce the taxpayer's RCP from two sources: a) his or her assets and b) his or her debts that are paid off before his or her Monthly Multiplier expires.

4. The system of claim 1 wherein the adjustments are based on the taxpayer selling his or her car, sheltering resulting cash, and leasing or temporarily renting a different car to take advantage of a car ownership exemption.

5. The system of claim 1 wherein the adjustments are based on shrinking additions to the taxpayer's RCP from at least one of a) business assets and equipment, b) home, and c) personal property comprising furniture and clothing.

6. The system of claim 1 wherein the adjustments are based on at least one of:
a) decreasing the taxpayer's business' short-term profitability and capitalized value by delaying or reducing sales and receipts and prepaying or increasing costs;
b) cutting profits and transferring income by hiring the taxpayer's children, but not paying them more than what the taxpayer would compensate anyone else for similar work; and
c) forming a new corporation to shelter personal assets and income.

7. The system of claim 1 wherein the adjustments are based on at least one of:
a) maxing out the taxpayer's credit lines;
b) selling part or all of the taxpayer's company; and
c) acquiring business assets.

8. The system of claim 1 wherein the adjustments are based on at least one of:
a) refinancing the taxpayer's home and pulling out any equity that would be added to his or her RCP and sheltering proceeds or using the proceeds for home improvements, purchasing furniture, repaying short-term borrowings, and paying off and closing credit cards or lines of credit; and
b) selling the taxpayer's home, putting a minimum down payment on another, and sheltering remaining cash.

9. The system of 1 wherein the adjustments are based on gifting highly appreciated assets through a charitable remainder trust.

10. The system of 1 wherein the adjustments are based on prepaying housing and utilities bills so as not to add to the taxpayer's RCP.

11. The system of 1 wherein the adjustments are based on using a discount rate on the taxpayer's future income and expenses.

12. The system of 1 wherein the adjustments are based on the taxpayer buying at least one of a) personal assets comprising furniture and clothing and b) tools for the taxpayer's business, which the IRS exempts a given amount and the taxpayer can value at a low valuation.

13. The system of claim 12 wherein the valuation is in a range of approximately 3% or 5% of retail prices.

14. The system of claim 1 wherein the adjustments are based on stockpiling food and supplies to hold the taxpayer's living expenses within IRS limits.

15. The system of claim 1 wherein the adjustments are based on at least one of:
a) temporarily reducing the taxpayer's income during a documentation period;
b) decreasing the taxpayer's overtime pay or deferring bonuses;
c) lessening or eliminating the number of exemptions so more taxes are withheld from the taxpayer's paycheck;
d) increasing the taxpayer's contributions to his or her 401(k) or other retirement plans if there are rules against borrowing;
e) including in the taxpayer's tax payments any installments he or she is remitting to his or her state for past due taxes; and
f) if the taxpayer has the option to do so, becoming an independent contractor and creating a corporation to shelter his or her earnings.

16. The system of claim 1 wherein the adjustments are based on purchasing term-life insurance, polices and paying an annual premium in advance.
